(19) United States
(12) Patent Application Publication
(10) Pub. No.: US 2026/0350370 A1
(43) Pub. Date: Nov. 5, 2026

(54) SYSTEMS AND METHODS FOR STATE SPACE MODEL-BASED SYNTHETIC DATA GENERATION FOR LONGITUDINAL AND TIME SERIES DATA

(71) Applicant: SAS Institute Inc., Cary, NC (US)

(72) Inventors: Rajesh Sadashiv Selukar, Cary, NC (US); Xilong Chen, Chapel Hill, NC (US); Sanggohn Han, Cary, NC (US); David Bruce Elsheimer, Clayton, NC (US); Ji Shen, Apex, NC (US)

(73) Assignee: SAS Institute Inc., Cary, NC (US)

(21) Appl. No.: 19/668,471

(22) Filed: May 5, 2026

Related U.S. Application Data
(60) Provisional application No. 63/800,200, filed on May 5, 2025.

(51) Int. Cl. G06N 3/0475

(52) U.S. Cl. CPC G06N 3/0475

(57) ABSTRACT

A system and method includes receiving, via a network interface coupled to one or more input devices, a synthetic data generation request comprising longitudinal data and one or more synthetic data generation parameters; fitting, via a model fitting and selection circuit, a plurality of candidate state space models to the longitudinal data; electing, via the model fitting and selection circuit, one of the plurality of candidate state space models as a champion state space model; generating a plurality of synthetic component trajectories using at least the champion state space model elected by the model fitting and selection circuit; generating a plurality of synthetic data records using the plurality of synthetic component trajectories generated by the simulation smoother circuit; and returning, via the network interface, the plurality of synthetic data records for output via an output device to a user associated with the synthetic data generation request.

### CROSS-REFERENCE TO RELATED APPLICATIONS

This application claims the benefit of U.S. Provisional Application No. 63/800,200, filed on 5 May 2025, which is incorporated in its entirety by this reference.

### TECHNICAL FIELD

This invention relates generally to the creation of synthetic data, and more specifically, to new and useful systems and methods for state space model-based synthetic data generation.

### BACKGROUND

Data processing systems may be used to analyze longitudinal and time series data across a wide range of domains, including finance, healthcare, environmental monitoring, and industrial operations. Such data often includes observations collected over time and may exhibit complex temporal dependencies, correlations among variables, and latent structures that are not directly observable. Conventional approaches to processing and analyzing such data may rely on statistical modeling to support downstream tasks such as forecasting, simulation, and machine learning. In some cases, these approaches may involve generating additional data records or modifying existing datasets to facilitate analysis, testing, or model development.

Therefore, there is a need in the art for improved data processing techniques capable of supporting analysis and model development in contexts involving complex temporal data structures. The embodiments of the present application provide technical solutions that address, at least, the needs described above, as well as the deficiencies of the state of the art.

### BRIEF SUMMARY OF THE EMBODIMENTS

In one embodiment, a computer-implemented system includes: one or more input devices, a network interface coupled to the one or more input devices, a host device coupled to the network interface, the host device comprising: a processor, and a synthetic data generation application comprising computer-readable instructions that, when executed by the processor, implement a plurality of circuits that control a generation of synthetic data, whereat the plurality of circuits include: a request detection circuit that receives, via the network interface, a synthetic data generation request that includes longitudinal data and one or more synthetic data generation parameters, a model fitting and selection circuit that (i) fits a plurality of candidate state space models to the longitudinal data received by the request detection circuit and (ii) elects one of the plurality of candidate state space models as a champion state space model, a simulation smoother circuit that generates a plurality of synthetic component trajectories using at least the champion state space model elected by the model fitting and selection circuit, and a synthetic data generation circuit that generates a plurality of synthetic data records using the plurality of synthetic component trajectories generated by the simulation smoother circuit, and an output device coupled to the host device that returns, using the network interface, the plurality of synthetic data records to a user associated with the synthetic data generation request.

In one embodiment, in response to the request detection circuit receiving the synthetic data generation request, the request detection circuit obtains, from computer memory, an initial data structure comprising the longitudinal data and the one or more synthetic data generation parameters stored in association with the initial data structure, in response to obtaining the initial data structure and the one or more synthetic data generation parameters, the synthetic data generation application: generates and stores in the computer memory a plurality of partially completed data records according to the one or more synthetic data generation parameters, and generates an augmented data structure that includes the longitudinal data and the plurality of partially completed data records, fitting the plurality of candidate state space models includes fitting, by the model fitting and selection circuit executing a model fitting computer program, the plurality of candidate state space models using the longitudinal data included in the augmented data structure, electing the one of the plurality of candidate state space models as the champion state space model includes selecting, in response to fitting the plurality of candidate state space models, the one of the plurality of candidate state space models as the champion state space model based on the one of the plurality of candidate state space models satisfying a model efficacy criterion, generating the plurality of synthetic component trajectories includes executing, by the simulation smoother circuit, a simulation smoother to generate a synthetic component trajectory for each model component of the champion state space model based on providing at least the augmented data structure and the champion state space model as input to the simulation smoother, and generating the plurality of synthetic data records further includes using the synthetic component trajectory generated for each model component of the champion state space model to compute a set of synthetic response data values for the plurality of partially completed data records.

In one embodiment, each partially completed data record of the plurality of partially completed data records includes an unpopulated response data field, and the computer-readable instructions, when executed by the processor, perform operations further comprising: in response to computing the set of synthetic response data values, populating the unpopulated response data field within each partially completed data record of the augmented data structure with a corresponding synthetic response data value included in the set of synthetic response data values.

In one embodiment, the longitudinal data includes a plurality of historical data records collectively corresponding to a historical time span, the one or more synthetic data generation parameters specifies a request to generate, at a predetermined time interval, synthetic longitudinal data for a target time span different from the historical time span, the plurality of partially completed data records collectively span the target time span at the predetermined time interval, and generating the augmented data structure includes: creating a plurality of new rows based on a total number of the plurality of partially completed data records, and augmenting the initial data structure with the plurality of new rows to form the augmented data structure.

In one embodiment, each partially completed data record of the plurality of partially completed data records includes a respective temporal identifier, each new row of the plurality of new rows corresponds to a distinct one of the plurality of partially completed data records, each new row of the plurality of new rows includes the respective temporal identifier that corresponds to the distinct one of the plurality of partially completed data records, and each new row of the plurality of new rows includes an unpopulated response data field.

In one embodiment, the longitudinal data includes a plurality of historical data records spanning a historical time span, a schema of the initial data structure specifies a plurality of predictor variables, a response variable associated with the plurality of predictor variables, and a temporal attribute, each historical data record of the plurality of historical data records includes: a temporal attribute value specifying a distinct period within the historical time span, a plurality of predictor variable data values observed for the distinct period that correspond to the plurality of predictor variables, and a response variable data value observed for the distinct period that corresponds to the response variable, and the champion state space model models a temporal behavior of the response variable across the historical time span as a state space model equation.

In one embodiment, the state space model equation predicts a subject response data value for the response variable at a given time as a sum of a regression component, a plurality of distinct latent components, and an error component, the regression component represents a contribution of the plurality of predictor variable data values observed at the given time multiplied by a predetermined set of regression coefficients, and each distinct latent component of the plurality of distinct latent components represents an effect of a distinct time-based factor at the given time.

In one embodiment, the champion state space model includes at least a first model component and a second model component, the set of synthetic response data values computed for the plurality of partially completed data records includes a respective synthetic response data value computed for each partially completed data record of the plurality of partially completed data records, and computing the respective synthetic response data value for a respective partially completed data record of the plurality of partially completed data records using the synthetic component trajectory generated for each model component of the champion state space model includes: obtaining, from the synthetic component trajectory generated for the first model component, a first model component value for the first model component based on a target time period specified by the respective partially completed data record, obtaining, from the synthetic component trajectory generated for the second model component, a second model component value for the second model component based on the target time period specified by the respective partially completed data record, computing a regression component value for the respective partially completed data record based on multiplying a plurality of predictor variable data values included in the respective partially completed data record by a predetermined set of regression coefficients, and combining the regression component value, the first model component value, the second model component value, and an error component value according to the state space model equation to compute the respective synthetic response data value for the respective partially completed data record.

In one embodiment, the champion state space model includes at least a first model component and a second model component, the set of synthetic response data values computed for the plurality of partially completed data records includes a respective synthetic response data value computed for each partially completed data record of the plurality of partially completed data records, and computing the respective synthetic response data value for a respective partially completed data record of the plurality of partially completed data records using the synthetic component trajectory generated for each model component of the champion state space model includes: obtaining, from the synthetic component trajectory generated for the first model component, a first model component value for the first model component based on a target time period specified by the respective partially completed data record, obtaining, from the synthetic component trajectory generated for the second model component, a second model component value for the second model component based on the target time period specified by the respective partially completed data record, computing a regression component value for the respective partially completed data record based on multiplying a plurality of predictor variable data values included in the respective partially completed data record by a predetermined set of regression coefficients, computing an intermediate synthetic response data value for the respective partially completed data record by aggregating the regression component value, the first model component value, the second model component value, and an error component value according to the state space model equation, and executing an inverse transformation operation on the intermediate synthetic response data value to compute the respective synthetic response data value for the respective partially completed data record.

In one embodiment, the champion state space model includes at least a first model component and a second model component, the set of synthetic response data values computed for the plurality of partially completed data records includes a respective synthetic response data value computed for each partially completed data record of the plurality of partially completed data records, and computing the respective synthetic response data value for a respective partially completed data record of the plurality of partially completed data records using the synthetic component trajectory generated for each model component of the champion state space model includes: obtaining, from the synthetic component trajectory generated for the first model component, a first model component value for the first model component based on a target time period specified by the respective partially completed data record, obtaining, from the synthetic component trajectory generated for the second model component, a second model component value for the second model component based on the target time period specified by the respective partially completed data record, computing a regression component value for the respective partially completed data record based on multiplying a plurality of predictor variable data values included in the respective partially completed data record by a predetermined set of regression coefficients, and aggregating, based on a modified version of the state space model equation, the regression component value, the first model component value, the second model component value, and an error component value to compute the respective synthetic response data value for the respective partially completed data record.

In one embodiment, the modified version of the state space model equation includes one or more additional scaling factors when compared to the state space model equation of the champion state space model.

In one embodiment, whereat the state space model equation does not include a first scaling factor for the first model component nor a second scaling factor for the second model component, the modified version of the state space model equation includes the first scaling factor for the first model component and the second scaling factor for the second model component, and aggregating the regression component value, the first model component value, the second model component value, and the error component value based on the modified version of the state space model equation includes: computing a first scaled model component value by multiplying the first model component value by the first scaling factor, computing a second scaled model component value by multiplying the second model component value by the second scaling factor, and computing the respective synthetic response data value for the respective partially completed data record by summing the first scaled model component value, the second scaled model component value, the regression component value, and the error component value.

In one embodiment, whereat the computer-readable instructions, when executed by the processor, perform operations further comprising: in response to selecting the champion state space model: generating, by the processor, an application programming interface request that includes the champion state space model and the augmented data structure, transmitting, over a computer network, the application programming interface request to an API endpoint of an analytics compute service, and invoking, in response to the API endpoint of the analytics compute service receiving the application programming interface request, a simulation smoother computer procedure that executes the simulation smoother.

In one embodiment, whereat the longitudinal data includes a plurality of historical data records collectively spanning a historical time span, the plurality of partially completed data records collectively span a target time span that occurred after the historical time span, and the synthetic component trajectory generated for a respective model component of the champion state space model represents a simulated behavior of the respective model component across the target time span.

In one embodiment, whereat the longitudinal data includes a plurality of historical data records collectively spanning a historical time span, the plurality of partially completed data records collectively span a target time span that occurred before the historical time span, and the synthetic component trajectory generated for a respective model component of the champion state space model represents a simulated behavior of the respective model component across the target time span.

In one embodiment, whereat the champion state space model includes a plurality of model components, the plurality of model components includes a plurality of latent model components, a first latent model component of the plurality of latent model components represents a seasonal behavior observed in the longitudinal data, a second latent model component of the plurality of latent model components represents a trend behavior observed in the longitudinal data, and a third latent model component of the plurality of latent model components represents a transient behavior observed in the longitudinal data.

In one embodiment, whereat the plurality of partially completed data records collectively span a target time span that is different from a historical time span spanned by the longitudinal data, the synthetic component trajectory generated for the first latent model component represents a simulated behavior of the seasonal behavior across the target time span, the synthetic component trajectory generated for the second latent model component represents a simulated behavior of the trend behavior across the target time span, and the synthetic component trajectory generated for the third latent model component represents a simulated behavior of the transient behavior across the target time span.

In one embodiment, whereat the champion state space model includes a plurality of model components, the plurality of model components includes a plurality of latent model components, a first latent model component of the plurality of latent model components represents a shared longitudinal behavior across a plurality of distinct experiments, and a second latent model component of the plurality of latent model components models a distinct experiment deviation curve for each distinct experiment of the plurality of distinct experiments.

In one embodiment, whereat the plurality of partially completed data records collectively span a target time span that is different from a historical time span spanned by the longitudinal data, the synthetic component trajectory generated for the first latent model component represents a simulated behavior of the shared longitudinal behavior across the target time span, and the synthetic component trajectory generated for the second latent model component includes a simulated behavior of the distinct experiment deviation curve for each distinct experiment of the plurality of distinct experiments across the target time span.

In one embodiment, whereat the plurality of partially completed data records collectively span a target time span that is different from a historical time span spanned by the longitudinal data, and the computer-readable instructions, when executed by the processor, perform operations further comprising: commencing an automated execution of the computer-readable instructions in response to receiving the synthetic data generation request that includes the initial data structure and the one or more synthetic data generation parameters, and in response to executing the simulation smoother, generating an output data structure that includes the set of synthetic response data values for the plurality of partially completed data records as a response to the synthetic data generation request, whereat: each row in the output data structure corresponds to a distinct partially completed data record of the plurality of partially completed data records, and each row in the output data structure includes: a temporal attribute value specifying a distinct period within the target time span that corresponds to the distinct partially completed data record, a respective synthetic response data value of the set of synthetic response data values computed based on the distinct partially completed data record, and a respective seed value corresponding to the distinct partially completed data record that represents a pseudo-random number generator state of the simulation smoother.

In one embodiment, whereat the one or more synthetic data generation parameters include a simulation count parameter that specifies a total number of simulations to perform using the simulation smoother, and the simulation smoother executes a plurality of distinct simulations equal in number to the total number of simulations specified by the simulation count parameter, whereat each simulation of the plurality of distinct simulations includes: initializing a pseudo-random number generator of the simulation smoother with a respective seed value, generating, based on the respective seed value, a corresponding synthetic component trajectory for each model component of the champion state space model, and computing, using the corresponding synthetic component trajectory generated for each model component of the champion state space model, a respective set of synthetic response data values for the plurality of partially completed data records.

In one embodiment, whereat the longitudinal data includes a plurality of distinct panels of longitudinal data, each panel of longitudinal data of the plurality of distinct panels of longitudinal data includes a distinct historical series of longitudinal data for a respective replicate of a plurality of distinct replicates, and the set of synthetic response data values computed for the plurality of partially completed data records includes a plurality of distinct subsets, whereat: each distinct subset of the plurality of distinct subsets includes a series of synthetic response data values representing a scaled behavior of a distinct replicate of the plurality of distinct replicates.

In one embodiment, whereat the plurality of partially completed data records collectively span a target time span that is different from a historical time span spanned by the longitudinal data, the longitudinal data is associated with a plurality of predictor variables and a response variable, and each synthetic response data value of the set of synthetic response data values computed for the plurality of partially completed data records represents a simulated value of the response variable corresponding to a respective period within the target time span.

In one embodiment, whereat the longitudinal data includes a plurality of predictor variables and a response variable, the longitudinal data includes a plurality of historical data records collectively corresponding to a historical time span, the one or more synthetic data generation parameters specifies a request to generate, at a predetermined time interval, synthetic longitudinal data for a target time span different from the historical time span, the plurality of partially completed data records collectively span the target time span at the predetermined time interval, the one or more synthetic data generation parameters further includes a target value for one of the plurality of predictor variables, and generating the augmented data structure includes: creating a plurality of new rows based on a total number of the plurality of partially completed data records, and augmenting the initial data structure with the plurality of new rows to form the augmented data structure.

In one embodiment, whereat each partially completed data record of the plurality of partially completed data records includes a respective temporal identifier, each new row of the plurality of new rows corresponds to a distinct one of the plurality of partially completed data records, and each new row of the plurality of new rows includes: the respective temporal identifier that corresponds to the distinct one of the plurality of partially completed data records, the target value for the one of the plurality of predictor variables, and an unpopulated response data field.

In one embodiment, whereat the longitudinal data does not include instances of a target class of a response variable, the plurality of synthetic data records generated by the synthetic data generation circuit includes synthetic instances of the target class, and the computer-readable instructions, when executed by the processor, perform operations further comprising: training at least one machine learning model using the plurality of synthetic data records generated by the synthetic data generation circuit to enable the at least one machine learning model to learn the target class of the response variable.

In one embodiment, whereat the computer-readable instructions, when executed by the processor, perform operations further comprising: training an ensemble of machine learning models using the plurality of synthetic data records generated by the synthetic data generation circuit.

In one embodiment, whereat the computer-readable instructions, when executed by the processor, perform operations further comprising: using the plurality of synthetic data records generated by the synthetic data generation circuit to automatically test or automatically assess one or more software algorithms developed by the user.

In one embodiment, a computer-implemented method includes: receiving, at a request detection circuit, via a network interface coupled to one or more input devices, a synthetic data generation request comprising longitudinal data and one or more synthetic data generation parameters; fitting, via a model fitting and selection circuit, a plurality of candidate state space models to the longitudinal data received by the request detection circuit; electing, via the model fitting and selection circuit, one of the plurality of candidate state space models as a champion state space model; generating, via a simulation smoother circuit, a plurality of synthetic component trajectories using at least the champion state space model elected by the model fitting and selection circuit; generating, via a synthetic data generation circuit, a plurality of synthetic data records using the plurality of synthetic component trajectories generated by the simulation smoother circuit; and returning, via the network interface, the plurality of synthetic data records for output via an output device to a user associated with the synthetic data generation request.

In one embodiment, a computer-program product includes a non-transitory machine-readable storage medium storing computer instructions that, when executed by processing circuitry, perform operations comprising: receive, at a request detection circuit, via a network interface coupled to one or more input devices, a synthetic data generation request comprising longitudinal data and one or more synthetic data generation parameters; fit, via a model fitting and selection circuit, a plurality of candidate state space models to the longitudinal data received by the request detection circuit; elect, via the model fitting and selection circuit, one of the plurality of candidate state space models as a champion state space model; generate, via a simulation smoother circuit, a plurality of synthetic component trajectories using at least the champion state space model elected by the model fitting and selection circuit; generate, via a synthetic data generation circuit, a plurality of synthetic data records using the plurality of synthetic component trajectories generated by the simulation smoother circuit; and return, via the network interface, the plurality of synthetic data records for output via an output device to a user associated with the synthetic data generation request.

In one embodiment, a computer-program product includes a non-transitory machine-readable storage medium storing computer instructions for improving a computer-based simulation of longitudinal data that, when executed by processing circuitry, perform operations comprising: obtaining, from computer memory, (i) an initial data structure comprising longitudinal data and (ii) one or more synthetic data generation parameters stored in association with the initial data structure, in response to obtaining the initial data structure and the one or more synthetic data generation parameters: generating and storing in the computer memory a plurality of partially completed data records according to the one or more synthetic data generation parameters, and generating an augmented data structure that includes the longitudinal data and the plurality of partially completed data records, fitting, by the processing circuitry executing a model fitting computer program, a plurality of candidate state space models using the longitudinal data included in the augmented data structure, selecting, in response to fitting the plurality of candidate state space models, one of the plurality of candidate state space models as a champion state space model based on the one of the plurality of candidate state space models satisfying a model efficacy criterion, executing, by the processing circuitry, a simulation smoother to generate a synthetic component trajectory for each model component of the champion state space model based on providing at least the augmented data structure and the champion state space model as input to the simulation smoother, and using the synthetic component trajectory generated for each model component of the champion state space model to compute, by the processing circuitry, a set of synthetic response data values for the plurality of partially completed data records.

In one embodiment, whereat each partially completed data record of the plurality of partially completed data records includes an unpopulated response data field, and the computer instructions, when executed by the processing circuitry, perform operations further comprising: in response to computing the set of synthetic response data values, populating the unpopulated response data field within each partially completed data record of the augmented data structure with a corresponding synthetic response data value included in the set of synthetic response data values.

In one embodiment, whereat the longitudinal data includes a plurality of historical data records collectively corresponding to a historical time span, the one or more synthetic data generation parameters specifies a request to generate, at a predetermined time interval, synthetic longitudinal data for a target time span different from the historical time span, the plurality of partially completed data records collectively span the target time span at the predetermined time interval, and generating the augmented data structure includes: creating a plurality of new rows based on a total number of the plurality of partially completed data records, and augmenting the initial data structure with the plurality of new rows to form the augmented data structure.

In one embodiment, whereat each partially completed data record of the plurality of partially completed data records includes a respective temporal identifier, each new row of the plurality of new rows corresponds to a distinct one of the plurality of partially completed data records, each new row of the plurality of new rows includes the respective temporal identifier that corresponds to the distinct one of the plurality of partially completed data records, and each new row of the plurality of new rows includes an unpopulated response data field.

In one embodiment, whereat the longitudinal data includes a plurality of historical data records spanning a historical time span, a schema of the initial data structure specifies a plurality of predictor variables, a response variable associated with the plurality of predictor variables, and a temporal attribute, each historical data record of the plurality of historical data records includes: a temporal attribute value specifying a distinct period within the historical time span, a plurality of predictor variable data values observed for the distinct period that correspond to the plurality of predictor variables, and a response variable data value observed for the distinct period that corresponds to the response variable, and the champion state space model models a temporal behavior of the response variable across the historical time span as a state space model equation.

In one embodiment, whereat state space model equation predicts a subject response data value for the response variable at a given time as a sum of a regression component, a plurality of distinct latent components, and an error component, the regression component represents a contribution of the plurality of predictor variable data values observed at the given time multiplied by a predetermined set of regression coefficients, and each distinct latent component of the plurality of distinct latent components represents an effect of a distinct time-based factor at the given time.

In one embodiment, whereat the champion state space model includes at least a first model component and a second model component, the set of synthetic response data values computed for the plurality of partially completed data records includes a respective synthetic response data value computed for each partially completed data record of the plurality of partially completed data records, and computing the respective synthetic response data value for a respective partially completed data record of the plurality of partially completed data records using the synthetic component trajectory generated for each model component of the champion state space model includes: obtaining, from the synthetic component trajectory generated for the first model component, a first model component value for the first model component based on a target time period specified by the respective partially completed data record, obtaining, from the synthetic component trajectory generated for the second model component, a second model component value for the second model component based on the target time period specified by the respective partially completed data record, computing a regression component value for the respective partially completed data record based on multiplying a plurality of predictor variable data values included in the respective partially completed data record by a predetermined set of regression coefficients, and combining the regression component value, the first model component value, the second model component value, and an error component value according to the state space model equation to compute the respective synthetic response data value for the respective partially completed data record.

In one embodiment, whereat the champion state space model includes at least a first model component and a second model component, the set of synthetic response data values computed for the plurality of partially completed data records includes a respective synthetic response data value computed for each partially completed data record of the plurality of partially completed data records, and computing the respective synthetic response data value for a respective partially completed data record of the plurality of partially completed data records using the synthetic component trajectory generated for each model component of the champion state space model includes: obtaining, from the synthetic component trajectory generated for the first model component, a first model component value for the first model component based on a target time period specified by the respective partially completed data record, obtaining, from the synthetic component trajectory generated for the second model component, a second model component value for the second model component based on the target time period specified by the respective partially completed data record, computing a regression component value for the respective partially completed data record based on multiplying a plurality of predictor variable data values included in the respective partially completed data record by a predetermined set of regression coefficients, computing an intermediate synthetic response data value for the respective partially completed data record by aggregating the regression component value, the first model component value, the second model component value, and an error component value according to the state space model equation, and executing an inverse transformation operation on the intermediate synthetic response data value to compute the respective synthetic response data value for the respective partially completed data record.

In one embodiment, whereat the champion state space model includes at least a first model component and a second model component, the set of synthetic response data values computed for the plurality of partially completed data records includes a respective synthetic response data value computed for each partially completed data record of the plurality of partially completed data records, and computing the respective synthetic response data value for a respective partially completed data record of the plurality of partially completed data records using the synthetic component trajectory generated for each model component of the champion state space model includes: obtaining, from the synthetic component trajectory generated for the first model component, a first model component value for the first model component based on a target time period specified by the respective partially completed data record, obtaining, from the synthetic component trajectory generated for the second model component, a second model component value for the second model component based on the target time period specified by the respective partially completed data record, computing a regression component value for the respective partially completed data record based on multiplying a plurality of predictor variable data values included in the respective partially completed data record by a predetermined set of regression coefficients, and aggregating, based on a modified version of the state space model equation, the regression component value, the first model component value, the second model component value, and an error component value to compute the respective synthetic response data value for the respective partially completed data record.

In one embodiment, whereat the modified version of the state space model equation includes one or more additional scaling factors when compared to the state space model equation of the champion state space model.

In one embodiment, whereat the state space model equation does not include a first scaling factor for the first model component nor a second scaling factor for the second model component, the modified version of the state space model equation includes the first scaling factor for the first model component and the second scaling factor for the second model component, and aggregating the regression component value, the first model component value, the second model component value, and the error component value based on the modified version of the state space model equation includes: computing a first scaled model component value by multiplying the first model component value by the first scaling factor, computing a second scaled model component value by multiplying the second model component value by the second scaling factor, and computing the respective synthetic response data value for the respective partially completed data record by summing the first scaled model component value, the second scaled model component value, the regression component value, and the error component value.

In one embodiment, whereat the computer instructions, when executed by the processing circuitry, perform operations further comprising: in response to selecting the champion state space model: generating, by the processing circuitry, an application programming interface request that includes the champion state space model and the augmented data structure, transmitting, over a computer network, the application programming interface request to an API endpoint of an analytics compute service, and invoking, in response to the API endpoint of the analytics compute service receiving the application programming interface request, a simulation smoother computer procedure that executes the simulation smoother.

In one embodiment, whereat longitudinal data includes a plurality of historical data records collectively spanning a historical time span, the plurality of partially completed data records collectively span a target time span that occurred after the historical time span, and the synthetic component trajectory generated for a respective model component of the champion state space model represents a simulated behavior of the respective model component across the target time span.

In one embodiment, whereat the longitudinal data includes a plurality of historical data records collectively spanning a historical time span, the plurality of partially completed data records collectively span a target time span that occurred before the historical time span, and the synthetic component trajectory generated for a respective model component of the champion state space model represents a simulated behavior of the respective model component across the target time span.

In one embodiment, whereat the champion state space model includes a plurality of model components, the plurality of model components includes a plurality of latent model components, a first latent model component of the plurality of latent model components represents a seasonal behavior observed in the longitudinal data, a second latent model component of the plurality of latent model components represents a trend behavior observed in the longitudinal data, and a third latent model component of the plurality of latent model components represents a transient behavior observed in the longitudinal data.

In one embodiment, whereat the plurality of partially completed data records collectively span a target time span that is different from a historical time span spanned by the longitudinal data, the synthetic component trajectory generated for the first latent model component represents a simulated behavior of the seasonal behavior across the target time span, the synthetic component trajectory generated for the second latent model component represents a simulated behavior of the trend behavior across the target time span, and the synthetic component trajectory generated for the third latent model component represents a simulated behavior of the transient behavior across the target time span.

In one embodiment, whereat the champion state space model includes a plurality of model components, the plurality of model components includes a plurality of latent model components, a first latent model component of the plurality of latent model components represents a shared longitudinal behavior across a plurality of distinct experiments, and a second latent model component of the plurality of latent model components models a distinct experiment deviation curve for each distinct experiment of the plurality of distinct experiments.

In one embodiment, whereat the plurality of partially completed data records collectively span a target time span that is different from a historical time span spanned by the longitudinal data, the synthetic component trajectory generated for the first latent model component represents a simulated behavior of the shared longitudinal behavior across the target time span, and the synthetic component trajectory generated for the second latent model component includes a simulated behavior of the distinct experiment deviation curve for each distinct experiment of the plurality of distinct experiments across the target time span.

In one embodiment, whereat the plurality of partially completed data records collectively span a target time span that is different from a historical time span spanned by the longitudinal data, and the computer instructions, when executed by the processing circuitry, perform operations further comprising: commencing an automated execution of the computer instructions in response to receiving a synthetic data generation request that includes the initial data structure and the one or more synthetic data generation parameters, and in response to executing the simulation smoother, generating an output data structure that includes the set of synthetic response data values for the plurality of partially completed data records as a response to the synthetic data generation request, whereat: each row in the output data structure corresponds to a distinct partially completed data record of the plurality of partially completed data records, and each row in the output data structure includes: a temporal attribute value specifying a distinct period within the target time span that corresponds to the distinct partially completed data record, a respective synthetic response data value of the set of synthetic response data values computed based on the distinct partially completed data record, and a respective seed value corresponding to the distinct partially completed data record that represents a pseudo-random number generator state of the simulation smoother.

In one embodiment, whereat the one or more synthetic data generation parameters include a simulation count parameter that specifies a total number of simulations to perform using the simulation smoother, and the simulation smoother executes a plurality of distinct simulations equal in number to the total number of simulations specified by the simulation count parameter, whereat each simulation of the plurality of distinct simulations includes: initializing a pseudo-random number generator of the simulation smoother with a respective seed value, generating, based on the respective seed value, a corresponding synthetic component trajectory for each model component of the champion state space model, and computing, using the corresponding synthetic component trajectory generated for each model component of the champion state space model, a respective set of synthetic response data values for the plurality of partially completed data records.

In one embodiment, whereat the longitudinal data includes a plurality of distinct panels of longitudinal data, each panel of longitudinal data of the plurality of distinct panels of longitudinal data includes a distinct historical series of longitudinal data for a respective replicate of a plurality of distinct replicates, and the set of synthetic response data values computed for the plurality of partially completed data records includes a plurality of distinct subsets, whereat: each distinct subset of the plurality of distinct subsets includes a series of synthetic response data values representing a scaled behavior of a distinct replicate of the plurality of distinct replicates.

In one embodiment, whereat the plurality of partially completed data records collectively span a target time span that is different from a historical time span spanned by the longitudinal data, the longitudinal data is associated with a plurality of predictor variables and a response variable, and each synthetic response data value of the set of synthetic response data values computed for the plurality of partially completed data records represents a simulated value of the response variable corresponding to a respective period within the target time span.

In one embodiment, whereat the longitudinal data includes a plurality of predictor variables and a response variable, the longitudinal data includes a plurality of historical data records collectively corresponding to a historical time span, the one or more synthetic data generation parameters specifies a request to generate, at a predetermined time interval, synthetic longitudinal data for a target time span different from the historical time span, the plurality of partially completed data records collectively span the target time span at the predetermined time interval, the one or more synthetic data generation parameters further includes a target value for one of the plurality of predictor variables, and generating the augmented data structure includes: creating a plurality of new rows based on a total number of the plurality of partially completed data records, and augmenting the initial data structure with the plurality of new rows to form the augmented data structure.

In one embodiment, whereat each partially completed data record of the plurality of partially completed data records includes a respective temporal identifier, each new row of the plurality of new rows corresponds to a distinct one of the plurality of partially completed data records, and each new row of the plurality of new rows includes: the respective temporal identifier that corresponds to the distinct one of the plurality of partially completed data records, the target value for the one of the plurality of predictor variables, and an unpopulated response data field.

In one embodiment, a computer-program product includes a non-transitory machine-readable storage medium storing computer instructions for improving a computer-based simulation of longitudinal data that, when executed by processing circuitry, perform operations comprising: obtaining, from computer memory, (i) an initial data structure comprising longitudinal data and (ii) one or more synthetic data generation parameters stored in association with the initial data structure, in response to obtaining the initial data structure and the one or more synthetic data generation parameters: generating and storing in the computer memory a plurality of partially completed data records according to the one or more synthetic data generation parameters, and generating an augmented data structure that includes the longitudinal data and the plurality of partially completed data records, fitting, by the processing circuitry executing a model fitting computer program, a plurality of candidate state space models using the longitudinal data included in the augmented data structure, selecting, in response to fitting the plurality of candidate state space models, one of the plurality of candidate state space models as a champion state space model based on the one of the plurality of candidate state space models satisfying a model efficacy criterion, executing, by the processing circuitry, a simulation smoother to generate a synthetic component trajectory for each model component of the champion state space model based on providing at least the augmented data structure and the champion state space model as input to the simulation smoother, and using the synthetic component trajectory generated for each model component of the champion state space model to compute, by the processing circuitry, a set of synthetic response data values for the plurality of partially completed data records.

In one embodiment, whereat each partially completed data record of the plurality of partially completed data records includes an unpopulated response data field, and the computer instructions, when executed by the processing circuitry, perform operations further comprising: in response to computing the set of synthetic response data values, populating the unpopulated response data field within each partially completed data record of the augmented data structure with a corresponding synthetic response data value included in the set of synthetic response data values.

In one embodiment, whereat the longitudinal data includes a plurality of historical data records collectively corresponding to a historical time span, the one or more synthetic data generation parameters specifies a request to generate, at a predetermined time interval, synthetic longitudinal data for a target time span different from the historical time span, the plurality of partially completed data records collectively span the target time span at the predetermined time interval, and generating the augmented data structure includes: creating a plurality of new rows based on a total number of the plurality of partially completed data records, and augmenting the initial data structure with the plurality of new rows to form the augmented data structure.

In one embodiment, whereat each partially completed data record of the plurality of partially completed data records includes a respective temporal identifier, each new row of the plurality of new rows corresponds to a distinct one of the plurality of partially completed data records, each new row of the plurality of new rows includes the respective temporal identifier that corresponds to the distinct one of the plurality of partially completed data records, and each new row of the plurality of new rows includes an unpopulated response data field.

In one embodiment, whereat the longitudinal data includes a plurality of historical data records spanning a historical time span, a schema of the initial data structure specifies a plurality of predictor variables, a response variable associated with the plurality of predictor variables, and a temporal attribute, each historical data record of the plurality of historical data records includes: a temporal attribute value specifying a distinct period within the historical time span, a plurality of predictor variable data values observed for the distinct period that correspond to the plurality of predictor variables, and a response variable data value observed for the distinct period that corresponds to the response variable, and the champion state space model models a temporal behavior of the response variable across the historical time span as a state space model equation.

In one embodiment, whereat the state space model equation predicts a subject response data value for the response variable at a given time as a sum of a regression component, a plurality of distinct latent components, and an error component, the regression component represents a contribution of the plurality of predictor variable data values observed at the given time multiplied by a predetermined set of regression coefficients, and each distinct latent component of the plurality of distinct latent components represents an effect of a distinct time-based factor at the given time.

In one embodiment, whereat the champion state space model includes at least a first model component and a second model component, the set of synthetic response data values computed for the plurality of partially completed data records includes a respective synthetic response data value computed for each partially completed data record of the plurality of partially completed data records, and computing the respective synthetic response data value for a respective partially completed data record of the plurality of partially completed data records using the synthetic component trajectory generated for each model component of the champion state space model includes: obtaining, from the synthetic component trajectory generated for the first model component, a first model component value for the first model component based on a target time period specified by the respective partially completed data record, obtaining, from the synthetic component trajectory generated for the second model component, a second model component value for the second model component based on the target time period specified by the respective partially completed data record, computing a regression component value for the respective partially completed data record based on multiplying a plurality of predictor variable data values included in the respective partially completed data record by a predetermined set of regression coefficients, and combining the regression component value, the first model component value, the second model component value, and an error component value according to the state space model equation to compute the respective synthetic response data value for the respective partially completed data record.

In one embodiment, whereat the champion state space model includes at least a first model component and a second model component, the set of synthetic response data values computed for the plurality of partially completed data records includes a respective synthetic response data value computed for each partially completed data record of the plurality of partially completed data records, and computing the respective synthetic response data value for a respective partially completed data record of the plurality of partially completed data records using the synthetic component trajectory generated for each model component of the champion state space model includes: obtaining, from the synthetic component trajectory generated for the first model component, a first model component value for the first model component based on a target time period specified by the respective partially completed data record, obtaining, from the synthetic component trajectory generated for the second model component, a second model component value for the second model component based on the target time period specified by the respective partially completed data record, computing a regression component value for the respective partially completed data record based on multiplying a plurality of predictor variable data values included in the respective partially completed data record by a predetermined set of regression coefficients, computing an intermediate synthetic response data value for the respective partially completed data record by aggregating the regression component value, the first model component value, the second model component value, and an error component value according to the state space model equation, and executing an inverse transformation operation on the intermediate synthetic response data value to compute the respective synthetic response data value for the respective partially completed data record.

In one embodiment, whereat the champion state space model includes at least a first model component and a second model component, the set of synthetic response data values computed for the plurality of partially completed data records includes a respective synthetic response data value computed for each partially completed data record of the plurality of partially completed data records, and computing the respective synthetic response data value for a respective partially completed data record of the plurality of partially completed data records using the synthetic component trajectory generated for each model component of the champion state space model includes: obtaining, from the synthetic component trajectory generated for the first model component, a first model component value for the first model component based on a target time period specified by the respective partially completed data record, obtaining, from the synthetic component trajectory generated for the second model component, a second model component value for the second model component based on the target time period specified by the respective partially completed data record, computing a regression component value for the respective partially completed data record based on multiplying a plurality of predictor variable data values included in the respective partially completed data record by a predetermined set of regression coefficients, and aggregating, based on a modified version of the state space model equation, the regression component value, the first model component value, the second model component value, and an error component value to compute the respective synthetic response data value for the respective partially completed data record.

In one embodiment, whereat the modified version of the state space model equation includes one or more additional scaling factors when compared to the state space model equation of the champion state space model.

In one embodiment, whereat the state space model equation does not include a first scaling factor for the first model component nor a second scaling factor for the second model component, the modified version of the state space model equation includes the first scaling factor for the first model component and the second scaling factor for the second model component, and aggregating the regression component value, the first model component value, the second model component value, and the error component value based on the modified version of the state space model equation includes: computing a first scaled model component value by multiplying the first model component value by the first scaling factor, computing a second scaled model component value by multiplying the second model component value by the second scaling factor, and computing the respective synthetic response data value for the respective partially completed data record by summing the first scaled model component value, the second scaled model component value, the regression component value, and the error component value.

In one embodiment, whereat the computer instructions, when executed by the processing circuitry, perform operations further comprising: in response to selecting the champion state space model: generating, by the processing circuitry, an application programming interface request that includes the champion state space model and the augmented data structure, transmitting, over a computer network, the application programming interface request to an API endpoint of an analytics compute service, and invoking, in response to the API endpoint of the analytics compute service receiving the application programming interface request, a simulation smoother computer procedure that executes the simulation smoother.

In one embodiment, whereat the longitudinal data includes a plurality of historical data records collectively spanning a historical time span, the plurality of partially completed data records collectively span a target time span that occurred after the historical time span, and the synthetic component trajectory generated for a respective model component of the champion state space model represents a simulated behavior of the respective model component across the target time span.

In one embodiment, whereat the longitudinal data includes a plurality of historical data records collectively spanning a historical time span, the plurality of partially completed data records collectively span a target time span that occurred before the historical time span, and the synthetic component trajectory generated for a respective model component of the champion state space model represents a simulated behavior of the respective model component across the target time span.

In one embodiment, whereat the champion state space model includes a plurality of model components, the plurality of model components includes a plurality of latent model components, a first latent model component of the plurality of latent model components represents a seasonal behavior observed in the longitudinal data, a second latent model component of the plurality of latent model components represents a trend behavior observed in the longitudinal data, and a third latent model component of the plurality of latent model components represents a transient behavior observed in the longitudinal data.

In one embodiment, whereat the plurality of partially completed data records collectively span a target time span that is different from a historical time span spanned by the longitudinal data, the synthetic component trajectory generated for the first latent model component represents a simulated behavior of the seasonal behavior across the target time span, the synthetic component trajectory generated for the second latent model component represents a simulated behavior of the trend behavior across the target time span, and the synthetic component trajectory generated for the third latent model component represents a simulated behavior of the transient behavior across the target time span.

In one embodiment, whereat the champion state space model includes a plurality of model components, the plurality of model components includes a plurality of latent model components, a first latent model component of the plurality of latent model components represents a shared longitudinal behavior across a plurality of distinct experiments, and a second latent model component of the plurality of latent model components models a distinct experiment deviation curve for each distinct experiment of the plurality of distinct experiments.

In one embodiment, whereat the plurality of partially completed data records collectively span a target time span that is different from a historical time span spanned by the longitudinal data, the synthetic component trajectory generated for the first latent model component represents a simulated behavior of the shared longitudinal behavior across the target time span, and the synthetic component trajectory generated for the second latent model component includes a simulated behavior of the distinct experiment deviation curve for each distinct experiment of the plurality of distinct experiments across the target time span.

In one embodiment, whereat the plurality of partially completed data records collectively span a target time span that is different from a historical time span spanned by the longitudinal data, and the computer instructions, when executed by the processing circuitry, perform operations further comprising: commencing an automated execution of the computer instructions in response to receiving a synthetic data generation request that includes the initial data structure and the one or more synthetic data generation parameters, and in response to executing the simulation smoother, generating an output data structure that includes the set of synthetic response data values for the plurality of partially completed data records as a response to the synthetic data generation request, whereat: each row in the output data structure corresponds to a distinct partially completed data record of the plurality of partially completed data records, and each row in the output data structure includes: a temporal attribute value specifying a distinct period within the target time span that corresponds to the distinct partially completed data record, a respective synthetic response data value of the set of synthetic response data values computed based on the distinct partially completed data record, and a respective seed value corresponding to the distinct partially completed data record that represents a pseudo-random number generator state of the simulation smoother.

In one embodiment, whereat the one or more synthetic data generation parameters include a simulation count parameter that specifies a total number of simulations to perform using the simulation smoother, and the simulation smoother executes a plurality of distinct simulations equal in number to the total number of simulations specified by the simulation count parameter, whereat each simulation of the plurality of distinct simulations includes: initializing a pseudo-random number generator of the simulation smoother with a respective seed value, generating, based on the respective seed value, a corresponding synthetic component trajectory for each model component of the champion state space model, and computing, using the corresponding synthetic component trajectory generated for each model component of the champion state space model, a respective set of synthetic response data values for the plurality of partially completed data records.

In one embodiment, whereat the longitudinal data includes a plurality of distinct panels of longitudinal data, each panel of longitudinal data of the plurality of distinct panels of longitudinal data includes a distinct historical series of longitudinal data for a respective replicate of a plurality of distinct replicates, and the set of synthetic response data values computed for the plurality of partially completed data records includes a plurality of distinct subsets, whereat: each distinct subset of the plurality of distinct subsets includes a series of synthetic response data values representing a scaled behavior of a distinct replicate of the plurality of distinct replicates.

In one embodiment, whereat the plurality of partially completed data records collectively span a target time span that is different from a historical time span spanned by the longitudinal data, the longitudinal data is associated with a plurality of predictor variables and a response variable, and each synthetic response data value of the set of synthetic response data values computed for the plurality of partially completed data records represents a simulated value of the response variable corresponding to a respective period within the target time span.

In one embodiment, whereat the longitudinal data includes a plurality of predictor variables and a response variable, the longitudinal data includes a plurality of historical data records collectively corresponding to a historical time span, the one or more synthetic data generation parameters specifies a request to generate, at a predetermined time interval, synthetic longitudinal data for a target time span different from the historical time span, the plurality of partially completed data records collectively span the target time span at the predetermined time interval, the one or more synthetic data generation parameters further includes a target value for one of the plurality of predictor variables, and generating the augmented data structure includes: creating a plurality of new rows based on a total number of the plurality of partially completed data records, and augmenting the initial data structure with the plurality of new rows to form the augmented data structure.

In one embodiment, whereat each partially completed data record of the plurality of partially completed data records includes a respective temporal identifier, each new row of the plurality of new rows corresponds to a distinct one of the plurality of partially completed data records, and each new row of the plurality of new rows includes: the respective temporal identifier that corresponds to the distinct one of the plurality of partially completed data records, the target value for the one of the plurality of predictor variables, and an unpopulated response data field.

### BRIEF DESCRIPTION OF THE FIGURES

FIG. 1 illustrates a block diagram that provides an illustration of the hardware components of a computing system, according to some embodiments of the present technology;

FIG. 2 illustrates an example network including an example set of devices communicating with each other over an exchange system and via a network, according to some embodiments of the present technology;

FIG. 3 illustrates a representation of a conceptual model of a communications protocol system, according to some embodiments of the present technology;

FIG. 4 illustrates a communications grid computing system including a variety of control and worker nodes, according to some embodiments of the present technology;

FIG. 5 illustrates a flow chart showing an example process for adjusting a communications grid or a work project in a communications grid after a failure of a node, according to some embodiments of the present technology;

FIG. 6 illustrates a portion of a communications grid computing system including a control node and a worker node, according to some embodiments of the present technology;

FIG. 7 illustrates a flow chart showing an example process for executing a data analysis or processing project, according to some embodiments of the present technology;

FIG. 8 illustrates a block diagram including components of an Event Stream Processing Engine (ESPE), according to embodiments of the present technology;

FIG. 9 illustrates a flow chart showing an example process including operations performed by an event stream processing engine, according to some embodiments of the present technology;

FIG. 10 illustrates an ESP system interfacing between a publishing device and multiple event subscribing devices, according to embodiments of the present technology;

FIG. 11 illustrates a flow chart of an example of a process for generating and using a machine-learning model according to some aspects, according to embodiments of the present technology;

FIG. 12 illustrates an example of a machine-learning model as a neural network, according to embodiments of the present technology;

FIG. 13 illustrates various aspects of the use of containers as a mechanism to allocate processing, storage and/or other resources of a processing system to the performance of various analyses, according to embodiments of the present technology;

FIG. 14A illustrates a block diagram of an example synthetic data generation system, according to some embodiments of the present technology;

FIG. 14B illustrates an exemplary architecture of the synthetic data generation application, according to some embodiments of the present technology;

FIG. 14C illustrates a flow chart illustrating a state space model-based synthetic data generation for longitudinal and time series data, according to some embodiments of the present technology;

FIG. 15 illustrates an exemplary data processing workflow for generating synthetic longitudinal data, according to embodiments of the present technology;

FIG. 16A-16D illustrate exemplary data structures associated with generating synthetic longitudinal data, according to some embodiments of the present technology;

FIGS. 17 and 17A illustrate aspects of generating synthetic component trajectories using a champion state space model, according to some embodiments of the present technology;

FIG. 18 illustrates an exemplary process for computing a synthetic response data value for a given time period using synthetic component trajectories and a state space model equation, producing an intermediate solution, according to some embodiments of the present technology;

FIG. 19 illustrates an exemplary process for computing a synthetic response data value using synthetic model component trajectories and a state space model equation, according to some embodiments of the present technology;

FIG. 20 illustrates an exemplary process for computing a synthetic response data value using a modified version of a state space model equation, according to some embodiments of the present technology;

FIG. 21 illustrates an exemplary process of generating multiple sets of synthetic response data values based on longitudinal data using a simulation smoother, according to some embodiments of the present technology;

FIG. 22 illustrates generation of a set of synthetic response data values based on longitudinal data using a simulation smoother, according to some embodiments of the present technology; and

FIG. 23 illustrates example performance characteristics associated with generating synthetic response data values for different input configurations, according to some embodiments of the present technology.

### DESCRIPTION OF THE PREFERRED EMBODIMENTS

The following description of the preferred embodiments of the inventions are not intended to limit the inventions to these preferred embodiments, but rather to enable any person skilled in the art to make and use these inventions.

### DETAILED DESCRIPTION

In the following description, for the purposes of explanation, specific details are set forth in order to provide a thorough understanding of embodiments of the technology. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the technology as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional operations not included in a figure. A process may correspond to a method, a function, a procedure, a subroutine, a subprogram, etc. When a process corresponds to a function, its termination can correspond to a return of the function to the calling function or the main function.

### Example Systems

Systems depicted in some of the figures may be provided in various configurations. In some embodiments, the systems may be configured as a distributed system where one or more components of the system are distributed across one or more networks in a cloud computing system.

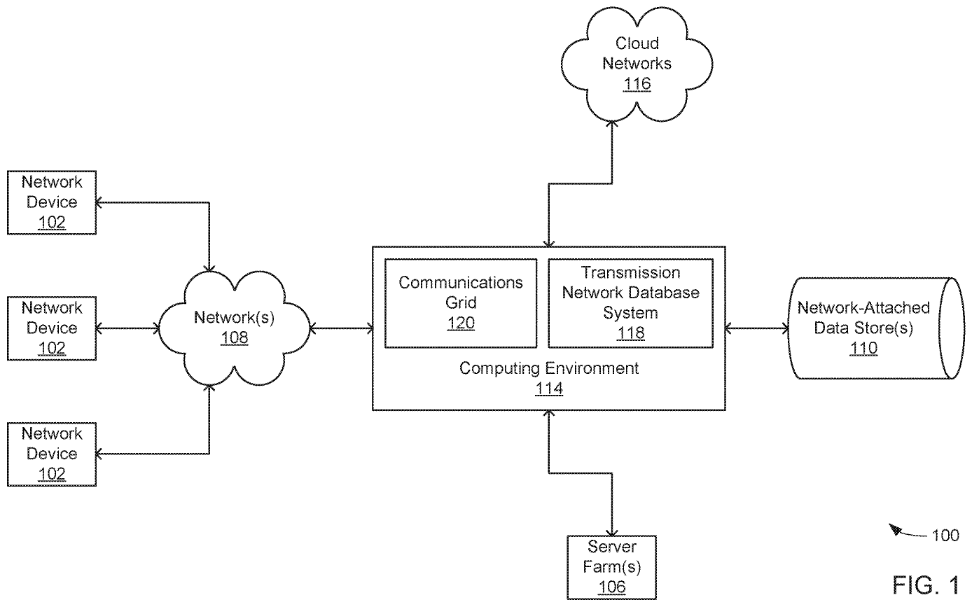

FIG. 1 is a block diagram that provides an illustration of the hardware components of a data transmission network 100, according to embodiments of the present technology. Data transmission network 100 is a specialized computer system that may be used for processing large amounts of data where a large number of computer processing cycles are required.

Data transmission network 100 may also include computing environment 114. Computing environment 114 may be a specialized computer or other machine that processes the data received within the data transmission network 100. Data transmission network 100 also includes one or more network devices 102. Network devices 102 may include client devices that attempt to communicate with computing environment 114. For example, network devices 102 may send data to the computing environment 114 to be processed, may send signals to the computing environment 114 to control different aspects of the computing environment or the data it is processing, among other reasons. Network devices 102 may interact with the computing environment 114 through a number of ways, such as, for example, over one or more networks 108. As shown in FIG. 1, computing environment 114 may include one or more other systems. For example, computing environment 114 may include a database system 118 and/or a communications grid 120.

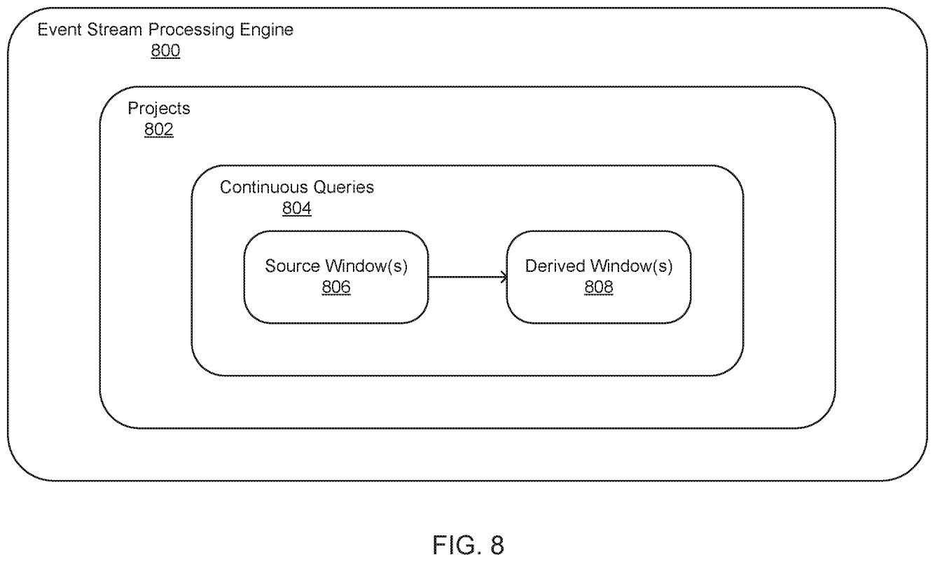

In other embodiments, network devices may provide a large amount of data, either all at once or streaming over a period of time (e.g., using event stream processing (ESP), described further with respect to FIGS. 8-10), to the computing environment 114 via networks 108. For example, network devices 102 may include network computers, sensors, databases, or other devices that may transmit or otherwise provide data to computing environment 114. For example, network devices may include local area network devices, such as routers, hubs, switches, or other computer networking devices. These devices may provide a variety of stored or generated data, such as network data or data specific to the network devices themselves. Network devices may also include sensors that monitor their environment or other devices to collect data regarding that environment or those devices, and such network devices may provide data they collect over time. Network devices may also include devices within the internet of things, such as devices within a home automation network. Some of these devices may be referred to as edge devices, and may involve edge computing circuitry. Data may be transmitted by network devices directly to computing environment 114 or to network-attached data stores, such as network-attached data stores 110 for storage so that the data may be retrieved later by the computing environment 114 or other portions of data transmission network 100.

Data transmission network 100 may also include one or more network-attached data stores 110. Network-attached data stores 110 are used to store data to be processed by the computing environment 114 as well as any intermediate or final data generated by the computing system in non-volatile memory. However, in certain embodiments, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated on-the-fly. In this non-limiting situation, the computing environment 114 may be configured to retain the processed information within memory so that responses can be generated for the user at different levels of detail as well as allow a user to interactively query against this information.

Network-attached data stores may store a variety of different types of data organized in a variety of different ways and from a variety of different sources. For example, network-attached data storage may include storage other than primary storage located within computing environment 114 that is directly accessible by processors located therein. Network-attached data storage may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory medium in which data can be stored and that does not include carrier waves and/or transitory electronic signals. Examples of a non-transitory medium may include, for example, a magnetic disk or tape, optical storage media such as compact disk or digital versatile disk, flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data, such as manufacturing data (e.g., a database containing records identifying products being manufactured with parameter data for each product, such as colors and models) or product sales databases (e.g., a database containing individual data records identifying details of individual product sales).

The unstructured data may be presented to the computing environment 114 in different forms such as a flat file or a conglomerate of data records, and may have data values and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time stamped data may be aggregated by time (e.g., into daily time period units) to generate time series data and/or structured hierarchically according to one or more dimensions (e.g., parameters, attributes, and/or variables). For example, data may be stored in a hierarchical data structure, such as a ROLAP OR MOLAP database, or may be stored in another tabular form, such as in a flat-hierarchy form.

Data transmission network 100 may also include one or more server farms 106. Computing environment 114 may route select communications or data to the one or more sever farms 106 or one or more servers within the server farms. Server farms 106 can be configured to provide information in a predetermined manner. For example, server farms 106 may access data to transmit in response to a communication. Server farms 106 may be separately housed from each other device within data transmission network 100, such as computing environment 114, and/or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time.

Data transmission network 100 may also include one or more cloud networks 116. Cloud network 116 may include a cloud infrastructure system that provides cloud services. In certain embodiments, services provided by the cloud network 116 may include a host of services that are made available to users of the cloud infrastructure system on demand. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network can dynamically scale to meet the needs of its users. The cloud network 116 may include one or more computers, servers, and/or systems. In some embodiments, the computers, servers, and/or systems that make up the cloud network 116 are different from the user's own on-premises computers, servers, and/or systems. For example, the cloud network 116 may host an application, and a user may, via a communication network such as the Internet, on demand, order and use the application.

While each device, server and system in FIG. 1 is shown as a single device, it will be appreciated that multiple devices may instead be used. For example, a set of network devices can be used to transmit various communications from a single user, or remote server 140 may include a server stack. As another example, data may be processed as part of computing environment 114.

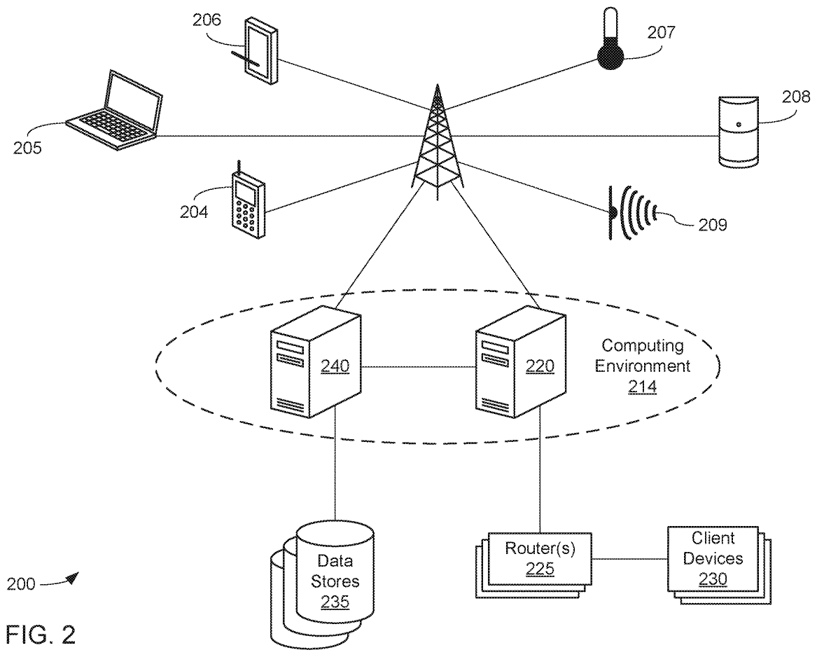

Each communication within data transmission network 100 (e.g., between client devices, between servers 106 and computing environment 114 or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a BLUETOOTH® communication channel or a BLUETOOTH® Low Energy communication channel. A wired network may include a wired interface. The wired and/or wireless networks may be implemented using routers, access points, bridges, gateways, or the like, to connect devices in the network 114, as will be further described with respect to FIG. 2. The one or more networks 108 can be incorporated entirely within or can include an intranet, an extranet, or a combination thereof. In one embodiment, communications between two or more systems and/or devices can be achieved by a secure communications protocol, such as secure sockets layer (SSL) or transport layer security (TLS). In addition, data and/or transactional details may be encrypted.

Some aspects may utilize the Internet of Things (IoT), where things (e.g., machines, devices, phones, sensors) can be connected to networks and the data from these things can be collected and processed within the things and/or external to the things. For example, the IoT can include sensors in many different devices, and high value analytics can be applied to identify hidden relationships and drive increased efficiencies. This can apply to both big data analytics and real-time (e.g., ESP) analytics. This will be described further below with respect to FIG. 2.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The compute nodes in the grid-based computing system 120 and the transmission network database system 118 may share the same processor hardware, such as processors that are located within computing environment 114.

FIG. 2 illustrates an example network including an example set of devices communicating with each other over an exchange system and via a network, according to embodiments of the present technology. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). The communication can be routed to another network device, such as network devices 205-209, via base station 210. The communication can also be routed to computing environment 214 via base station 210. For example, network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, and electrical current, among others. The sensors may be mounted to various components used as part of a variety of different types of systems (e.g., an oil drilling operation). The network devices may detect and record data related to the environment that it monitors and transmit that data to computing environment 214.

As noted, one type of system that may include various sensors that collect data to be processed and/or transmitted to a computing environment according to certain embodiments includes an oil drilling system. For example, the one or more drilling operation sensors may include surface sensors that measure a hook load, a fluid rate, a temperature and a density in and out of the wellbore, a standpipe pressure, a surface torque, a rotation speed of a drill pipe, a rate of penetration, a mechanical specific energy, etc. and downhole sensors that measure a rotation speed of a bit, fluid densities, downhole torque, downhole vibration (axial, tangential, lateral), a weight applied at a drill bit, an annular pressure, a differential pressure, an azimuth, an inclination, a dog leg severity, a measured depth, a vertical depth, a downhole temperature, etc. Besides the raw data collected directly by the sensors, other data may include parameters either developed by the sensors or assigned to the system by a client or other controlling device. For example, one or more drilling operation control parameters may control settings such as a mud motor speed to flow ratio, a bit diameter, a predicted formation top, seismic data, weather data, etc. Other data may be generated using physical models such as an earth model, a weather model, a seismic model, a bottom hole assembly model, a well plan model, an annular friction model, etc. In addition to sensor and control settings, predicted outputs, of for example, the rate of penetration, mechanical specific energy, hook load, flow in fluid rate, flow out fluid rate, pump pressure, surface torque, rotation speed of the drill pipe, annular pressure, annular friction pressure, annular temperature, equivalent circulating density, etc. may also be stored in the data warehouse.

In another example, another type of system that may include various sensors that collect data to be processed and/or transmitted to a computing environment according to certain embodiments includes a home automation or similar automated network in a different environment, such as an office space, school, public space, sports venue, or a variety of other locations. Network devices in such an automated network may include network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). For example, network device 102 may include a home automation switch that may be coupled with a home appliance. In another embodiment, a network device can allow a user to access, control, and/or configure devices, such as office-related devices (e.g., copy machine, printer, or fax machine), audio and/or video related devices (e.g., a receiver, a speaker, a projector, a DVD player, or a television), media-playback devices (e.g., a compact disc player, a CD player, or the like), computing devices (e.g., a home computer, a laptop computer, a tablet, a personal digital assistant (PDA), a computing device, or a wearable device), lighting devices (e.g., a lamp or recessed lighting), devices associated with a security system, devices associated with an alarm system, devices that can be operated in an automobile (e.g., radio devices, navigation devices), and/or the like. Data may be collected from such various sensors in raw form, or data may be processed by the sensors to create parameters or other data either developed by the sensors based on the raw data or assigned to the system by a client or other controlling device.

In another example, another type of system that may include various sensors that collect data to be processed and/or transmitted to a computing environment according to certain embodiments includes a power or energy grid. A variety of different network devices may be included in an energy grid, such as various devices within one or more power plants, energy farms (e.g., wind farm, solar farm, among others) energy storage facilities, factories, homes and businesses of consumers, among others. One or more of such devices may include one or more sensors that detect energy gain or loss, electrical input or output or loss, and a variety of other efficiencies. These sensors may collect data to inform users of how the energy grid, and individual devices within the grid, may be functioning and how they may be made more efficient.

Network device sensors may also perform processing on data it collects before transmitting the data to the computing environment 114, or before deciding whether to transmit data to the computing environment 114. For example, network devices may determine whether data collected meets certain rules, for example by comparing data or values calculated from the data and comparing that data to one or more thresholds. The network device may use this data and/or comparisons to determine if the data should be transmitted to the computing environment 214 for further use or processing.

Computing environment 214 may include machines 220 and 240. Although computing environment 214 is shown in FIG. 2 as having two machines, 220 and 240, computing environment 214 may have only one machine or may have more than two machines. The machines that make up computing environment 214 may include specialized computers, servers, or other machines that are configured to individually and/or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with devices 230 via one or more routers 225. Computing environment 214 may collect, analyze and/or store data from or pertaining to communications, client device operations, client rules, and/or user-associated actions stored at one or more data stores 235. Such data may influence communication routing to the devices within computing environment 214, how data is stored or processed within computing environment 214, among other actions.

Notably, various other devices can further be used to influence communication routing and/or processing between devices within computing environment 214 and with devices outside of computing environment 214. For example, as shown in FIG. 2, computing environment 214 may include a web server 240. Thus, computing environment 214 can retrieve data of interest, such as client information (e.g., product information, client rules, etc.), technical product details, news, current or predicted weather, and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices may receive data periodically from network device sensors as the sensors continuously sense, monitor and track changes in their environments. Devices within computing environment 214 may also perform pre-analysis on data it receives to determine if the data received should be processed as part of an ongoing project. The data received and collected by computing environment 214, no matter what the source or method or timing of receipt, may be processed over a period of time for a client to determine results data based on the client's needs and rules.

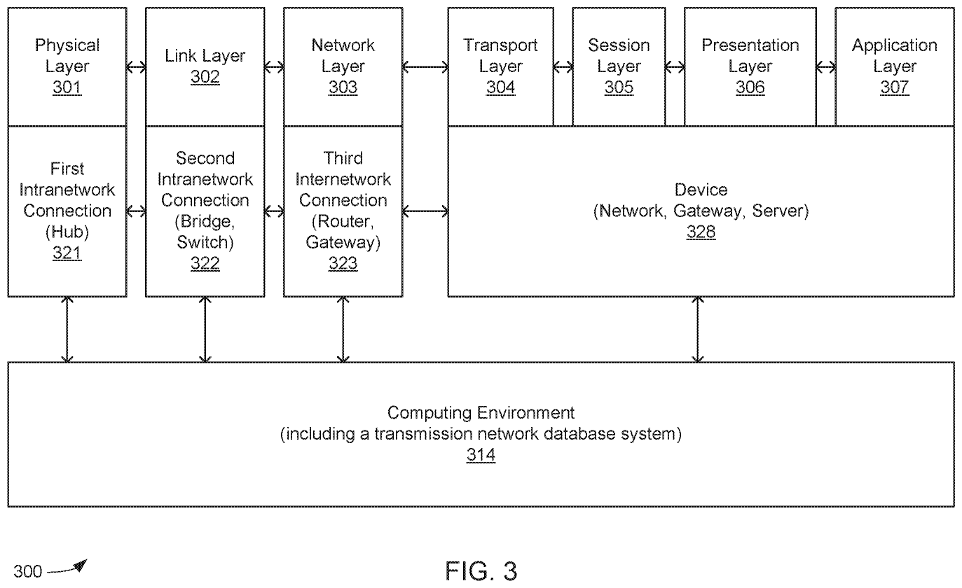

FIG. 3 illustrates a representation of a conceptual model of a communications protocol system, according to embodiments of the present technology. More specifically, FIG. 3 identifies operation of a computing environment in an Open Systems Interaction model that corresponds to various connection components. The model 300 shows, for example, how a computing environment, such as computing environment 314 (or computing environment 214 in FIG. 2) may communicate with other devices in its network, and control how communications between the computing environment and other devices are executed and under what conditions.

The model can include layers 301-307. The layers are arranged in a stack. Each layer in the stack serves the layer one level higher than it (except for the application layer, which is the highest layer), and is served by the layer one level below it (except for the physical layer, which is the lowest layer). The physical layer is the lowest layer because it receives and transmits raw bites of data, and is the farthest layer from the user in a communications system. On the other hand, the application layer is the highest layer because it interacts directly with a software application.

As noted, the model includes a physical layer 301. Physical layer 301 represents physical communication, and can define parameters of that physical communication. For example, such physical communication may come in the form of electrical, optical, or electromagnetic signals. Physical layer 301 also defines protocols that may control communications within a data transmission network.

Link layer 302 defines links and mechanisms used to transmit (i.e., move) data across a network. The link layer 302 manages node-to-node communications, such as within a grid computing environment. Link layer 302 can detect and correct errors (e.g., transmission errors in the physical layer 301). Link layer 302 can also include a media access control (MAC) layer and logical link control (LLC) layer.

Network layer 303 defines the protocol for routing within a network. In other words, the network layer coordinates transferring data across nodes in a same network (e.g., such as a grid computing environment). Network layer 303 can also define the processes used to structure local addressing within the network.

Transport layer 304 can manage the transmission of data and the quality of the transmission and/or receipt of that data. Transport layer 304 can provide a protocol for transferring data, such as, for example, a Transmission Control Protocol (TCP). Transport layer 304 can assemble and disassemble data frames for transmission. The transport layer can also detect transmission errors occurring in the layers below it.

Session layer 305 can establish, maintain, and manage communication connections between devices on a network. In other words, the session layer controls the dialogues or nature of communications between network devices on the network. The session layer may also establish checkpointing, adjournment, termination, and restart procedures.

Presentation layer 306 can provide translation for communications between the application and network layers. In other words, this layer may encrypt, decrypt and/or format data based on data types and/or encodings known to be accepted by an application or network layer.

Application layer 307 interacts directly with software applications and end users, and manages communications between them. Application layer 307 can identify destinations, local resource states or availability and/or communication content or formatting using the applications.

Intra-network connection components 321 and 322 are shown to operate in lower levels, such as physical layer 301 and link layer 302, respectively. For example, a hub can operate in the physical layer, a switch can operate in the link layer, and a router can operate in the network layer. Inter-network connection components 323 and 328 are shown to operate on higher levels, such as layers 303-307. For example, routers can operate in the network layer and network devices can operate in the transport, session, presentation, and application layers.

As noted, a computing environment 314 can interact with and/or operate on, in various embodiments, one, more, all or any of the various layers. For example, computing environment 314 can interact with a hub (e.g., via the link layer) so as to adjust which devices the hub communicates with. The physical layer may be served by the link layer, so it may implement such data from the link layer. For example, the computing environment 314 may control which devices it will receive data from. For example, if the computing environment 314 knows that a certain network device has turned off, broken, or otherwise become unavailable or unreliable, the computing environment 314 may instruct the hub to prevent any data from being transmitted to the computing environment 314 from that network device. Such a process may be beneficial to avoid receiving data that is inaccurate or that has been influenced by an uncontrolled environment. As another example, computing environment 314 can communicate with a bridge, switch, router or gateway and influence which device within the system (e.g., system 200) the component selects as a destination. In some embodiments, computing environment 314 can interact with various layers by exchanging communications with equipment operating on a particular layer by routing or modifying existing communications. In another embodiment, such as in a grid computing environment, a node may determine how data within the environment should be routed (e.g., which node should receive certain data) based on certain parameters or information provided by other layers within the model.

As noted, the computing environment 314 may be a part of a communications grid environment, the communications of which may be implemented as shown in the protocol of FIG. 3. For example, referring back to FIG. 2, one or more of machines 220 and 240 may be part of a communications grid computing environment. A gridded computing environment may be employed in a distributed system with non-interactive workloads where data resides in memory on the machines, or compute nodes. In such an environment, analytic code, instead of a database management system, controls the processing performed by the nodes. Data is co-located by pre-distributing it to the grid nodes, and the analytic code on each node loads the local data into memory. Each node may be assigned a particular task such as a portion of a processing project, or to organize or control other nodes within the grid.

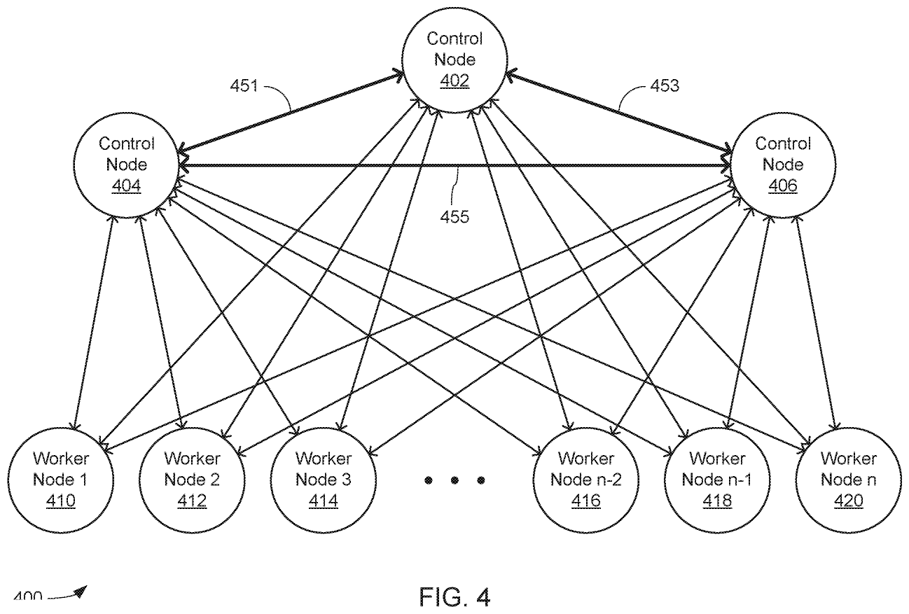

FIG. 4 illustrates a communications grid computing system 400 including a variety of control and worker nodes, according to embodiments of the present technology. Communications grid computing system 400 includes three control nodes and one or more worker nodes. Communications grid computing system 400 includes control nodes 402, 404, and 406. The control nodes are communicatively connected via communication paths 451, 453, and 455. Therefore, the control nodes may transmit information (e.g., related to the communications grid or notifications), to and receive information from each other. Although communications grid computing system 400 is shown in FIG. 4 as including three control nodes, the communications grid may include more or less than three control nodes.

Communications grid computing system (or just “communications grid”) 400 also includes one or more worker nodes. Shown in FIG. 4 are six worker nodes 410-420. Although FIG. 4 shows six worker nodes, a communications grid according to embodiments of the present technology may include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid 400 may be connected (wired or wirelessly, and directly or indirectly) to control nodes 402-406. Therefore, each worker node may receive information from the control nodes (e.g., an instruction to perform work on a project) and may transmit information to the control nodes (e.g., a result from work performed on a project). Furthermore, worker nodes may communicate with each other (either directly or indirectly). For example, worker nodes may transmit data between each other related to a job being performed or an individual task within a job being performed by that worker node. However, in certain embodiments, worker nodes may not, for example, be connected (communicatively or otherwise) to certain other worker nodes. In an embodiment, worker nodes may only be able to communicate with the control node that controls it, and may not be able to communicate with other worker nodes in the communications grid, whether they are other worker nodes controlled by the control node that controls the worker node, or worker nodes that are controlled by other control nodes in the communications grid.

A control node may connect with an external device with which the control node may communicate (e.g., a grid user, such as a server or computer, may connect to a controller of the grid). For example, a server or computer may connect to control nodes and may transmit a project or job to the node. The project may include a data set. The data set may be of any size. Once the control node receives such a project including a large data set, the control node may distribute the data set or projects related to the data set to be performed by worker nodes. Alternatively, for a project including a large data set, the data set may be received or stored by a machine other than a control node (e.g., a HADOOP® standard-compliant data node employing the HADOOP® Distributed File System, or HDFS).

Control nodes may maintain knowledge of the status of the nodes in the grid (i.e., grid status information), accept work requests from clients, subdivide the work across worker nodes, and coordinate the worker nodes, among other responsibilities. Worker nodes may accept work requests from a control node and provide the control node with results of the work performed by the worker node. A grid may be started from a single node (e.g., a machine, computer, server, etc.). This first node may be assigned or may start as the primary control node that will control any additional nodes that enter the grid.

When a project is submitted for execution (e.g., by a client or a controller of the grid) it may be assigned to a set of nodes. After the nodes are assigned to a project, a data structure (i.e., a communicator) may be created. The communicator may be used by the project for information to be shared between the project codes running on each node. A communication handle may be created on each node. A handle, for example, is a reference to the communicator that is valid within a single process on a single node, and the handle may be used when requesting communications between nodes.

A control node, such as control node 402, may be designated as the primary control node. A server, computer or other external device may connect to the primary control node. Once the control node receives a project, the primary control node may distribute portions of the project to its worker nodes for execution. For example, when a project is initiated on communications grid 400, primary control node 402 controls the work to be performed for the project in order to complete the project as requested or instructed. The primary control node may distribute work to the worker nodes based on various factors, such as which subsets or portions of projects may be completed most efficiently and in the correct amount of time. For example, a worker node may perform analysis on a portion of data that is already local (e.g., stored on) the worker node. The primary control node also coordinates and processes the results of the work performed by each worker node after each worker node executes and completes its job. For example, the primary control node may receive a result from one or more worker nodes, and the control node may organize (e.g., collect and assemble) the results received and compile them to produce a complete result for the project received from the end user.

Any remaining control nodes, such as control nodes 404 and 406, may be assigned as backup control nodes for the project. In an embodiment, backup control nodes may not control any portion of the project. Instead, backup control nodes may serve as a backup for the primary control node and take over as primary control node if the primary control node were to fail. If a communications grid were to include only a single control node, and the control node were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes, including a backup control node, may be beneficial.

To add another node or machine to the grid, the primary control node may open a pair of listening sockets, for example. A socket may be used to accept work requests from clients, and the second socket may be used to accept connections from other grid nodes. The primary control node may be provided with a list of other nodes (e.g., other machines, computers, servers) that will participate in the grid, and the role that each node will fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other machines in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it will check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. However, a hierarchy of nodes may also be determined using methods other than using the unique identifiers of the nodes. For example, the hierarchy may be predetermined, or may be assigned based on other predetermined factors.

The grid may add new machines at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404 and 406 (and, for example, to other control or worker nodes within the communications grid). Such communications may be sent periodically, at fixed time intervals, between known fixed stages of the project's execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes in the grid, unique identifiers of the nodes, or their relationships with the primary control node) and the status of a project (including, for example, the status of each worker node's portion of the project). The snapshot may also include analysis or results received from worker nodes in the communications grid. The backup control nodes may receive and store the backup data received from the primary control node. The backup control nodes may transmit a request for such a snapshot (or other information) from the primary control node, or the primary control node may send such information periodically to the backup control nodes.

As noted, the backup data may allow the backup control node to take over as primary control node if the primary control node fails without requiring the grid to start the project over from scratch. If the primary control node fails, the backup control node that will take over as primary control node may retrieve the most recent version of the snapshot received from the primary control node and use the snapshot to continue the project from the stage of the project indicated by the backup data. This may prevent failure of the project as a whole.

A backup control node may use various methods to determine that the primary control node has failed. In one example of such a method, the primary control node may transmit (e.g., periodically) a communication to the backup control node that indicates that the primary control node is working and has not failed, such as a heartbeat communication. The backup control node may determine that the primary control node has failed if the backup control node has not received a heartbeat communication for a certain predetermined period of time. Alternatively, a backup control node may also receive a communication from the primary control node itself (before it failed) or from a worker node that the primary control node has failed, for example because the primary control node has failed to communicate with the worker node.

Different methods may be performed to determine which backup control node of a set of backup control nodes (e.g., backup control nodes 404 and 406) will take over for failed primary control node 402 and become the new primary control node. For example, the new primary control node may be chosen based on a ranking or “hierarchy” of backup control nodes based on their unique identifiers. In an alternative embodiment, a backup control node may be assigned to be the new primary control node by another device in the communications grid or from an external device (e.g., a system infrastructure or an end user, such as a server or computer, controlling the communications grid). In another alternative embodiment, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative embodiment, the primary control node may transmit a communication to each of the operable worker nodes still on the communications grid that each of the worker nodes should purposefully fail also. After each of the worker nodes fail, they may each retrieve their most recent saved checkpoint of their status and re-start the project from that checkpoint to minimize lost progress on the project being executed.

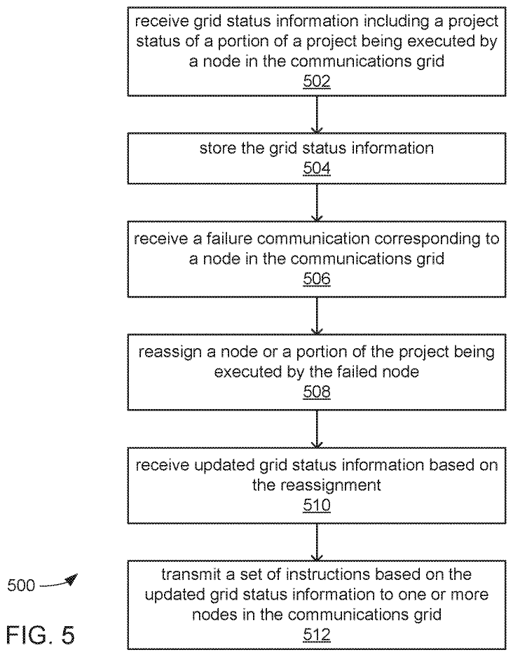

FIG. 5 illustrates a flow chart showing an example process 500 for adjusting a communications grid or a work project in a communications grid after a failure of a node, according to embodiments of the present technology. The process may include, for example, receiving grid status information including a project status of a portion of a project being executed by a node in the communications grid, as described in operation 502. For example, a control node (e.g., a backup control node connected to a primary control node and a worker node on a communications grid) may receive grid status information, where the grid status information includes a project status of the primary control node or a project status of the worker node. The project status of the primary control node and the project status of the worker node may include a status of one or more portions of a project being executed by the primary and worker nodes in the communications grid. The process may also include storing the grid status information, as described in operation 504. For example, a control node (e.g., a backup control node) may store the received grid status information locally within the control node. Alternatively, the grid status information may be sent to another device for storage where the control node may have access to the information.

The process may also include receiving a failure communication corresponding to a node in the communications grid in operation 506. For example, a node may receive a failure communication including an indication that the primary control node has failed, prompting a backup control node to take over for the primary control node. In an alternative embodiment, a node may receive a failure that a worker node has failed, prompting a control node to reassign the work being performed by the worker node. The process may also include reassigning a node or a portion of the project being executed by the failed node, as described in operation 508. For example, a control node may designate the backup control node as a new primary control node based on the failure communication upon receiving the failure communication. If the failed node is a worker node, a control node may identify a project status of the failed worker node using the snapshot of the communications grid, where the project status of the failed worker node includes a status of a portion of the project being executed by the failed worker node at the failure time.

The process may also include receiving updated grid status information based on the reassignment, as described in operation 510, and transmitting a set of instructions based on the updated grid status information to one or more nodes in the communications grid, as described in operation 512. The updated grid status information may include an updated project status of the primary control node or an updated project status of the worker node. The updated information may be transmitted to the other nodes in the grid to update their stale stored information.

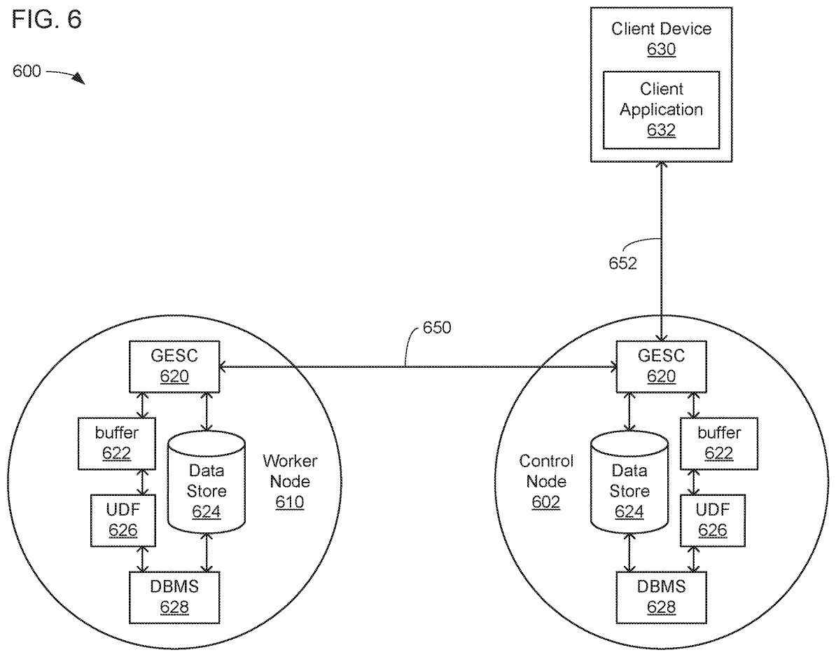

FIG. 6 illustrates a portion of a communications grid computing system 600 including a control node and a worker node, according to embodiments of the present technology. Communications grid 600 computing system includes one control node (control node 602) and one worker node (worker node 610) for purposes of illustration, but may include more worker and/or control nodes. The control node 602 is communicatively connected to worker node 610 via communication path 650. Therefore, control node 602 may transmit information (e.g., related to the communications grid or notifications), to and receive information from worker node 610 via path 650.

Similar to in FIG. 4, communications grid computing system (or just “communications grid”) 600 includes data processing nodes (control node 602 and worker node 610). Nodes 602 and 610 include multi-core data processors. Each node 602 and 610 includes a grid-enabled software component (GESC) 620 that executes on the data processor associated with that node and interfaces with buffer memory 622 also associated with that node. Each node 602 and 610 includes database management software (DBMS) 628 that executes on a database server (not shown) at control node 602 and on a database server (not shown) at worker node 610.

Each node also includes a data store 624. Data stores 624, similar to network-attached data stores 110 in FIG. 1 and data stores 235 in FIG. 2, are used to store data to be processed by the nodes in the computing environment. Data stores 624 may also store any intermediate or final data generated by the computing system after being processed, for example in non-volatile memory. However, in certain embodiments, the configuration of the grid computing environment allows its operations to be performed such that intermediate and final data results can be stored solely in volatile memory (e.g., RAM), without a requirement that intermediate or final data results be stored to non-volatile types of memory. Storing such data in volatile memory may be useful in certain situations, such as when the grid receives queries (e.g., ad hoc) from a client and when responses, which are generated by processing large amounts of data, need to be generated quickly or on-the-fly. In such a situation, the grid may be configured to retain the data within memory so that responses can be generated at different levels of detail and so that a client may interactively query against this information.

Each node also includes a user-defined function (UDF) 626. The UDF provides a mechanism for the DBMS 628 to transfer data to or receive data from the database stored in the data stores 624 that are managed by the DBMS. For example, UDF 626 can be invoked by the DBMS to provide data to the GESC for processing. The UDF 626 may establish a socket connection (not shown) with the GESC to transfer the data. Alternatively, the UDF 626 can transfer data to the GESC by writing data to shared memory accessible by both the UDF and the GESC.

The GESC 620 at the nodes 602 and 620 may be connected via a network, such as network 108 shown in FIG. 1. Therefore, nodes 602 and 620 can communicate with each other via the network using a predetermined communication protocol such as, for example, the Message Passing Interface (MPI). Each GESC 620 can engage in point-to-point communication with the GESC at another node or in collective communication with multiple GESCs via the network. The GESC 620 at each node may contain identical (or nearly identical) software instructions. Each node may be capable of operating as either a control node or a worker node. The GESC at the control node 602 can communicate, over a communication path 652, with a client deice 630. More specifically, control node 602 may communicate with client application 632 hosted by the client device 630 to receive queries and to respond to those queries after processing large amounts of data.

DBMS 628 may control the creation, maintenance, and use of database or data structure (not shown) within a nodes 602 or 610. The database may organize data stored in data stores 624. The DBMS 628 at control node 602 may accept requests for data and transfer the appropriate data for the request. With such a process, collections of data may be distributed across multiple physical locations. In this example, each node 602 and 610 stores a portion of the total data managed by the management system in its associated data store 624.

Furthermore, the DBMS may be responsible for protecting against data loss using replication techniques. Replication includes providing a backup copy of data stored on one node on one or more other nodes. Therefore, if one node fails, the data from the failed node can be recovered from a replicated copy residing at another node. However, as described herein with respect to FIG. 4, data or status information for each node in the communications grid may also be shared with each node on the grid.

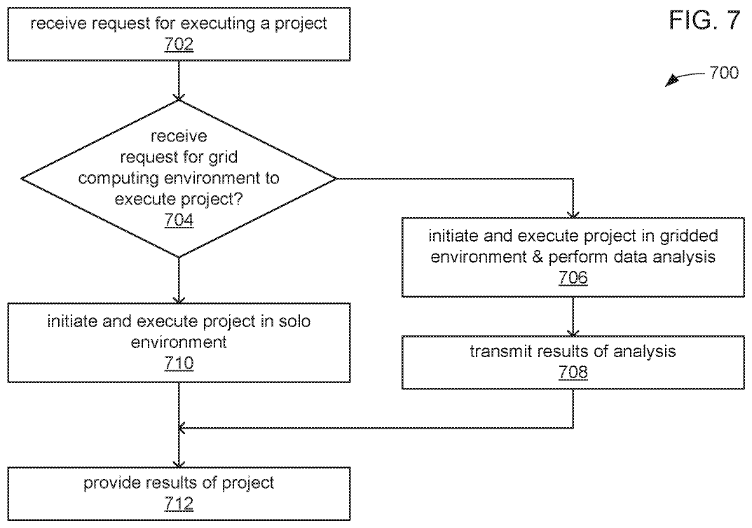

FIG. 7 illustrates a flow chart showing an example method 700 for executing a project within a grid computing system, according to embodiments of the present technology. As described with respect to FIG. 6, the GESC at the control node may transmit data with a client device (e.g., client device 630) to receive queries for executing a project and to respond to those queries after large amounts of data have been processed. The query may be transmitted to the control node, where the query may include a request for executing a project, as described in operation 702. The query can contain instructions on the type of data analysis to be performed in the project and whether the project should be executed using the grid-based computing environment, as shown in operation 704.

To initiate the project, the control node may determine if the query requests use of the grid-based computing environment to execute the project. If the determination is no, then the control node initiates execution of the project in a solo environment (e.g., at the control node), as described in operation 710. If the determination is yes, the control node may initiate execution of the project in the grid-based computing environment, as described in operation 706. In such a situation, the request may include a requested configuration of the grid. For example, the request may include a number of control nodes and a number of worker nodes to be used in the grid when executing the project. After the project has been completed, the control node may transmit results of the analysis yielded by the grid, as described in operation 708. Whether the project is executed in a solo or grid-based environment, the control node provides the results of the project, as described in operation 712.

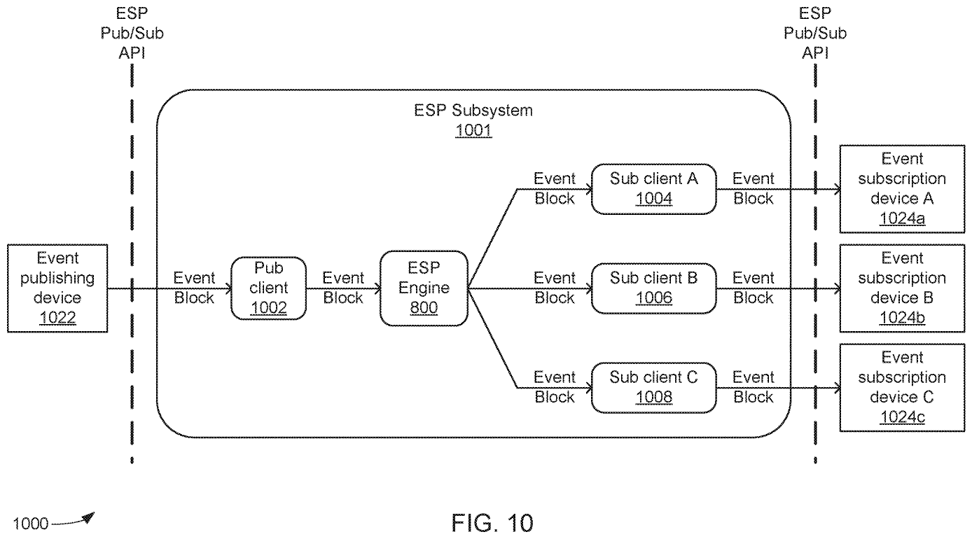

As noted with respect to FIG. 2, the computing environments described herein may collect data (e.g., as received from network devices, such as sensors, such as network devices 204-209 in FIG. 2, and client devices or other sources) to be processed as part of a data analytics project, and data may be received in real time as part of a streaming analytics environment (e.g., ESP). Data may be collected using a variety of sources as communicated via different kinds of networks or locally, such as on a real-time streaming basis. For example, network devices may receive data periodically from network device sensors as the sensors continuously sense, monitor and track changes in their environments. More specifically, an increasing number of distributed applications develop or produce continuously flowing data from distributed sources by applying queries to the data before distributing the data to geographically distributed recipients. An event stream processing engine (ESPE) may continuously apply the queries to the data as it is received and determines which entities should receive the data. Client or other devices may also subscribe to the ESPE or other devices processing ESP data so that they can receive data after processing, based on for example the entities determined by the processing engine. For example, client devices 230 in FIG. 2 may subscribe to the ESPE in computing environment 214. In another example, event subscription devices 1024a-c, described further with respect to FIG. 10, may also subscribe to the ESPE. The ESPE may determine or define how input data or event streams from network devices or other publishers (e.g., network devices 204-209 in FIG. 2) are transformed into meaningful output data to be consumed by subscribers, such as for example client devices 230 in FIG. 2.

FIG. 8 illustrates a block diagram including components of an Event Stream Processing Engine (ESPE), according to embodiments of the present technology. ESPE 800 may include one or more projects 802. A project may be described as a second-level container in an engine model managed by ESPE 800 where a thread pool size for the project may be defined by a user. Each project of the one or more projects 802 may include one or more continuous queries 804 that contain data flows, which are data transformations of incoming event streams. The one or more continuous queries 804 may include one or more source windows 806 and one or more derived windows 808.

The ESPE may receive streaming data over a period of time related to certain events, such as events or other data sensed by one or more network devices. The ESPE may perform operations associated with processing data created by the one or more devices. For example, the ESPE may receive data from the one or more network devices 204-209 shown in FIG. 2. As noted, the network devices may include sensors that sense different aspects of their environments, and may collect data over time based on those sensed observations. For example, the ESPE may be implemented within one or more of machines 220 and 240 shown in FIG. 2. The ESPE may be implemented within such a machine by an ESP application. An ESP application may embed an ESPE with its own dedicated thread pool or pools into its application space where the main application thread can do application-specific work and the ESPE processes event streams at least by creating an instance of a model into processing objects.

The engine container is the top-level container in a model that manages the resources of the one or more projects 802. In an illustrative embodiment, for example, there may be only one ESPE 800 for each instance of the ESP application, and ESPE 800 may have a unique engine name. Additionally, the one or more projects 802 may each have unique project names, and each query may have a unique continuous query name and begin with a uniquely named source window of the one or more source windows 806. ESPE 800 may or may not be persistent.

Continuous query modeling involves defining directed graphs of windows for event stream manipulation and transformation. A window in the context of event stream manipulation and transformation is a processing node in an event stream processing model. A window in a continuous query can perform aggregations, computations, pattern-matching, and other operations on data flowing through the window. A continuous query may be described as a directed graph of source, relational, pattern matching, and procedural windows. The one or more source windows 806 and the one or more derived windows 808 represent continuously executing queries that generate updates to a query result set as new event blocks stream through ESPE 800. A directed graph, for example, is a set of nodes connected by edges, where the edges have a direction associated with them.

An event object may be described as a packet of data accessible as a collection of fields, with at least one of the fields defined as a key or unique identifier (ID). The event object may be created using a variety of formats including binary, alphanumeric, XML, etc. Each event object may include one or more fields designated as a primary identifier (ID) for the event so ESPE 800 can support operation codes (opcodes) for events including insert, update, upsert, and delete. Upsert opcodes update the event if the key field already exists; otherwise, the event is inserted. For illustration, an event object may be a packed binary representation of a set of field values and include both metadata and field data associated with an event. The metadata may include an opcode indicating if the event represents an insert, update, delete, or upsert, a set of flags indicating if the event is a normal, partial-update, or a retention generated event from retention policy management, and a set of microsecond timestamps that can be used for latency measurements.

An event block object may be described as a grouping or package of event objects. An event stream may be described as a flow of event block objects. A continuous query of the one or more continuous queries 804 transforms a source event stream made up of streaming event block objects published into ESPE 800 into one or more output event streams using the one or more source windows 806 and the one or more derived windows 808. A continuous query can also be thought of as data flow modeling.

The one or more source windows 806 are at the top of the directed graph and have no windows feeding into them. Event streams are published into the one or more source windows 806, and from there, the event streams may be directed to the next set of connected windows as defined by the directed graph. The one or more derived windows 808 are all instantiated windows that are not source windows and that have other windows streaming events into them. The one or more derived windows 808 may perform computations or transformations on the incoming event streams. The one or more derived windows 808 transform event streams based on the window type (that is operators such as join, filter, compute, aggregate, copy, pattern match, procedural, union, etc.) and window settings. As event streams are published into ESPE 800, they are continuously queried, and the resulting sets of derived windows in these queries are continuously updated.

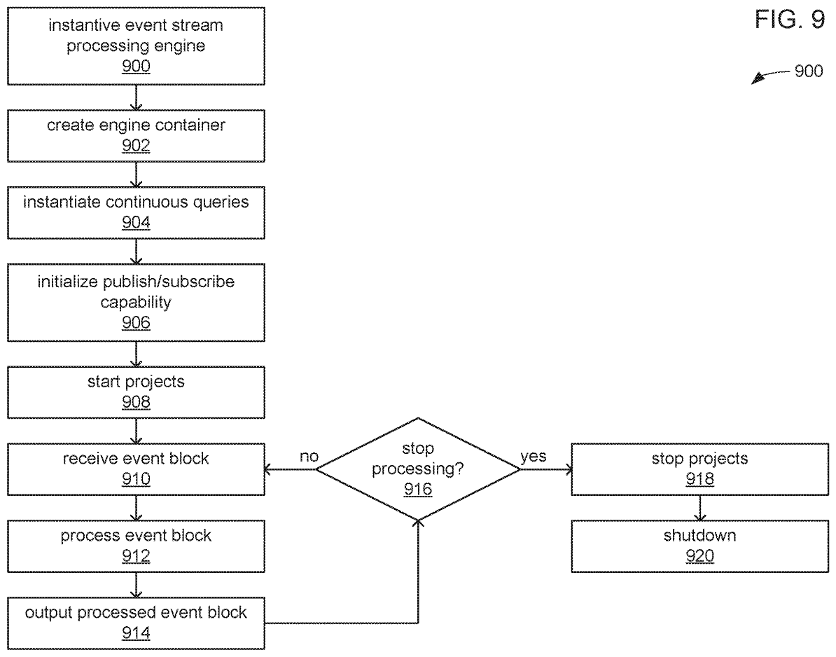

FIG. 9 illustrates a flow chart showing an example process including operations performed by an event stream processing engine, according to some embodiments of the present technology. As noted, the ESPE 800 (or an associated ESP application) defines how input event streams are transformed into meaningful output event streams. More specifically, the ESP application may define how input event streams from publishers (e.g., network devices providing sensed data) are transformed into meaningful output event streams consumed by subscribers (e.g., a data analytics project being executed by a machine or set of machines).

Within the application, a user may interact with one or more user interface windows presented to the user in a display under control of the ESPE independently or through a browser application in an order selectable by the user. For example, a user may execute an ESP application, which causes presentation of a first user interface window, which may include a plurality of menus and selectors such as drop down menus, buttons, text boxes, hyperlinks, etc. associated with the ESP application as understood by a person of skill in the art. As further understood by a person of skill in the art, various operations may be performed in parallel, for example, using a plurality of threads.

At operation 900, an ESP application may define and start an ESPE, thereby instantiating an ESPE at a device, such as machine 220 and/or 240. In an operation 902, the engine container is created. For illustration, ESPE 800 may be instantiated using a function call that specifies the engine container as a manager for the model.

In an operation 904, the one or more continuous queries 804 are instantiated by ESPE 800 as a model. The one or more continuous queries 804 may be instantiated with a dedicated thread pool or pools that generate updates as new events stream through ESPE 800. For illustration, the one or more continuous queries 804 may be created to model business processing logic within ESPE 800, to predict events within ESPE 800, to model a physical system within ESPE 800, to predict the physical system state within ESPE 800, etc. For example, as noted, ESPE 800 may be used to support sensor data monitoring and management (e.g., sensing may include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, or electrical current, etc.).

ESPE 800 may analyze and process events in motion or “event streams.” Instead of storing data and running queries against the stored data, ESPE 800 may store queries and stream data through them to allow continuous analysis of data as it is received. The one or more source windows 806 and the one or more derived windows 808 may be created based on the relational, pattern matching, and procedural algorithms that transform the input event streams into the output event streams to model, simulate, score, test, predict, etc. based on the continuous query model defined and application to the streamed data.

In an operation 906, a publish/subscribe (pub/sub) capability is initialized for ESPE 800. In an illustrative embodiment, a pub/sub capability is initialized for each project of the one or more projects 802. To initialize and enable pub/sub capability for ESPE 800, a port number may be provided. Pub/sub clients can use a host name of an ESP device running the ESPE and the port number to establish pub/sub connections to ESPE 800.

FIG. 10 illustrates an ESP system 1000 interfacing between publishing device 1022 and event subscribing devices 1024a-c, according to embodiments of the present technology. ESP system 1000 may include ESP device or subsystem 851, event publishing device 1022, an event subscribing device A 1024a, an event subscribing device B 1024b, and an event subscribing device C 1024c. Input event streams are output to ESP device 851 by publishing device 1022. In alternative embodiments, the input event streams may be created by a plurality of publishing devices. The plurality of publishing devices further may publish event streams to other ESP devices. The one or more continuous queries instantiated by ESPE 800 may analyze and process the input event streams to form output event streams output to event subscribing device A 1024a, event subscribing device B 1024b, and event subscribing device C 1024c. ESP system 1000 may include a greater or a fewer number of event subscribing devices of event subscribing devices.

Publish-subscribe is a message-oriented interaction paradigm based on indirect addressing. Processed data recipients specify their interest in receiving information from ESPE 800 by subscribing to specific classes of events, while information sources publish events to ESPE 800 without directly addressing the receiving parties. ESPE 800 coordinates the interactions and processes the data. In some cases, the data source receives confirmation that the published information has been received by a data recipient.

A publish/subscribe API may be described as a library that enables an event publisher, such as publishing device 1022, to publish event streams into ESPE 800 or an event subscriber, such as event subscribing device A 1024a, event subscribing device B 1024b, and event subscribing device C 1024c, to subscribe to event streams from ESPE 800. For illustration, one or more publish/subscribe APIs may be defined. Using the publish/subscribe API, an event publishing application may publish event streams into a running event stream processor project source window of ESPE 800, and the event subscription application may subscribe to an event stream processor project source window of ESPE 800.

The publish/subscribe API provides cross-platform connectivity and endianness compatibility between ESP application and other networked applications, such as event publishing applications instantiated at publishing device 1022, and event subscription applications instantiated at one or more of event subscribing device A 1024a, event subscribing device B 1024b, and event subscribing device C 1024c.

Referring back to FIG. 9, operation 906 initializes the publish/subscribe capability of ESPE 800. In an operation 908, the one or more projects 802 are started. The one or more started projects may run in the background on an ESP device. In an operation 910, an event block object is received from one or more computing device of the event publishing device 1022.

ESP subsystem 800 may include a publishing client 1002, ESPE 800, a subscribing client A 1004, a subscribing client B 1006, and a subscribing client C 1008. Publishing client 1002 may be started by an event publishing application executing at publishing device 1022 using the publish/subscribe API. Subscribing client A 1004 may be started by an event subscription application A, executing at event subscribing device A 1024a using the publish/subscribe API. Subscribing client B 1006 may be started by an event subscription application B executing at event subscribing device B 1024b using the publish/subscribe API. Subscribing client C 1008 may be started by an event subscription application C executing at event subscribing device C 1024c using the publish/subscribe API.

An event block object containing one or more event objects is injected into a source window of the one or more source windows 806 from an instance of an event publishing application on event publishing device 1022. The event block object may be generated, for example, by the event publishing application and may be received by publishing client 1002. A unique ID may be maintained as the event block object is passed between the one or more source windows 806 and/or the one or more derived windows 808 of ESPE 800, and to subscribing client A 1004, subscribing client B 1006, and subscribing client C 1008 and to event subscription device A 1024a, event subscription device B 1024b, and event subscription device C 1024c. Publishing client 1002 may further generate and include a unique embedded transaction ID in the event block object as the event block object is processed by a continuous query, as well as the unique ID that publishing device 1022 assigned to the event block object.

In an operation 912, the event block object is processed through the one or more continuous queries 804. In an operation 914, the processed event block object is output to one or more computing devices of the event subscribing devices 1024a-c. For example, subscribing client A 1004, subscribing client B 1006, and subscribing client C 1008 may send the received event block object to event subscription device A 1024a, event subscription device B 1024b, and event subscription device C 1024c, respectively.

ESPE 800 maintains the event block containership aspect of the received event blocks from when the event block is published into a source window and works its way through the directed graph defined by the one or more continuous queries 804 with the various event translations before being output to subscribers. Subscribers can correlate a group of subscribed events back to a group of published events by comparing the unique ID of the event block object that a publisher, such as publishing device 1022, attached to the event block object with the event block ID received by the subscriber.

In an operation 916, a determination is made concerning whether or not processing is stopped. If processing is not stopped, processing continues in operation 910 to continue receiving the one or more event streams containing event block objects from the, for example, one or more network devices. If processing is stopped, processing continues in an operation 918. In operation 918, the started projects are stopped. In operation 920, the ESPE is shutdown.

As noted, in some embodiments, big data is processed for an analytics project after the data is received and stored. In other embodiments, distributed applications process continuously flowing data in real-time from distributed sources by applying queries to the data before distributing the data to geographically distributed recipients. As noted, an event stream processing engine (ESPE) may continuously apply the queries to the data as it is received and determines which entities receive the processed data. This allows for large amounts of data being received and/or collected in a variety of environments to be processed and distributed in real time. For example, as shown with respect to FIG. 2, data may be collected from network devices that may include devices within the internet of things, such as devices within a home automation network. However, such data may be collected from a variety of different resources in a variety of different environments. In any such situation, embodiments of the present technology allow for real-time processing of such data.

Aspects of the current disclosure provide technical solutions to technical problems, such as computing problems that arise when an ESP device fails which results in a complete service interruption and potentially significant data loss. The data loss can be catastrophic when the streamed data is supporting mission critical operations such as those in support of an ongoing manufacturing or drilling operation. An embodiment of an ESP system achieves a rapid and seamless failover of ESPE running at the plurality of ESP devices without service interruption or data loss, thus significantly improving the reliability of an operational system that relies on the live or real-time processing of the data streams. The event publishing systems, the event subscribing systems, and each ESPE not executing at a failed ESP device are not aware of or effected by the failed ESP device. The ESP system may include thousands of event publishing systems and event subscribing systems. The ESP system keeps the failover logic and awareness within the boundaries of out-messaging network connector and out-messaging network device.

In one example embodiment, a system is provided to support a failover when event stream processing (ESP) event blocks. The system includes, but is not limited to, an out-messaging network device and a computing device. The computing device includes, but is not limited to, a processor and a computer-readable medium operably coupled to the processor. The processor is configured to execute an ESP engine (ESPE). The computer-readable medium has instructions stored thereon that, when executed by the processor, cause the computing device to support the failover. An event block object is received from the ESPE that includes a unique identifier. A first status of the computing device as active or standby is determined. When the first status is active, a second status of the computing device as newly active or not newly active is determined. Newly active is determined when the computing device is switched from a standby status to an active status. When the second status is newly active, a last published event block object identifier that uniquely identifies a last published event block object is determined. A next event block object is selected from a non-transitory computer-readable medium accessible by the computing device. The next event block object has an event block object identifier that is greater than the determined last published event block object identifier. The selected next event block object is published to an out-messaging network device. When the second status of the computing device is not newly active, the received event block object is published to the out-messaging network device. When the first status of the computing device is standby, the received event block object is stored in the non-transitory computer-readable medium.

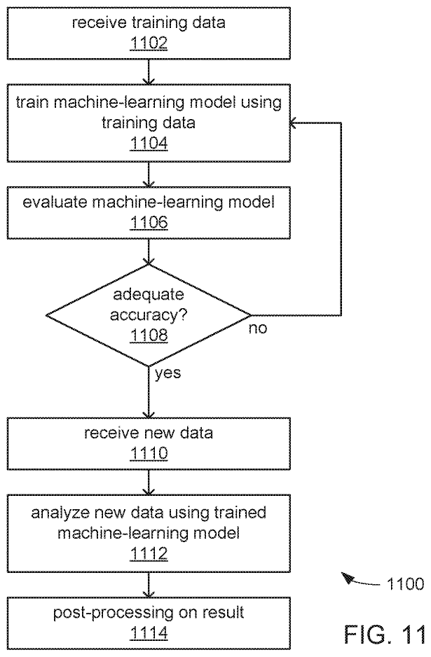

FIG. 11 is a flow chart of an example of a process for generating and using a machine-learning model according to some aspects. Machine learning is a branch of artificial intelligence that relates to mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusterers, such as k-means clusterers, mean-shift clusterers, and spectral clusterers; (v) factorizers, such as factorization machines, principal component analyzers and kernel principal component analyzers; and (vi) ensembles or other combinations of machine-learning models. In some examples, neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these.

Different machine-learning models may be used interchangeably to perform a task. Examples of tasks that can be performed at least partially using machine-learning models include various types of scoring; bioinformatics; cheminformatics; software engineering; fraud detection; customer segmentation; generating online recommendations; adaptive websites; determining customer lifetime value; search engines; placing advertisements in real time or near real time; classifying DNA sequences; affective computing; performing natural language processing and understanding; object recognition and computer vision; robotic locomotion; playing games; optimization and metaheuristics; detecting network intrusions; medical diagnosis and monitoring; or predicting when an asset, such as a machine, will need maintenance.

Any number and combination of tools can be used to create machine-learning models. Examples of tools for creating and managing machine-learning models can include SAS® Enterprise Miner, SAS® Rapid Predictive Modeler, and SAS® Model Manager, SAS Cloud Analytic Services (CAS)®, SAS Viya R of all which are by SAS Institute Inc. of Cary, North Carolina.

Machine-learning models can be constructed through an at least partially automated (e.g., with little or no human involvement) process called training. During training, input data can be iteratively supplied to a machine-learning model to enable the machine-learning model to identify patterns related to the input data or to identify relationships between the input data and output data. With training, the machine-learning model can be transformed from an untrained state to a trained state. Input data can be split into one or more training sets and one or more validation sets, and the training process may be repeated multiple times. The splitting may follow a k-fold cross-validation rule, a leave-one-out-rule, a leave-p-out rule, or a holdout rule. An overview of training and using a machine-learning model is described below with respect to the flow chart of FIG. 11.

In block 1102, training data is received. In some examples, the training data is received from a remote database or a local database, constructed from various subsets of data, or input by a user. The training data can be used in its raw form for training a machine-learning model or pre-processed into another form, which can then be used for training the machine-learning model. For example, the raw form of the training data can be smoothed, truncated, aggregated, clustered, or otherwise manipulated into another form, which can then be used for training the machine-learning model.

In block 1104, a machine-learning model is trained using the training data. The machine-learning model can be trained in a supervised, unsupervised, or semi-supervised manner. In supervised training, each input in the training data is correlated to a desired output. This desired output may be a scalar, a vector, or a different type of data structure such as text or an image. This may enable the machine-learning model to learn a mapping between the inputs and desired outputs. In unsupervised training, the training data includes inputs, but not desired outputs, so that the machine-learning model has to find structure in the inputs on its own. In semi-supervised training, only some of the inputs in the training data are correlated to desired outputs.

In block 1106, the machine-learning model is evaluated. For example, an evaluation dataset can be obtained, for example, via user input or from a database. The evaluation dataset can include inputs correlated to desired outputs. The inputs can be provided to the machine-learning model and the outputs from the machine-learning model can be compared to the desired outputs. If the outputs from the machine-learning model closely correspond with the desired outputs, the machine-learning model may have a high degree of accuracy. For example, if 90% or more of the outputs from the machine-learning model are the same as the desired outputs in the evaluation dataset, the machine-learning model may have a high degree of accuracy. Otherwise, the machine-learning model may have a low degree of accuracy. The 90% number is an example only. A realistic and desirable accuracy percentage is dependent on the problem and the data.

In some examples, if, at 1108, the machine-learning model has an inadequate degree of accuracy for a particular task, the process can return to block 1104, where the machine-learning model can be further trained using additional training data or otherwise modified to improve accuracy. However, if, at 1108. the machine-learning model has an adequate degree of accuracy for the particular task, the process can continue to block 1110.

In block 1110, new data is received. In some examples, the new data is received from a remote database or a local database, constructed from various subsets of data, or input by a user. The new data may be unknown to the machine-learning model. For example, the machine-learning model may not have previously processed or analyzed the new data.

In block 1112, the trained machine-learning model is used to analyze the new data and provide a result. For example, the new data can be provided as input to the trained machine-learning model. The trained machine-learning model can analyze the new data and provide a result that includes a classification of the new data into a particular class, a clustering of the new data into a particular group, a prediction based on the new data, or any combination of these.

In block 1114, the result is post-processed. For example, the result can be added to, multiplied with, or otherwise combined with other data as part of a job. As another example, the result can be transformed from a first format, such as a time series format, into another format, such as a count series format. Any number and combination of operations can be performed on the result during post-processing.

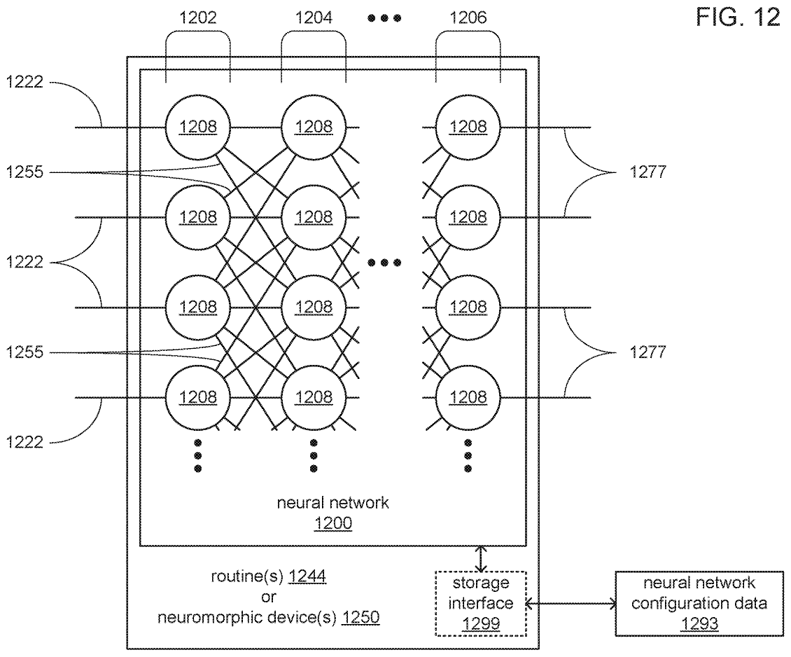

A more specific example of a machine-learning model is the neural network 1200 shown in FIG. 12. The neural network 1200 is represented as multiple layers of neurons 1208 that can exchange data between one another via connections 1255 that may be selectively instantiated thereamong. The layers include an input layer 1202 for receiving input data provided at inputs 1222, one or more hidden layers 1204, and an output layer 1206 for providing a result at outputs 1277. The hidden layer(s) 1204 are referred to as hidden because they may not be directly observable or have their inputs or outputs directly accessible during the normal functioning of the neural network 1200. Although the neural network 1200 is shown as having a specific number of layers and neurons for exemplary purposes, the neural network 1200 can have any number and combination of layers, and each layer can have any number and combination of neurons.

The neurons 1208 and connections 1255 thereamong may have numeric weights, which can be tuned during training of the neural network 1200. For example, training data can be provided to at least the inputs 1222 to the input layer 1202 of the neural network 1200, and the neural network 1200 can use the training data to tune one or more numeric weights of the neural network 1200. In some examples, the neural network 1200 can be trained using backpropagation. Backpropagation can include determining a gradient of a particular numeric weight based on a difference between an actual output of the neural network 1200 at the outputs 1277 and a desired output of the neural network 1200. Based on the gradient, one or more numeric weights of the neural network 1200 can be updated to reduce the difference therebetween, thereby increasing the accuracy of the neural network 1200. This process can be repeated multiple times to train the neural network 1200. For example, this process can be repeated hundreds or thousands of times to train the neural network 1200.

In some examples, the neural network 1200 is a feed-forward neural network. In a feed-forward neural network, the connections 1255 are instantiated and/or weighted so that every neuron 1208 only propagates an output value to a subsequent layer of the neural network 1200. For example, data may only move one direction (forward) from one neuron 1208 to the next neuron 1208 in a feed-forward neural network. Such a “forward” direction may be defined as proceeding from the input layer 1202 through the one or more hidden layers 1204, and toward the output layer 1206.

In other examples, the neural network 1200 may be a recurrent neural network. A recurrent neural network can include one or more feedback loops among the connections 1255, thereby allowing data to propagate in both forward and backward through the neural network 1200. Such a “backward” direction may be defined as proceeding in the opposite direction of forward, such as from the output layer 1206 through the one or more hidden layers 1204, and toward the input layer 1202. This can allow for information to persist within the recurrent neural network. For example, a recurrent neural network can determine an output based at least partially on information that the recurrent neural network has seen before, giving the recurrent neural network the ability to use previous input to inform the output.

In some examples, the neural network 1200 operates by receiving a vector of numbers from one layer; transforming the vector of numbers into a new vector of numbers using a matrix of numeric weights, a nonlinearity, or both; and providing the new vector of numbers to a subsequent layer (“subsequent” in the sense of moving “forward”) of the neural network 1200. Each subsequent layer of the neural network 1200 can repeat this process until the neural network 1200 outputs a final result at the outputs 1277 of the output layer 1206. For example, the neural network 1200 can receive a vector of numbers at the inputs 1222 of the input layer 1202. The neural network 1200 can multiply the vector of numbers by a matrix of numeric weights to determine a weighted vector. The matrix of numeric weights can be tuned during the training of the neural network 1200. The neural network 1200 can transform the weighted vector using a nonlinearity, such as a sigmoid tangent or the hyperbolic tangent. In some examples, the nonlinearity can include a rectified linear unit, which can be expressed using the equation y=max(x, o) where y is the output and x is an input value from the weighted vector. The transformed output can be supplied to a subsequent layer (e.g., a hidden layer 1204) of the neural network 1200. The subsequent layer of the neural network 1200 can receive the transformed output, multiply the transformed output by a matrix of numeric weights and a nonlinearity, and provide the result to yet another layer of the neural network 1200 (e.g., another, subsequent, hidden layer 1204). This process continues until the neural network 1200 outputs a final result at the outputs 1277 of the output layer 1206.

As also depicted in FIG. 12, the neural network 1200 may be implemented either through the execution of the instructions of one or more routines 1244 by central processing units (CPUs), or through the use of one or more neuromorphic devices 1250 that incorporate a set of memristors (or other similar components) that each function to implement one of the neurons 1208 in hardware. Where multiple neuromorphic devices 1250 are used, they may be interconnected in a depth-wise manner to enable implementing neural networks with greater quantities of layers, and/or in a width-wise manner to enable implementing neural networks having greater quantities of neurons 1208 per layer.

The neuromorphic device 1250 may incorporate a storage interface 1299 by which neural network configuration data 1293 that is descriptive of various parameters and hyper parameters of the neural network 1200 may be stored and/or retrieved. More specifically, the neural network configuration data 1293 may include such parameters as weighting and/or biasing values derived through the training of the neural network 1200, as has been described. Alternatively, or additionally, the neural network configuration data 1293 may include such hyperparameters as the manner in which the neurons 1208 are to be interconnected (e.g., feed-forward or recurrent), the trigger function to be implemented within the neurons 1208, the quantity of layers and/or the overall quantity of the neurons 1208. The neural network configuration data 1293 may provide such information for more than one neuromorphic device 1250 where multiple ones have been interconnected to support larger neural networks.

Other examples of the present disclosure may include any number and combination of machine-learning models having any number and combination of characteristics. The machine-learning model(s) can be trained in a supervised, semi-supervised, or unsupervised manner, or any combination of these. The machine-learning model(s) can be implemented using a single computing device or multiple computing devices, such as the communications grid computing system 400 discussed above.

Implementing some examples of the present disclosure at least in part by using machine-learning models can reduce the total number of processing iterations, time, memory, electrical power, or any combination of these consumed by a computing device when analyzing data. For example, a neural network may more readily identify patterns in data than other approaches. This may enable the neural network to analyze the data using fewer processing cycles and less memory than other approaches, while obtaining a similar or greater level of accuracy.

Some machine-learning approaches may be more efficiently and speedily executed and processed with machine-learning specific processors (e.g., not a generic CPU). Such processors may also provide an energy savings when compared to generic CPUs. For example, some of these processors can include a graphical processing unit (GPU), an application-specific integrated circuit (ASIC), a field-programmable gate array (FPGA), an artificial intelligence (AI) accelerator, a neural computing core, a neural computing engine, a neural processing unit, a purpose-built chip architecture for deep learning, and/or some other machine-learning specific processor that implements a machine learning approach or one or more neural networks using semiconductor (e.g., silicon (Si), gallium arsenide (GaAs)) devices. These processors may also be employed in heterogeneous computing architectures with a number of and/or a variety of different types of cores, engines, nodes, and/or layers to achieve various energy efficiencies, processing speed improvements, data communication speed improvements, and/or data efficiency targets and improvements throughout various parts of the system when compared to a homogeneous computing architecture that employs CPUs for general purpose computing.

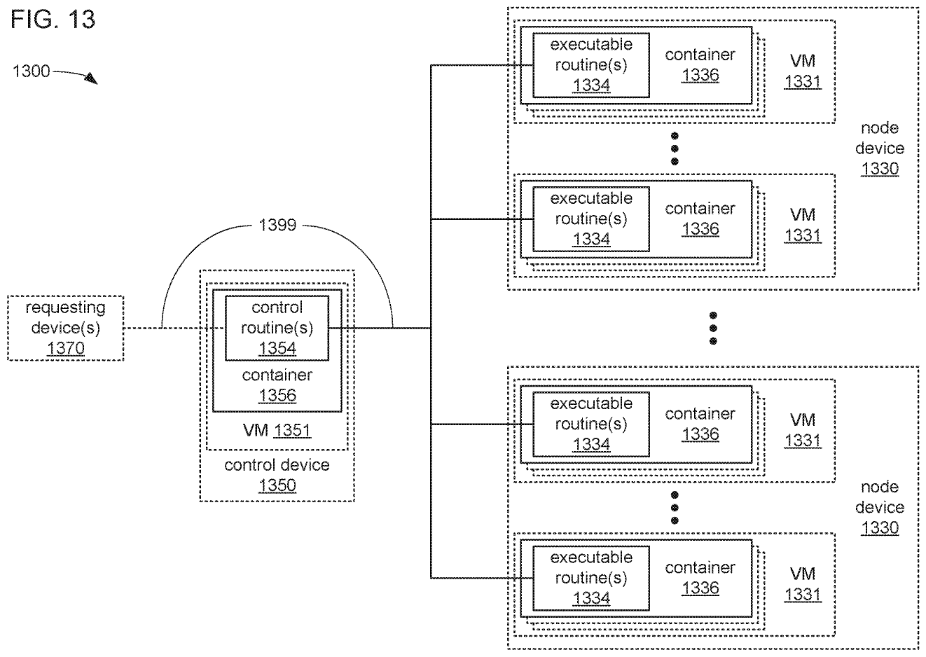

FIG. 13 illustrates various aspects of the use of containers 1336 as a mechanism to allocate processing, storage and/or other resources of a processing system 1300 to the performance of various analyses. More specifically, in a processing system 1300 that includes one or more node devices 1330 (e.g., the aforedescribed grid system 400), the processing, storage and/or other resources of each node device 1330 may be allocated through the instantiation and/or maintenance of multiple containers 1336 within the node devices 1330 to support the performance(s) of one or more analyses. As each container 1336 is instantiated, predetermined amounts of processing, storage and/or other resources may be allocated thereto as part of creating an execution environment therein in which one or more executable routines 1334 may be executed to cause the performance of part or all of each analysis that is requested to be performed.

It may be that at least a subset of the containers 1336 are each allocated a similar combination and amounts of resources so that each is of a similar configuration with a similar range of capabilities, and therefore, are interchangeable. This may be done in embodiments in which it is desired to have at least such a subset of the containers 1336 already instantiated prior to the receipt of requests to perform analyses, and thus, prior to the specific resource requirements of each of those analyses being known.

Alternatively, or additionally, it may be that at least a subset of the containers 1336 are not instantiated until after the processing system 1300 receives requests to perform analyses where each request may include indications of the resources required for one of those analyses. Such information concerning resource requirements may then be used to guide the selection of resources and/or the amount of each resource allocated to each such container 1336. As a result, it may be that one or more of the containers 1336 are caused to have somewhat specialized configurations such that there may be differing types of containers to support the performance of different analyses and/or different portions of analyses.

It may be that the entirety of the logic of a requested analysis is implemented within a single executable routine 1334. In such embodiments, it may be that the entirety of that analysis is performed within a single container 1336 as that single executable routine 1334 is executed therein. However, it may be that such a single executable routine 1334, when executed, is at least intended to cause the instantiation of multiple instances of itself that are intended to be executed at least partially in parallel. This may result in the execution of multiple instances of such an executable routine 1334 within a single container 1336 and/or across multiple containers 1336.

Alternatively, or additionally, it may be that the logic of a requested analysis is implemented with multiple differing executable routines 1334. In such embodiments, it may be that at least a subset of such differing executable routines 1334 are executed within a single container 1336. However, it may be that the execution of at least a subset of such differing executable routines 1334 is distributed across multiple containers 1336.

Where an executable routine 1334 of an analysis is under development, and/or is under scrutiny to confirm its functionality, it may be that the container 1336 within which that executable routine 1334 is to be executed is additionally configured assist in limiting and/or monitoring aspects of the functionality of that executable routine 1334. More specifically, the execution environment provided by such a container 1336 may be configured to enforce limitations on accesses that are allowed to be made to memory and/or I/O addresses to control what storage locations and/or I/O devices may be accessible to that executable routine 1334. Such limitations may be derived based on comments within the programming code of the executable routine 1334 and/or other information that describes what functionality the executable routine 1334 is expected to have, including what memory and/or I/O accesses are expected to be made when the executable routine 1334 is executed. Then, when the executable routine 1334 is executed within such a container 1336, the accesses that are attempted to be made by the executable routine 1334 may be monitored to identify any behavior that deviates from what is expected.

Where the possibility exists that different executable routines 1334 may be written in different programming languages, it may be that different subsets of containers 1336 are configured to support different programming languages. In such embodiments, it may be that each executable routine 1334 is analyzed to identify what programming language it is written in, and then what container 1336 is assigned to support the execution of that executable routine 1334 may be at least partially based on the identified programming language. Where the possibility exists that a single requested analysis may be based on the execution of multiple executable routines 1334 that may each be written in a different programming language, it may be that at least a subset of the containers 1336 are configured to support the performance of various data structure and/or data format conversion operations to enable a data object output by one executable routine 1334 written in one programming language to be accepted as an input to another executable routine 1334 written in another programming language.

As depicted, at least a subset of the containers 1336 may be instantiated within one or more VMs 1331 that may be instantiated within one or more node devices 1330. Thus, in some embodiments, it may be that the processing, storage and/or other resources of at least one node device 1330 may be partially allocated through the instantiation of one or more VMs 1331, and then in turn, may be further allocated within at least one VM 1331 through the instantiation of one or more containers 1336.

In some embodiments, it may be that such a nested allocation of resources may be carried out to effect an allocation of resources based on two differing criteria. By way of example, it may be that the instantiation of VMs 1331 is used to allocate the resources of a node device 1330 to multiple users or groups of users in accordance with any of a variety of service agreements by which amounts of processing, storage and/or other resources are paid for each such user or group of users. Then, within each VM 1331 or set of VMs 1331 that is allocated to a particular user or group of users, containers 1336 may be allocated to distribute the resources allocated to each VM 1331 among various analyses that are requested to be performed by that particular user or group of users.

As depicted, where the processing system 1300 includes more than one node device 1330, the processing system 1300 may also include at least one control device 1350 within which one or more control routines 1354 may be executed to control various aspects of the use of the node device(s) 1330 to perform requested analyses. By way of example, it may be that at least one control routine 1354 implements logic to control the allocation of the processing, storage and/or other resources of each node device 1300 to each VM 1331 and/or container 1336 that is instantiated therein. Thus, it may be the control device(s) 1350 that effects a nested allocation of resources, such as the aforedescribed example allocation of resources based on two differing criteria.

As also depicted, the processing system 1300 may also include one or more distinct requesting devices 1370 from which requests to perform analyses may be received by the control device(s) 1350. Thus, and by way of example, it may be that at least one control routine 1354 implements logic to monitor for the receipt of requests from authorized users and/or groups of users for various analyses to be performed using the processing, storage and/or other resources of the node device(s) 1330 of the processing system 1300. The control device(s) 1350 may receive indications of the availability of resources, the status of the performances of analyses that are already underway, and/or still other status information from the node device(s) 1330 in response to polling, at a recurring interval of time, and/or in response to the occurrence of various preselected events. More specifically, the control device(s) 1350 may receive indications of status for each container 1336, each VM 1331 and/or each node device 1330. At least one control routine 1354 may implement logic that may use such information to select container(s) 1336, VM(s) 1331 and/or node device(s) 1330 that are to be used in the execution of the executable routine(s) 1334 associated with each requested analysis.

As further depicted, in some embodiments, the one or more control routines 1354 may be executed within one or more containers 1356 and/or within one or more VMs 1351 that may be instantiated within the one or more control devices 1350. It may be that multiple instances of one or more varieties of control routine 1354 may be executed within separate containers 1356, within separate VMs 1351 and/or within separate control devices 1350 to better enable parallelized control over parallel performances of requested analyses, to provide improved redundancy against failures for such control functions, and/or to separate differing ones of the control routines 1354 that perform different functions. By way of example, it may be that multiple instances of a first variety of control routine 1354 that communicate with the requesting device(s) 1370 are executed in a first set of containers 1356 instantiated within a first VM 1351, while multiple instances of a second variety of control routine 1354 that control the allocation of resources of the node device(s) 1330 are executed in a second set of containers 1356 instantiated within a second VM 1351. It may be that the control of the allocation of resources for performing requested analyses may include deriving an order of performance of portions of each requested analysis based on such factors as data dependencies there among, as well as allocating the use of containers 1336 in a manner that effectuates such a derived order of performance.

Where multiple instances of control routine 1354 are used to control the allocation of resources for performing requested analyses, such as the assignment of individual ones of the containers 1336 to be used in executing executable routines 1334 of each of multiple requested analyses, it may be that each requested analysis is assigned to be controlled by just one of the instances of control routine 1354. This may be done as part of treating each requested analysis as one or more “ACID transactions” that each have the four properties of atomicity, consistency, isolation and durability such that a single instance of control routine 1354 is given full control over the entirety of each such transaction to better ensure that either all of each such transaction is either entirely performed or is entirely not performed. As will be familiar to those skilled in the art, allowing partial performances to occur may cause cache incoherencies and/or data corruption issues.

As additionally depicted, the control device(s) 1350 may communicate with the requesting device(s) 1370 and with the node device(s) 1330 through portions of a network 1399 extending there among. Again, such a network as the depicted network 1399 may be based on any of a variety of wired and/or wireless technologies, and may employ any of a variety of protocols by which commands, status, data and/or still other varieties of information may be exchanged. It may be that one or more instances of a control routine 1354 cause the instantiation and maintenance of a web portal or other variety of portal that is based on any of a variety of communication protocols, etc. (e.g., a restful API). Through such a portal, requests for the performance of various analyses may be received from requesting device(s) 1370, and/or the results of such requested analyses may be provided thereto. Alternatively, or additionally, it may be that one or more instances of a control routine 1354 cause the instantiation of and maintenance of a message passing interface and/or message queues. Through such an interface and/or queues, individual containers 1336 may each be assigned to execute at least one executable routine 1334 associated with a requested analysis to cause the performance of at least a portion of that analysis.

Although not specifically depicted, it may be that at least one control routine 1354 may include logic to implement a form of management of the containers 1336 based on the Kubernetes container management platform promulgated by Could Native Computing Foundation of San Francisco, CA, USA. In such embodiments, containers 1336 in which executable routines 1334 of requested analyses may be instantiated within “pods” (not specifically shown) in which other containers may also be instantiated for the execution of other supporting routines. Such supporting routines may cooperate with control routine(s) 1354 to implement a communications protocol with the control device(s) 1350 via the network 1399 (e.g., a message passing interface, one or more message queues, etc.). Alternatively, or additionally, such supporting routines may serve to provide access to one or more storage repositories (not specifically shown) in which at least data objects may be stored for use in performing the requested analyses.

### Associated Processes

The systems, methods, and embodiments described herein may be used in a variety of technology areas in synthetic data generation, training of artificial intelligence models, risk assessments, and data processing technologies. The disclosed techniques may utilize a structured process that includes generating partially completed data records, forming an augmented data structure, fitting and selecting a champion state space model, and executing a simulation smoother to generate synthetic component trajectories that are subsequently used to compute synthetic response data values. This approach may differ from conventional data generation techniques by leveraging state space modeling to capture both observed and latent temporal behaviors, thereby enabling more realistic and internally consistent synthetic datasets. Additionally, the ability to integrate configurable synthetic data generation parameters, support multiple simulation runs, and produce synthetic data across arbitrary target time spans may provide enhanced control, scalability, and adaptability. As a result, high-quality synthetic data may be generated that maintains statistical fidelity to underlying processes while supporting privacy preservation, data augmentation, and advanced analytical use cases. Several instance such as weekly sales at a store, visibility at different depths in a lake, monthly number of travelers using a given airport, and bacterial growth projections, may benefit from such advancements.

A technical advantage as described in more detail herein may relate to improved privacy preservation and data anonymization. For example, the systems and methods described herein may enable generation of synthetic longitudinal data that retains statistical and temporal characteristics of underlying real-world data without directly exposing sensitive or personally identifiable information. By modeling relationships between variables using a state space framework and generating synthetic response data values based on simulated component trajectories, the disclosed techniques may reduce a need to share or access original datasets. As a result, data consumers may perform analysis, testing, or model development using synthetic datasets that approximate real-world behavior while mitigating risks associated with disclosure of confidential or regulated data.

Another technical advantage as described herein may relate to addressing data scarcity in domains where available data may be limited or imbalanced. For example, certain applications, such as fraud detection or rare event prediction, may involve datasets in which particular classes or conditions are underrepresented. The disclosed synthetic data generation techniques may enable creation of additional data records that reflect temporal patterns and relationships observed in existing longitudinal data, thereby augmenting limited datasets. This may improve the ability of downstream computational models to learn patterns associated with underrepresented conditions, which may in turn enhance performance, robustness, or generalization of such models.

In some embodiments, the present disclosure may provide technical advantages in testing and benchmarking computational systems. For example, the ability to generate synthetic longitudinal datasets with controlled characteristics may allow developers to evaluate algorithms under a variety of scenarios, including edge cases or stress conditions that may not be readily available in real-world data. The use of parameterized synthetic data generation, including configurable predictor variables and target time spans, may enable systematic variation of input conditions. This may facilitate more comprehensive validation of software systems, including machine learning models and data processing pipelines, by providing repeatable and tunable datasets for testing purposes.

In some embodiments, another technical advantage may relate to reducing the cost and resource burden associated with collecting high-quality data. For example, acquiring real-world datasets, such as medical imaging data or sensor data for autonomous systems, may require substantial time, financial resources, and specialized infrastructure. The disclosed techniques may enable generation of synthetic datasets that approximate such data using existing longitudinal data and modeled relationships, thereby reducing reliance on costly data collection processes. This may allow organizations to accelerate development and experimentation cycles while conserving resources.

In some embodiments, another technical advantage may include improvements within data processing fields achieved through structured generation and manipulation of longitudinal data using a state space modeling framework. For example, processing circuitry may be configured to construct an augmented data structure that integrates historical data records with partially completed data records aligned to a target time span, thereby enabling unified model fitting and simulation across both observed and target domains. By fitting a plurality of candidate state space models to the augmented data structure, selecting a model based on a model efficacy criterion, and executing a simulation smoother to generate synthetic component trajectories, the system may produce synthetic response data values that preserve temporal dependencies and latent relationships present in the underlying data. This configuration may improve operation of computing systems by enabling more efficient reuse of fitted models across multiple simulation runs, reducing redundant computation, and facilitating scalable generation of high-dimensional time series data with controlled characteristics.

In some embodiments, another technical advantage may relate to enabling simulation of unseen or rare events. For example, real-world datasets may lack sufficient examples of infrequent but critical scenarios, such as system failures, anomalies, or extreme conditions. The use of a state space model and simulation smoother may allow generation of synthetic component trajectories that explore a range of possible system behaviors, including variations that may not be present in historical data. By combining these trajectories with configurable parameters, the disclosed techniques may produce synthetic data that represents rare or hypothetical scenarios, thereby supporting analysis, testing, and model training in contexts where such data would otherwise be unavailable.

Another technical advantage may relate to improved efficiency and scalability of synthetic data generation. For example, by generating an augmented data structure and fitting a champion state space model once, the system may reuse the fitted model to generate multiple synthetic datasets via the simulation smoother. This may reduce redundant computation compared to approaches that independently simulate or recompute models for each dataset, thereby improving processing efficiency and resource utilization of the computing system.

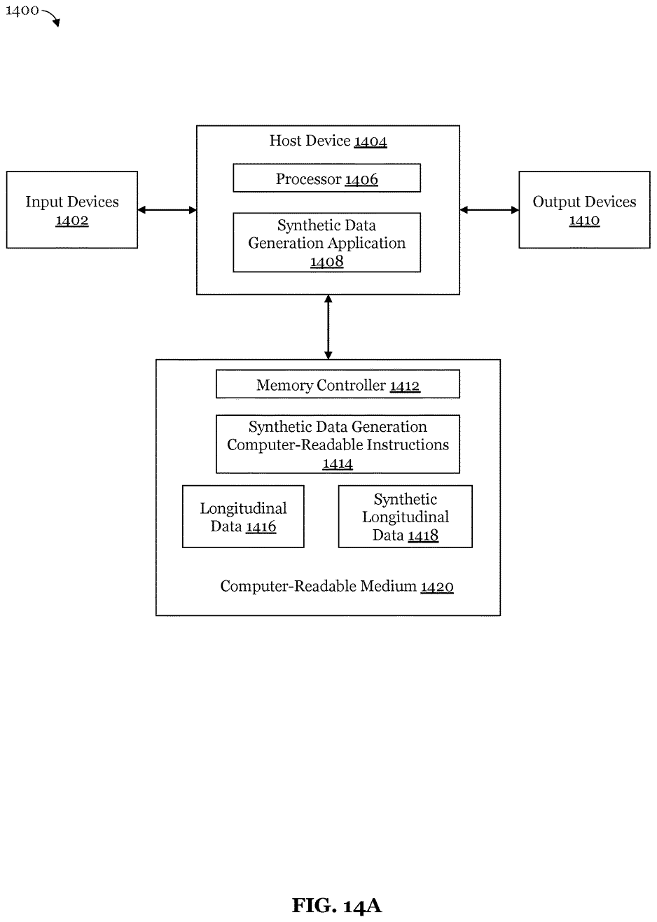

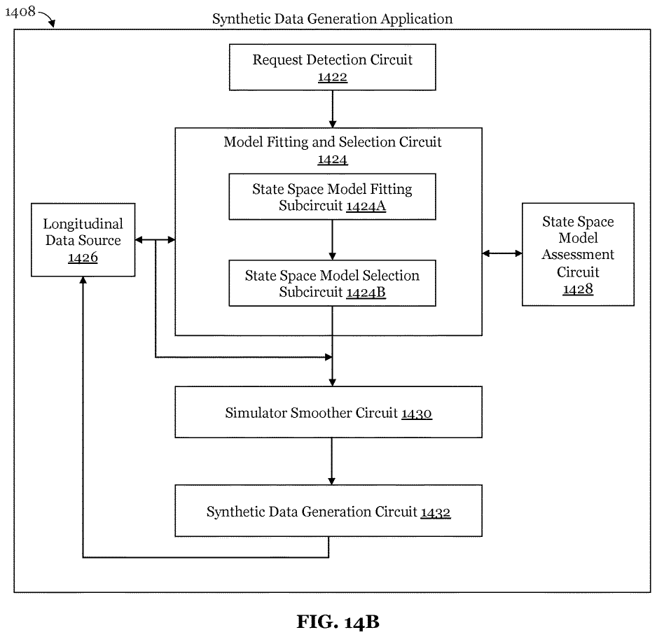

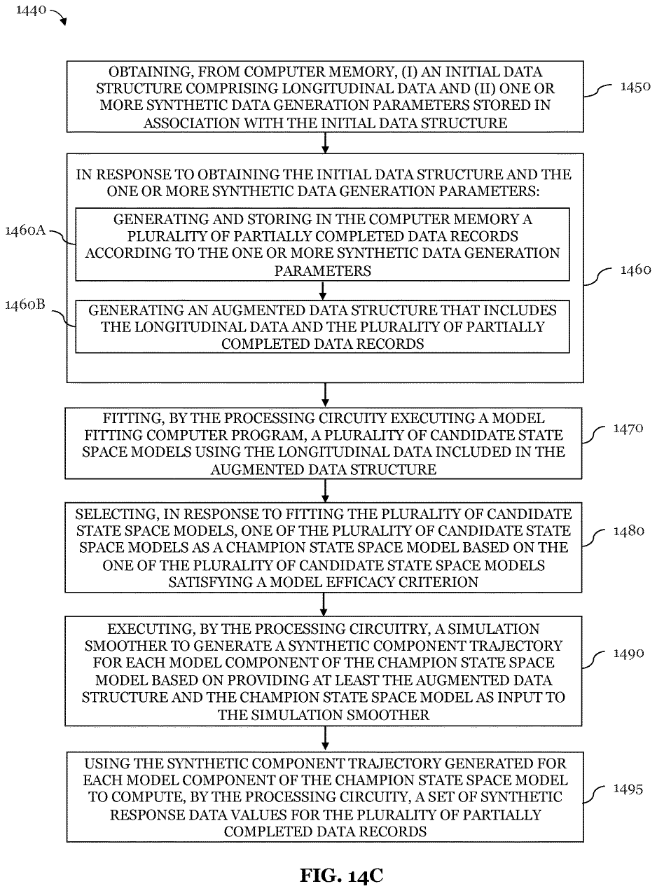

FIG. 14C illustrates one embodiment of a method 1400 for a state space model-based synthetic data generation for longitudinal and time series data. It shall be appreciated that other embodiments contemplated within the scope of the present disclosure may involve more operations, fewer operations, different operations, or a different order of operations than as shown in FIG. 14C.

### Exemplary Synthetic Data Generation System

Turning now to FIG. 14A, which illustrates a block diagram of an example synthetic data generation system 1440 in accordance with some embodiments of the present disclosure. The synthetic data generation system 1400 may be part of, or otherwise associated with, the computing environment 114. The synthetic data generation system 1400 includes a host device 1404 associated with a computer-readable medium 1420. The host device 1404 may be configured to receive input from one or more input devices 1402 and provide output to one or more output devices 1410. The host device 1404 may be configured to communicate with the computer-readable medium 1420, the input devices 1402, and the output devices 1410 via appropriate communication interfaces, buses, or channels respectively. The synthetic data generation system 1400 may be implemented in a variety of computing devices such as computers (e.g., desktop, laptop, etc.), servers, tablets, personal digital assistants, mobile devices, wearable computing devices such as smart watches, other handheld or portable devices, or any other computing units suitable for performing operations described herein using the host device 1404.

Further, some or all of the features described in the present disclosure may be implemented on a client device, an on-premises server device, a cloud/distributed computing environment, or a combination thereof. Additionally, unless otherwise indicated, functions described herein as being performed by a computing device (e.g., the synthetic data generation system 1400) may be implemented by multiple computing devices in a distributed environment, and vice versa.

In some embodiments, one or more operations of the synthetic data generation application may be performed using a remote computing service accessible via an application programming interface (API). For example, the host device may be configured to generate an API request that includes one or more inputs associated with the synthetic data generation process and transmit the API request over a network to an API endpoint of a remote compute service.

The input devices 1402 may include any of a variety of input technologies such as a keyboard, stylus, touch screen, mouse, track ball, keypad, microphone, voice recognition, motion recognition, remote controllers, input ports, one or more buttons, dials, joysticks, point of sale/service devices, card readers, chip readers, and any other input peripheral that is associated with the host device 1404 and that allows an external source, such as a user, to enter information (e.g., data) into the host device and send instructions to the host device 1404. Similarly, the output devices 1410 may include a variety of output technologies such as external memories, printers, speakers, displays, microphones, light emitting diodes, headphones, plotters, speech generating devices, video devices, and any other output peripherals that are configured to receive information (e.g., data) from the host device 1404. The “data” that is either input into the host device 1404 and/or output from the host device may include any of a variety of textual data, numerical data, alphanumerical data, graphical data, video data, sound data, position data, combinations thereof, or other types of analog and/or digital data that is suitable for processing using the synthetic data generation system 1400.

The host device 1404 may include a processor 1406 that may be configured to execute instructions for running one or more applications associated with the host device 1404. In some embodiments, the instructions and data needed to run the one or more applications may be stored within the computer-readable medium 1420. The host device 1404 may also be configured to store the results of running the one or more applications within the computer-readable medium 1420. One such application on the host device 1404 may be a synthetic data generation application 1408. The synthetic data generation application 1408 may be used to automatically generate simulated data.

The synthetic data generation application 1408 may be executed by the processor 1406. The instructions to execute the synthetic data generation application 1408 may be stored within the computer-readable medium 1420. To facilitate communication between the host device 1404 and the computer-readable medium 1420, the computer-readable medium may include or be associated with a memory controller 1412. Although the memory controller 1412 is shown as being part of the computer-readable medium 1420, in some embodiments, the memory controller may instead be part of the host device 1404 or another element of the synthetic data generation system 1400 and operatively associated with the computer-readable medium 1420. The memory controller 1412 may be configured as a logical block or circuitry that receives instructions from the host device 1404 and performs operations in accordance with those instructions. For example, to execute the synthetic data generation application 1408, the host device 1404 may send a request to the memory controller 1412. The memory controller 1412 may read the instructions associated with the synthetic data generation application 1408. For example, the memory controller 1412 may read synthetic data generation computer-readable instructions 1414 stored within the computer-readable medium 1420 and send those instructions back to the host device 1404. In some embodiments, those instructions may be temporarily stored within a memory on the host device 1404. The processor 1406 may then execute those instructions by performing one or more operations called for by those instructions.

The computer-readable medium 1420 may include one or more memory circuits. The memory circuits may be any of a variety of memory types, including a variety of volatile memories, non-volatile memories, or a combination thereof. For example, in some embodiments, one or more of the memory circuits or portions thereof may include NAND flash memory cores. In other embodiments, one or more of the memory circuits or portions thereof may include NOR flash memory cores, Static Random Access Memory (SRAM) cores, Dynamic Random Access Memory (DRAM) cores, Magnetoresistive Random Access Memory (MRAM) cores, Phase Change Memory (PCM) cores, Resistive Random Access Memory (ReRAM) cores, 3D XPoint memory cores, ferroelectric random-access memory (FeRAM) cores, and other types of memory cores that are suitable for use within the computer-readable medium 1420. In some embodiments, one or more of the memory circuits or portions thereof may be configured as other types of storage class memory (“SCM”). Generally speaking, the memory circuits may include any of a variety of Random Access Memory (RAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

The computer-readable medium 1420 may also be configured to store longitudinal data 1416 and synthetic longitudinal data 1418. The longitudinal data 1416 may include, and/or be used to generate, observation vectors for use by the synthetic data generation application 1408. In other words, the longitudinal data 1416 may be used to facilitate the generation of the synthetic longitudinal data 1418 by the synthetic data generation application 1408.

In some embodiments, the circuits, subcircuits, and processing circuitry described herein may be implemented using one or more of hardware, software, firmware, or combinations thereof. For example, certain circuits may be realized as dedicated hardware components, such as application-specific integrated circuits (ASICs), field-programmable gate arrays (FPGAs), or other programmable logic devices. In other embodiments, one or more circuits or subcircuits may be implemented as software modules, algorithms, or executable instructions stored in memory and executed by one or more processors. Additionally, the described functionality may be realized within virtualized computing environments, including cloud-based or distributed computing systems, or through simulation environments configured to emulate hardware behavior. In some implementations, different portions of the described circuitry may be distributed across multiple physical or virtual devices and may communicate via one or more networks.

It is to be understood that only some components of the synthetic data generation system 1400 are shown and described in FIG. 14A. However, the synthetic data generation system 1400 may include other components such as various batteries and power sources, networking interfaces, routers, switches, external memory systems, controllers, etc. Generally speaking, the synthetic data generation system 1400 may include any of a variety of hardware, software, and/or firmware components that are needed or considered desirable in performing the functions described herein. Similarly, the host device 1404, the input devices 1402, the output devices 1410, and the computer-readable medium 1420, including the memory controller 1412, may include hardware, software, and/or firmware components that are considered necessary or desirable in performing the functions described herein.

### Exemplarily Synthetic Data Generation Application

Turning now to FIG. 14B, which illustrates a block diagram of an example architecture of the synthetic data generation application 1408, in accordance with some embodiments of the present disclosure. As shown in FIG. 14B, the synthetic data generation application 1408 may comprise a plurality of functional circuits that may cooperate to perform operations associated with generating synthetic longitudinal data. In some embodiments, the synthetic data generation application 1408 shown in FIG. 14B may correspond to the synthetic data generation application 1408 executed by the host device 1404 described above with respect to FIG. 14A.

In some embodiments, the synthetic data generation application 1408 may include a request detection circuit 1422 that may be configured to detect or otherwise receive a synthetic data generation request. The request may include, or may be associated with, an initial data structure that comprises longitudinal data and one or more synthetic data generation parameters stored in association with the initial data structure. The request detection circuit 1422 may be configured to initiate execution of one or more downstream circuits of the synthetic data generation application 1408 in response to detecting the synthetic data generation request.

The synthetic data generation application 1408 may further include a model fitting and selection circuit 1424 that may be configured to generate and evaluate one or more candidate models based on the longitudinal data. In some embodiments, the model fitting and selection circuit 1424 may include a state space model fitting subcircuit 1424A and a state space model selection subcircuit 1424B. The state space model fitting subcircuit 1424A may be configured to fit a plurality of candidate state space models using the longitudinal data, which may include historical data records spanning a historical time span. The state space model selection subcircuit 1424B may be configured to select, from among the plurality of candidate state space models, a champion state space model based on a model efficacy criterion, such as a likelihood-based metric, an information criterion, or another performance measure.

In some embodiments, the synthetic data generation application 1408 may further include a longitudinal data source 1426 that may be configured to provide access to the longitudinal data used for model fitting and subsequent processing. The longitudinal data source 1426 may include, or may be associated with, one or more data repositories that store historical data records, and may be configured to provide such data to the model fitting and selection circuit 1424 and other circuits of the synthetic data generation application 1408.

The synthetic data generation application 1408 may also include a state space model assessment circuit 1428 that may be configured to evaluate the fitted candidate state space models and/or the selected champion state space model. The state space model assessment circuit 1428 may be configured to compute one or more diagnostic metrics, perform validation procedures, or otherwise assess the suitability of the candidate models and the champion state space model for use in generating synthetic data. In some embodiments, the assessment performed by the state space model assessment circuit 1428 may inform or refine the model selection process performed by the state space model selection subcircuit 1424B.

Further, the synthetic data generation application 1408 may include a simulator smoother circuit 1430 that may be configured to execute a simulation smoother procedure. The simulator smoother circuit 1430 may generate a synthetic component trajectory for each model component of the champion state space model based on the augmented data structure and the champion state space model. In some embodiments, the simulation smoother may draw samples from a joint posterior distribution of latent model components conditioned on the observed longitudinal data, thereby enabling the generation of synthetic trajectories that preserve temporal characteristics of the longitudinal data.

In some embodiments, the synthetic data generation application 1408 may further include a synthetic data generation circuit 1432 that may be configured to compute synthetic response data values for a plurality of partially completed data records. The synthetic data generation circuit 1432 may utilize the synthetic component trajectories generated by the simulator smoother circuit 1430 to compute respective synthetic response data values for each partially completed data record, for example, by combining regression components, latent model component values, and error components in accordance with a state space model equation. The synthetic data generation circuit 1432 may further be configured to populate one or more unpopulated fields within the partially completed data records with the computed synthetic response data values, thereby generating synthetic longitudinal data.

It is to be understood that the arrangement of circuits shown in FIG. 14B is provided for illustrative purposes, and that, in some embodiments, the functionality described with respect to one or more circuits may be combined, separated, or otherwise distributed across additional or alternative components. Additionally, each of the circuits described herein may be implemented using hardware, software, firmware, or any combination thereof, and may be executed by one or more processing devices in a centralized or distributed computing environment.

Obtaining an Initial Data Structure Comprising Longitudinal Data and One or More Synthetic Data Generation Parameters Stored in Association with the Initial Data Structure

In one or more embodiments, method 1440 may include process 1450, which describes the request detection circuit obtaining, from computer memory, (I) an initial data structure comprising longitudinal data and (II) one or more synthetic data generation parameters stored in association with the initial data structure. In some embodiments, the initial data structure may be stored within a computer-readable medium, such as the computer-readable medium 1420 described above with respect to FIG. 14A and may be accessible by processing circuitry executing a synthetic data generation application.

In some embodiments, the term “longitudinal data,” may refer to data that includes a plurality of observations of one or more variables collected over a sequence of time periods or other ordered indices. The longitudinal data may include a plurality of data records, each data record corresponding to a distinct time period within a defined time span, such as a historical time span. Each data record may include a temporal attribute value that identifies the corresponding time period, along with one or more data values associated with that time period.

In some embodiments, the longitudinal data may include values associated with one or more predictor variables and a response variable. The predictor variables may represent explanatory or independent variables that may influence or be associated with the response variable, while the response variable may represent a dependent variable of interest whose behavior over time may be modeled or analyzed. Each data record of the longitudinal data may therefore include a set of predictor variable data values observed at a given time period and a corresponding response variable data value observed at that time period.

In some embodiments, the observations included in the longitudinal data may be collected at regular intervals, such as daily, weekly, or monthly intervals, in which case the longitudinal data may be referred to as time series data. In other embodiments, the observations may be collected at irregular intervals or based on another indexing variable, such as spatial depth or experimental sequence, while still maintaining an ordered structure. The longitudinal data may therefore encompass both evenly spaced time series data and more generally ordered observational data.

In some embodiments, the longitudinal data may include one or more distinct panels of data, where each panel corresponds to a respective entity, subject, or experimental replicate. Each panel may include a sequence of data records spanning a respective time span, and the plurality of panels may collectively represent multiple related sequences of longitudinal observations. The longitudinal data may be stored in a structured format, such as a tabular data structure, that enables efficient retrieval and processing by one or more computing systems. It is to be understood that the longitudinal data described herein may include any type of numerical, categorical, or otherwise encoded data that is suitable for representing observations across an ordered sequence, and may be used as input for modeling, simulation, and synthetic data generation processes as described throughout the present disclosure. In some embodiments, each panel of longitudinal data may correspond to a distinct replicate, experiment, subject, or entity, and may include a respective sequence of observations spanning a corresponding time span.

In some embodiments, when the longitudinal data includes a plurality of distinct panels corresponding to respective experiments, subjects, or replicates, the state space model may include one or more latent model components that represent shared behavior across the plurality of panels. For example, a first latent model component may represent a shared longitudinal behavior common to all panels of data. In addition, the state space model may include one or more latent model components that represent panel-specific deviations. For example, a second latent model component may model a distinct deviation curve for each panel, thereby capturing variations specific to individual experiments or replicates.

The initial data structure may include a plurality of historical data records that collectively correspond to a historical time span. Each historical data record may include a temporal attribute value that specifies a distinct time period within the historical time span, one or more predictor variable data values observed for the distinct time period, and a response variable data value associated with the predictor variables. In some embodiments, the longitudinal data included in the initial data structure may represent measurements of one or more variables collected over time, and may include additional contextual or explanatory variables that may influence a response variable of interest.

In some embodiments, the one or more synthetic data generation parameters may be stored in association with the initial data structure, for example, within the same data repository, as metadata linked to the initial data structure, or within a separate data structure that is retrievable using a reference associated with the initial data structure. The synthetic data generation parameters may specify one or more conditions or guidelines associated with generating synthetic longitudinal data. For example, the synthetic data generation parameters may include a target time span for which synthetic data is to be generated, a predetermined time interval for generating synthetic data records, one or more values or configurations for predictor variables, a simulation count parameter, or other parameters that may influence the generation of synthetic data.

In some embodiments, the one or more synthetic data generation parameters may correspond to, or be included within, a synthetic data generation request that specifies a request to generate synthetic longitudinal data. For example, the synthetic data generation request may explicitly indicate a target time span and a predetermined time interval at which synthetic data records are to be generated. In this manner, the synthetic data generation request may define both a temporal scope and a temporal resolution for the synthetic longitudinal data to be generated by the synthetic data generation application.

In some embodiments, the term “synthetic data generation parameters,” may refer to one or more configurable values, settings, or inputs that may control, influence, or otherwise define aspects of a synthetic data generation process. The synthetic data generation parameters may be stored in association with an initial data structure comprising longitudinal data and may be retrieved from computer memory together with, or in response to accessing, the initial data structure.

In some embodiments, the synthetic data generation parameters may specify one or more characteristics of synthetic data to be generated. For example, the synthetic data generation parameters may include a target time span that is different from a historical time span associated with the longitudinal data, and may further specify a temporal granularity or predetermined time interval at which synthetic data records are to be generated. In this manner, the synthetic data generation parameters may define a temporal framework for generating a plurality of partially completed data records that collectively span the target time span.

In some embodiments, the predetermined time interval specified by the synthetic data generation parameters may control generation of each partially completed data record, such that a respective partially completed data record is generated for each interval within the target time span defined by the synthetic data generation request.

In some embodiments, the synthetic data generation parameters may include one or more values, guidelines, or configurations associated with predictor variables included in the longitudinal data. For example, the synthetic data generation parameters may specify target values, ranges, distributions, or scenarios for one or more predictor variables, which may be incorporated into the plurality of partially completed data records. In this way, the synthetic data generation parameters may enable controlled variation of predictor variable values in the generated synthetic data while maintaining consistency with relationships observed in the longitudinal data.

In some embodiments, the synthetic data generation parameters may include a target value for one or more predictor variables. The target value may specify a particular value to be assigned to a predictor variable for one or more partially completed data records generated for the target time span.

In some embodiments, the synthetic data generation parameters may further include one or more simulation-related parameters that may influence the execution of a simulation procedure, such as a simulation smoother. For example, the synthetic data generation parameters may include a simulation count parameter that specifies a number of simulations to be performed, one or more seed values associated with a pseudo-random number generator, or other parameters that may affect stochastic aspects of the synthetic data generation process.

In some embodiments, the synthetic data generation parameters may include a simulation count parameter that specifies a total number of simulations to be performed by the simulation smoother. The simulation count parameter may be provided by a user or determined programmatically and may control the number of distinct simulation runs executed during the synthetic data generation process. In some embodiments, the simulation smoother may execute a plurality of distinct simulations equal in number to the total number of simulations specified by the simulation count parameter. Each simulation may correspond to a separate execution of the simulation smoother and may produce a distinct set of synthetic component trajectories. In some embodiments, each simulation of the plurality of distinct simulations may include initializing a pseudo-random number generator using a respective seed value. The respective seed value may be associated with the simulation and may be used to control stochastic sampling performed during execution of the simulation smoother.

In some embodiments, for each simulation, the simulation smoother may generate a corresponding synthetic component trajectory for each model component of the champion state space model. The synthetic data generation circuit may then compute, for each simulation, a respective set of synthetic response data values for the plurality of partially completed data records using the synthetic component trajectories generated during that simulation.

In some embodiments, each execution of the simulation smoother may be associated with one or more seed values used to initialize a pseudo-random number generator. In some embodiments, a respective seed value may be associated with each partially completed data record or each generated synthetic response data value. The synthetic data generation application may store the respective seed value in association with the corresponding synthetic response data value.

In some embodiments, the synthetic data generation parameters may also include one or more model-related parameters, configuration flags, or criteria that may influence model fitting, model selection, or model evaluation procedures. For example, the synthetic data generation parameters may include information indicative of a model efficacy criterion, allowable model structures, or constraints on model components. It is to be understood that the synthetic data generation parameters described herein may include types of parameter, metadata, or configuration information that may be used to guide or control one or more stages of the synthetic data generation process. Such parameters may be provided by a user, generated programmatically, or derived from the longitudinal data, and may be stored in a structured format that enables retrieval and use by processing circuitry executing the synthetic data generation application.

The operation of obtaining the initial data structure and the one or more synthetic data generation parameters may include retrieving the initial data structure and the associated parameters from the computer memory in response to a synthetic data generation request. In some embodiments, the obtaining operation may be performed by processing circuitry that reads the initial data structure and the associated parameters via a memory controller or similar interface, and may temporarily store the retrieved data within a working memory for further processing.

### In Response to Obtaining the Initial Data Structure and the One or More Synthetic Data Generation Parameters

In one or more embodiments, method 1440 may include process 1460 wherein in response to obtaining the initial data structure and the one or more synthetic data generation parameters, the synthetic data generation application: generates and stores in the computer memory a plurality of partially completed data records according to the one or more synthetic data generation parameters 1460A and generates an augmented data structure that includes the longitudinal data and the plurality of partially completed data records 1460B. The generation of the plurality of partially completed data records may be performed by processing circuitry executing one or more instructions of the synthetic data generation application, and may be based on parameters that define a target time span, a temporal granularity, and/or one or more constraints associated with the synthetic data to be generated.

In some embodiments, each partially completed data record of the plurality of partially completed data records may correspond to a respective time period within the target time span specified by the one or more synthetic data generation parameters. The plurality of partially completed data records may collectively span the target time span at a predetermined time interval, such as daily, weekly, or another specified interval. Each partially completed data record may include a temporal identifier corresponding to its associated time period, and may further include one or more predictor variable data values that may be determined based on the synthetic data generation parameters, predefined values, or derived values.

In some embodiments, each partially completed data record may include an unpopulated response data field that is intended to be populated in a subsequent stage of the method. As such, the partially completed data records may represent a structural framework for synthetic longitudinal data, where certain fields (e.g., predictor variables and temporal attributes) may be specified, while other fields (e.g., response variable values) may remain unassigned pending further computation.

The generation of the plurality of partially completed data records may further include allocating storage for each record within the computer memory and writing the generated records to the memory in a structured format. In some embodiments, the plurality of partially completed data records may be stored as new rows within a tabular data structure, such as a matrix or data frame, that is configured to be combined with the initial data structure. The generated and stored plurality of partially completed data records may subsequently be used to form an augmented data structure and to facilitate downstream model fitting and synthetic data generation operations.

In some embodiments, the term “plurality of partially completed data records,” may refer to a set of data records that are generated based on one or more synthetic data generation parameters and that are structured to correspond to a target time span, but that may initially lack one or more data values to be computed in subsequent processing stages. The plurality of partially completed data records may be generated in response to obtaining an initial data structure comprising longitudinal data and the associated synthetic data generation parameters, and may be stored in computer memory for further processing.

In some embodiments, each partially completed data record of the plurality of partially completed data records may correspond to a distinct time period within the target time span specified by the synthetic data generation parameters. The plurality of partially completed data records may collectively span the target time span at a predetermined time interval, such that each partially completed data record is associated with a respective temporal identifier that specifies its corresponding time period. The temporal identifiers may be generated based on the synthetic data generation parameters and may align with a temporal schema used in the longitudinal data.

In some embodiments, each partially completed data record may include one or more fields corresponding to predictor variables and a response variable, consistent with a schema of the initial data structure. The predictor variable fields within each partially completed data record may be populated with values specified by, derived from, or otherwise consistent with the synthetic data generation parameters. For example, the predictor variable values may be assigned fixed values, sampled values, or values determined according to predefined scenarios or constraints.

In some embodiments, each partially completed data record may include an unpopulated or placeholder value in a response data field. The response data field may be intended to store a synthetic response data value that is to be computed in a subsequent stage of the synthetic data generation process. As such, the plurality of partially completed data records may represent an intermediate data structure in which temporal and predictor variable information is defined, while response variable values remain to be determined.

In some embodiments, the plurality of partially completed data records may be organized in a tabular format, such as a set of rows in a data table, where each row corresponds to a distinct partially completed data record. The plurality of partially completed data records may be configured to be combined with the longitudinal data to form an augmented data structure, thereby enabling joint processing of historical data and target-period data during model fitting and synthetic data generation operations.

In some embodiments, the method 1440 may further include, in response to obtaining the initial data structure and the one or more synthetic data generation parameters, the synthetic data generation application generates an augmented data structure that includes the longitudinal data and the plurality of partially completed data records, as indicated at 1460B. The generation of the augmented data structure may be performed by processing circuitry executing one or more instructions of the synthetic data generation application, and may involve combining the historical data contained in the initial data structure with the plurality of partially completed data records generated.

In some embodiments, the term “augmented data structure,” may refer to a composite data structure that includes both the longitudinal data obtained from an initial data structure and a plurality of partially completed data records generated based on one or more synthetic data generation parameters. The augmented data structure may be formed by combining or otherwise integrating the longitudinal data and the plurality of partially completed data records into a unified data representation that is stored in computer memory.

In some embodiments, the augmented data structure may preserve a schema of the initial data structure, such that both the longitudinal data and the plurality of partially completed data records conform to a common set of fields. These fields may include, for example, a temporal attribute, one or more predictor variables, and a response variable. The longitudinal data included in the augmented data structure may include fully populated data records corresponding to a historical time span, whereas the plurality of partially completed data records may include data records corresponding to a target time span that may be different from the historical time span

In some embodiments, the augmented data structure may be generated by appending a plurality of new rows corresponding to the plurality of partially completed data records to existing rows corresponding to the longitudinal data. Each new row may include a temporal identifier corresponding to a respective time period within the target time span, along with one or more predictor variable values and an unpopulated response data field. As a result, the augmented data structure may include a continuous or extended sequence of data records that span both the historical time span and the target time span.

In some embodiments, each new row corresponding to a respective partially completed data record may include all data fields associated with the respective partially completed data record, including the temporal identifier, one or more predictor variable values, and an unpopulated response data field. In some embodiments, the one or more predictor variable values included in each new row may include a target value specified by the synthetic data generation parameters for a corresponding predictor variable, such that the target value is explicitly stored within each new row associated with the partially completed data records.

In some embodiments, a total number of the plurality of new rows generated for inclusion in the augmented data structure may be based on a total number of the plurality of partially completed data records. For example, the synthetic data generation application may determine a number of partially completed data records generated for a target time span and may create a corresponding number of new rows, where each new row corresponds to a respective partially completed data record. In this manner, a one-to-one correspondence may be established between the plurality of partially completed data records and the plurality of new rows included in the augmented data structure.

In some embodiments, the augmented data structure may be configured to serve as input to one or more model fitting and simulation procedures. By including both the longitudinal data and the plurality of partially completed data records, the augmented data structure may enable a model fitting procedure to account for the structure, temporal alignment, and predictor variable configurations associated with the target time span. This may facilitate the generation of a model, such as a state space model, that is capable of producing synthetic data values corresponding to the plurality of partially completed data records.

In some embodiments, the augmented data structure may be stored in a tabular, matrix-based, or other structured format that supports efficient access and manipulation by processing circuitry. The augmented data structure may also include additional metadata, indexing information, or identifiers that distinguish between historical data records and partially completed data records, thereby enabling selective processing during subsequent stages of the synthetic data generation process.

In some embodiments, generating the augmented data structure may include creating a plurality of new rows corresponding to the plurality of partially completed data records and appending the plurality of new rows to the initial data structure. Each new row may correspond to a distinct partially completed data record and may include a temporal identifier that specifies a respective time period within a target time span. The augmented data structure may therefore include both historical data records associated with a historical time span and newly generated rows associated with the target time span, which may be different from the historical time span.

In some embodiments, the augmented data structure may preserve a schema of the initial data structure, such that each row of the augmented data structure includes fields corresponding to a plurality of predictor variables, a response variable, and a temporal attribute. For the plurality of partially completed data records included in the augmented data structure, one or more fields, such as the response variable field, may remain unpopulated or partially populated, while other fields, such as predictor variable values and temporal identifiers, may be specified in accordance with the synthetic data generation parameters.

The generation of the augmented data structure may further include storing the combined data structure in computer memory in a format suitable for subsequent processing. In some embodiments, the augmented data structure may be configured to serve as input to a model fitting procedure, such that both the historical data and the plurality of partially completed data records may be jointly considered during the fitting of one or more candidate state space models. The inclusion of the partially completed data records within the augmented data structure may enable the model fitting procedure to account for the structure and temporal scope of the target time span during subsequent operations of method 1440.

The augmented data structure may be formed by combining or otherwise integrating the longitudinal data and the plurality of partially completed data records into a unified data representation that is stored in computer memory. In some embodiments, the augmented data structure may preserve a schema of the initial data structure, such that both the longitudinal data and the plurality of partially completed data records conform to a common set of fields. These fields may include, for example, a temporal attribute, one or more predictor variables, and a response variable. The longitudinal data included in the augmented data structure may include fully populated data records corresponding to a historical time span, whereas the plurality of partially completed data records may include data records corresponding to a target time span that may be different from the historical time span.

In some embodiments, the augmented data structure may be generated by appending a plurality of new rows corresponding to the plurality of partially completed data records to existing rows corresponding to the longitudinal data. Each new row may include a temporal identifier corresponding to a respective time period within the target time span, along with one or more predictor variable values and an unpopulated response data field. As a result, the augmented data structure may include a continuous or extended sequence of data records that span both the historical time span and the target time span.

In some embodiments, the augmented data structure may be configured to serve as input to one or more model fitting and simulation procedures. By including both the longitudinal data and the plurality of partially completed data records, the augmented data structure may enable a model fitting procedure to account for the structure, temporal alignment, and predictor variable configurations associated with the target time span. This may facilitate the generation of a model, such as a state space model, that is capable of producing synthetic data values corresponding to the plurality of partially completed data records.

In some embodiments, the augmented data structure may be stored in a tabular, matrix-based, or other structured format that supports efficient access and manipulation by processing circuitry. The augmented data structure may also include additional metadata, indexing information, or identifiers that distinguish between historical data records and partially completed data records, thereby enabling selective processing during subsequent stages of the synthetic data generation process.

### Fitting, by the Processing Circuitry Executing a Model Fitting Computer Program, a Plurality of Candidate State Space Models Using the Longitudinal Data Included in the Augmented Data Structure

In one or more embodiments, method 1440 may include process 1470 illustrating fitting, by the processing circuitry executing a model fitting computer program, a plurality of candidate state space models using the longitudinal data included in the augmented data structure. The fitting of the plurality of candidate state space models may be performed in response to generating the augmented data structure, and may utilize the historical data records included therein to estimate parameters associated with each candidate model. The fitting operation may involve determining values for model parameters such that the candidate state space model adequately represents temporal relationships observed in the longitudinal data, including relationships between predictor variables, latent components, and a response variable.

In some embodiments, fitting may include applying one or more statistical estimation procedures to the longitudinal data included in the augmented data structure. For example, the processing circuitry may execute a model fitting computer program that performs likelihood-based estimation, such as maximum likelihood estimation or Bayesian estimation, to determine parameter values that optimize an objective function associated with each candidate state space model. The objective function may measure, for example, a degree of agreement between observed response variable data values and values predicted by the candidate state space model.

In some embodiments, fitting may further include executing one or more recursive filtering procedures, such as a Kalman filtering procedure or related algorithms, to estimate latent state variables associated with the candidate state space models over a sequence of time periods. These latent state variables may represent unobserved temporal effects, such as trend, seasonal variation, or other dynamic behaviors, and the fitting process may involve estimating both the parameters governing these latent components and the corresponding state trajectories over time. In some embodiments, fitting may also include performing one or more optimization or iterative refinement procedures, such as expectation-maximization techniques or gradient-based optimization methods, to iteratively update parameter estimates until a convergence criterion is satisfied. The convergence criterion may correspond to stabilization of parameter values, attainment of a threshold likelihood value, or satisfaction of another model efficacy condition

In some embodiments, fitting the plurality of candidate state space models may further include evaluating intermediate results, such as residual errors, likelihood scores, or information criteria, during the estimation process. These intermediate results may be used to refine parameter estimates and may also be provided as inputs to subsequent model selection operations.

In some embodiments, each candidate state space model of the plurality of candidate state space models may include a state space model equation that models a temporal behavior of a response variable as a function of one or more components. Such components may include a regression component representing contributions of predictor variable data values, one or more latent components representing time-dependent effects such as trend, seasonality, or other temporal patterns, and an error component representing stochastic variation. The parameters associated with these components may be estimated during the fitting process using the longitudinal data included in the augmented data structure.

In some embodiments, the plurality of candidate state space models may differ from one another with respect to model structure, included components, parameterization, or assumptions regarding temporal dynamics. For example, different candidate models may include different combinations of latent components, different functional forms for regression relationships, or different assumptions regarding noise distributions. The model fitting computer program may therefore fit multiple alternative model configurations to the longitudinal data to enable subsequent evaluation and selection of a suitable model.

In some embodiments, although the augmented data structure includes both historical data records and partially completed data records, the fitting of the plurality of candidate state space models may be performed using the longitudinal data corresponding to the historical time span, while the partially completed data records may provide structural context for subsequent processing stages. In this manner, the fitting operation may focus on observed data while maintaining alignment with the target time span represented within the augmented data structure.

### Selecting One of the Plurality of Candidate State Space Models as a Champion State Space Model

In one or more embodiments, method 1440 may include process 1480 which may include selecting, in response to fitting the plurality of candidate state space models, one of the plurality of candidate state space models as a champion state space model based on the one of the plurality of candidate state space models satisfying a model efficacy criterion. The selection of the champion state space model may be performed by processing circuitry executing one or more instructions of a model fitting and selection circuit, such as the model fitting and selection circuit 1424 described above with respect to FIG. 14B.

In some embodiments, the model efficacy criterion may include one or more quantitative or qualitative measures indicative of a performance of a candidate state space model with respect to the longitudinal data. For example, the model efficacy criterion may include a likelihood-based metric, an information criterion such as Akaike Information Criterion (AIC) or Bayesian Information Criterion (BIC), a prediction error metric, a goodness-of-fit measure, or another statistical measure that may be used to evaluate how well a candidate state space model represents temporal patterns in the longitudinal data. In some embodiments, the model efficacy criterion may include a combination of multiple evaluation metrics, and may optionally include threshold conditions or ranking procedures applied across the plurality of candidate state space models.

In some embodiments, selecting the champion state space model may include comparing the plurality of candidate state space models based on one or more values computed during or after the fitting process, such as likelihood scores, residual error values, or penalty-adjusted fit statistics. The processing circuitry may identify a candidate state space model that optimizes, minimizes, or otherwise satisfies the model efficacy criterion relative to the other candidate state space models. For example, the selected candidate state space model may correspond to a model that minimizes an information criterion value, maximizes a likelihood value, or achieves a desired balance between model complexity and predictive accuracy.

In some embodiments, the selection process may further include evaluating diagnostic information associated with each candidate state space model, such as residual distributions, stability of parameter estimates, or adherence to modeling assumptions. The model fitting and selection circuit may incorporate such diagnostic information into the model efficacy criterion or may use such information to validate or refine the selection of the champion state space model.

In some embodiments, the champion state space model selected in accordance with the model efficacy criterion may be used in subsequent stages of the method, including execution of a simulation smoother and generation of synthetic data. The selected champion state space model may therefore represent a model that is determined, based on the available longitudinal data and the applied evaluation criteria, to be suitable for generating synthetic component trajectories and corresponding synthetic response data values. The champion state space model may represent a model configuration whose estimated parameters and structural components provide an acceptable or improved representation of temporal behavior observed in the longitudinal data relative to other candidate models.

In some embodiments, each candidate state space model may define a respective state space model equation that models a response variable as a function of one or more components, such as a regression component associated with predictor variables, one or more latent components representing time-dependent effects, and an error component. The candidate models may differ with respect to the number, type, or configuration of these components, as well as parameterization choices and underlying assumptions regarding temporal dynamics. The champion state space model may therefore correspond to a particular combination of components and parameter estimates that is selected from among these alternatives.

In some embodiments, the selection of the champion state space model may include evaluating each of the plurality of candidate state space models using a model efficacy criterion that reflects how well each model fits or explains the longitudinal data. The evaluation may be based on one or more metrics computed during the fitting process, such as likelihood values, prediction errors, residual characteristics, or information criteria that balance model fit and model complexity. For example, the processing circuitry may compute, for each candidate model, a respective score indicative of model performance and may compare these scores across the plurality of candidate models to identify a model that satisfies the model efficacy criterion.

In some embodiments, the selection process may further include ranking the plurality of candidate state space models according to their respective evaluation metrics and selecting a highest-ranked model as the champion state space model. In other embodiments, the selection process may include determining whether one or more candidate models satisfy one or more threshold conditions associated with the model efficacy criterion, and selecting a model that satisfies such conditions. In still other embodiments, multiple criteria may be considered jointly, such that the selected champion state space model reflects a balance between predictive accuracy, robustness, and model simplicity.

In some embodiments, the selection of the champion state space model may also account for diagnostic information associated with each candidate model, such as stability of parameter estimates, convergence behavior during fitting, or adherence to modeling assumptions. The processing circuitry may use such diagnostic information to refine the selection process or to exclude certain candidate models from consideration.

### Executing a Simulation Smoother to Generate a Synthetic Component Trajectory for Each Model Component of the Champion State Space Model

In one or more embodiments, method 1440 may include process 1490 which may include generating the plurality of synthetic component trajectories includes executing, by the simulation smoother circuit, a simulation smoother to generate a synthetic component trajectory for each model component of the champion state space model based on providing at least the augmented data structure and the champion state space model as input to the simulation smoother. The execution of the simulation smoother may be performed by processing circuitry associated with the simulation smoother circuit, such as the simulation smoother circuit 1430 described above with respect to FIG. 14B

In some embodiments, the simulation smoother may refer to a computational procedure configured to generate simulated trajectories of latent model components over a sequence of time periods, conditioned on observed data and a fitted state space model. The simulation smoother may operate on the champion state space model, which may include a plurality of model components, such as regression components, latent components, and error components, each of which may contribute to the modeled behavior of a response variable over time. The augmented data structure, which includes both longitudinal data and partially completed data records, may be provided as input to the simulation smoother to define a temporal framework and observed data context for generating the synthetic component trajectories.

In some embodiments, executing the simulation smoother may include drawing one or more samples from a joint posterior distribution of latent state variables associated with the champion state space model. These latent state variables may correspond to unobserved temporal effects, such as trend, seasonal patterns, or other dynamic behaviors. The simulation smoother may generate, for each model component of the champion state space model, a corresponding synthetic component trajectory that represents a simulated evolution of that component across a specified time span, such as a target time span associated with the partially completed data records.

In some embodiments, the simulation smoother may generate synthetic component trajectories that extend across a target time span occurring before the historical time span. For example, the simulation smoother may generate values of one or more model components corresponding to time periods prior to observed data, thereby enabling reconstruction or backcasting of temporal behavior of the model components.

In some embodiments, when the state space model includes latent model components corresponding to shared behavior and panel-specific deviation behavior, the simulation smoother may generate a synthetic component trajectory for the shared latent model component that represents simulated shared behavior across the target time span, and may generate respective synthetic component trajectories for panel-specific latent model components that represent simulated deviation behavior for each panel across the target time span.

In some embodiments, each synthetic component trajectory may include a sequence of values indexed by time, where each value corresponds to a simulated state of a respective model component at a particular time period. For example, a first synthetic component trajectory may represent simulated values of a trend component over time, while a second synthetic component trajectory may represent simulated values of a seasonal component over time. Additional synthetic component trajectories may be generated for other latent components or model elements included in the champion state space model.

In some embodiments, each synthetic component trajectory generated for a respective latent model component may represent simulated behavior of the temporal effect associated with that latent model component across the target time span. For example, a synthetic component trajectory corresponding to a seasonal latent component may represent simulated seasonal variation over the target time span, while a synthetic component trajectory corresponding to a trend latent component may represent simulated long-term progression over the target time span.

In some embodiments, the simulation smoother may utilize stochastic processes, such as pseudo-random number generation, to introduce variability into the generated synthetic component trajectories while maintaining consistency with the statistical properties of the champion state space model and the observed longitudinal data. The generated synthetic component trajectories may therefore reflect plausible realizations of the underlying temporal processes modeled by the champion state space model.

### Using the Synthetic Component Trajectory Generated for Each Model Component of the Champion State Space Model to Compute a Set of Synthetic Response Data Values for the Plurality of Partially Completed Data Records

In one or more embodiments, method 1440 may include process 1495 which may include generating the plurality of synthetic data records further includes using the synthetic component trajectory generated for each model component of the champion state space model to compute a set of synthetic response data values for the plurality of partially completed data records. This operation may be performed by processing circuitry associated with a synthetic data generation circuit, such as the synthetic data generation circuit 1432 described above with respect to FIG. 14B.

In some embodiments, the plurality of synthetic data records generated by the synthetic data generation application may be used to train one or more machine learning models. For example, a machine learning model may be trained using the synthetic data records to learn patterns, relationships, or classes represented in the synthetic data, including target classes that may be underrepresented or absent in the original longitudinal data. In some embodiments, training the machine learning model using the synthetic data records may enable the machine learning model to learn to identify or predict the target class associated with the response variable. In some embodiments, an ensemble of machine learning models may be trained using the plurality of synthetic data records. The ensemble may include multiple models trained on the same or different subsets of the synthetic data records, and outputs of the ensemble may be combined to improve predictive performance or robustness.

In some embodiments, the synthetic component trajectories generated by the simulation smoother may provide, for each model component of the champion state space model, a sequence of simulated values indexed by time. Each partially completed data record may correspond to a particular time period within a target time span, and the synthetic data generation circuit may be configured to obtain, from each synthetic component trajectory, a corresponding model component value associated with that time period. In this manner, a set of component-specific values may be identified for each partially completed data record.

In some embodiments, computing a synthetic response data value for a given partially completed data record may include combining the model component values obtained from the synthetic component trajectories with one or more additional values associated with the partially completed data record. For example, the synthetic data generation circuit may compute a regression component value based on predictor variable data values included in the partially completed data record and a set of regression coefficients associated with the champion state space model. The synthetic data generation circuit may then aggregate the regression component value with the model component values and, in some embodiments, an error component value in accordance with a state space model equation defined by the champion state space model.

In some embodiments, computing a synthetic response data value for a respective partially completed data record may include performing a sequence of operations for a target time period specified by the respective partially completed data record. For example, the synthetic data generation circuit may obtain, from a first synthetic component trajectory corresponding to a first model component of the champion state space model, a first model component value associated with the target time period. The synthetic data generation circuit may further obtain, from a second synthetic component trajectory corresponding to a second model component of the champion state space model, a second model component value associated with the target time period.

In some embodiments, the synthetic data generation circuit may compute a regression component value for the respective partially completed data record based on multiplying a plurality of predictor variable data values included in the respective partially completed data record by a predetermined set of regression coefficients associated with the champion state space model. In some embodiments, the synthetic data generation circuit may further obtain an error component value corresponding to the target time period, where the error component value may be derived from a stochastic process associated with the champion state space model or from a synthetic component trajectory corresponding to an error component. In some embodiments, the synthetic data generation circuit may compute the synthetic response data value for the respective partially completed data record by combining the regression component value, the first model component value, the second model component value, and the error component value according to the state space model equation of the champion state space model.

In some embodiments, the aggregation of these components may produce a synthetic response data value that represents a simulated value of a response variable for the time period associated with the partially completed data record. The synthetic data generation circuit may perform this computation for each partially completed data record of the plurality of partially completed data records, thereby generating a corresponding set of synthetic response data values.

In some embodiments, the computation of the synthetic response data values may further include additional processing steps, such as applying a transformation or inverse transformation to an intermediate value generated by combining the model component values. For example, an intermediate synthetic response data value may be computed using the state space model equation, and an inverse transformation operation may subsequently be applied to obtain a final synthetic response data value. In other embodiments, modified versions of the state space model equation, including scaling factors or alternative parameterizations, may be used in computing the synthetic response data values.

In some embodiments, once the set of synthetic response data values has been computed, the synthetic data generation circuit may populate corresponding response data fields within the plurality of partially completed data records with the computed values, thereby generating a plurality of completed synthetic data records. These completed synthetic data records may collectively form at least a portion of the plurality of synthetic data records that are returned or otherwise provided as output of the synthetic data generation process.

### Exemplary Data Processing Workflow for Generating Synthetic Longitudinal Data

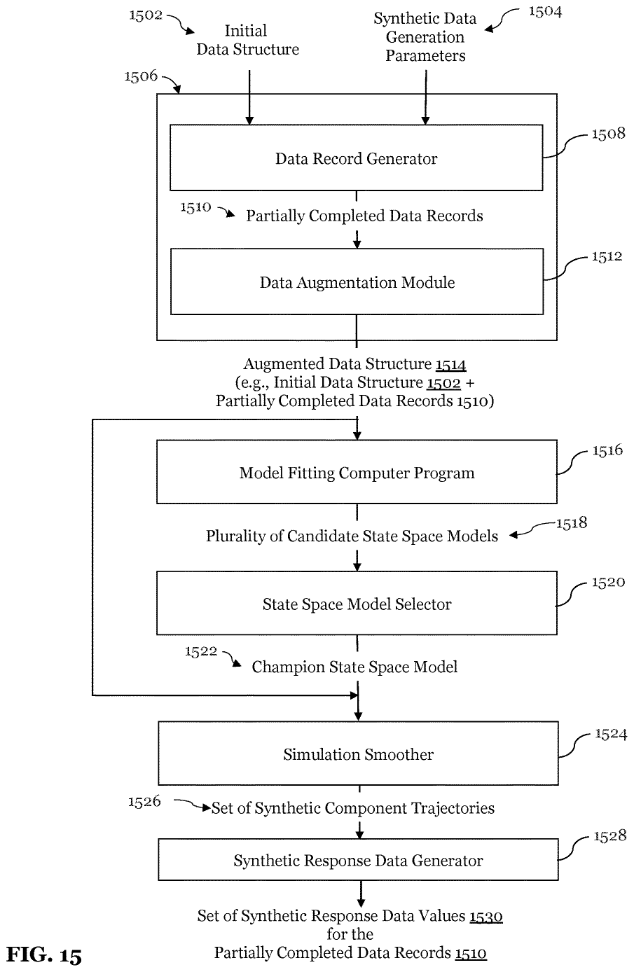

Turning now to FIG. 15, wherein exemplary data processing workflow for generating synthetic longitudinal data is illustrated. In some embodiments, FIG. 15 may represent a functional view of operations performed by a synthetic data generation application 1506, which may correspond to, or be an instance of, the synthetic data generation application described above with respect to FIGS. 14A and 14B.

In some embodiments, the synthetic data generation application 1506 may be configured to receive an initial data structure 1502 and one or more synthetic data generation parameters 1504. The initial data structure 1502 may include longitudinal data, such as a plurality of historical data records spanning a historical time span, while the synthetic data generation parameters 1504 may specify one or more conditions or configurations associated with generating synthetic data, such as a target time span or predictor variable settings.

In some embodiments, the synthetic data generation application 1506 may include or invoke a data record generator 1508 that may be configured to generate a plurality of partially completed data records 1510 based on the synthetic data generation parameters 1504. The partially completed data records 1510 may collectively span a target time span and may include temporal identifiers and predictor variable values, while including one or more unpopulated response data fields.

In some embodiments, the synthetic data generation application 1506 may further include or invoke a data augmentation module 1512 that may be configured to generate an augmented data structure 1514. The augmented data structure 1514 may be formed by combining the initial data structure 1502 with the plurality of partially completed data records 1510, for example, by appending new rows corresponding to the partially completed data records to the initial data structure. The augmented data structure 1514 may therefore include both historical data and data corresponding to the target time span.

In some embodiments, the augmented data structure 1514 may be provided as input to a model fitting computer program 1516, which may be configured to fit a plurality of candidate state space models 1518 using the longitudinal data included in the augmented data structure. The plurality of candidate state space models 1518 may represent alternative model configurations that capture temporal relationships within the data. In some embodiments, the synthetic data generation application 1506 may further include or invoke a state space model selector 1520 that may be configured to select a champion state space model 1522 from among the plurality of candidate state space models 1518. The selection may be based on one or more model efficacy criteria, such as goodness-of-fit or predictive performance.

In some embodiments, the champion state space model 1522 and the augmented data structure 1514 may be provided as input to a simulation smoother 1524. The simulation smoother 1524 may be configured to generate a set of synthetic component trajectories 1526, where each synthetic component trajectory corresponds to a respective model component of the champion state space model 1522 and represents a simulated evolution of that component over time.

In some embodiments, the champion state space model 1522 and the augmented data structure may be included in an API request generated by the synthetic data generation application. The API request may include structured data representing the champion state space model 1522, the augmented data structure 1514, and one or more simulation parameters, and may be formatted according to a communication protocol associated with the API endpoint. In some embodiments, the synthetic data generation application 1506 may transmit the API request over a computer network to an API endpoint associated with an analytics compute service. The analytics compute service may include one or more remote computing devices configured to perform computationally intensive operations associated with synthetic data generation.

In some embodiments, in response to the API endpoint receiving the API request, the analytics compute service may invoke a simulation smoother computer procedure to execute the simulation smoother using the champion state space model and the augmented data structure included in the API request. The simulation smoother computer procedure may generate synthetic component trajectories and may return one or more results to the host device.

In some embodiments, the synthetic component trajectories 1526 may be provided to a synthetic response data generator 1528, which may be configured to compute a set of synthetic response data values 1530 for the plurality of partially completed data records 1510. The synthetic response data generator 1528 may compute each synthetic response data value based on combining component values obtained from the synthetic component trajectories 1526 with predictor variable values and other components in accordance with a state space model equation associated with the champion state space model 1522.

In some embodiments, the computed set of synthetic response data values 1530 may be used to populate corresponding response data fields within the plurality of partially completed data records 1510, thereby generating completed synthetic data records. These completed synthetic data records may collectively represent synthetic longitudinal data generated by the synthetic data generation application 1506.

In some embodiments, the set of synthetic response data values generated for the plurality of partially completed data records may be organized into a plurality of distinct subsets, where each subset corresponds to a respective panel or replicate of the longitudinal data. In some embodiments, each subset of synthetic response data values may represent a scaled or adjusted behavior of a corresponding replicate. For example, synthetic response data values associated with a given replicate may be generated based on scaling, weighting, or transforming model component contributions or predictor variable values to reflect characteristics specific to that replicate.

In some embodiments, the synthetic data generation application may generate an output data structure that includes the plurality of synthetic response data values computed for the plurality of partially completed data records. The output data structure may be organized as a tabular structure in which each row corresponds to a respective partially completed data record. In some embodiments, each row of the output data structure may include a temporal attribute value corresponding to a respective time period within the target time span and a synthetic response data value computed for the respective partially completed data record.

It is to be understood that FIG. 15 illustrates one example arrangement of components and data flows, and that, in some embodiments, one or more components may be combined, omitted, or implemented in alternative configurations. Additionally, the operations illustrated in FIG. 15 may be performed by hardware, software, firmware, or any combination thereof executed by one or more processing devices within a computing system.

Exemplary Data Structures Associated with Generating Synthetic Longitudinal Data

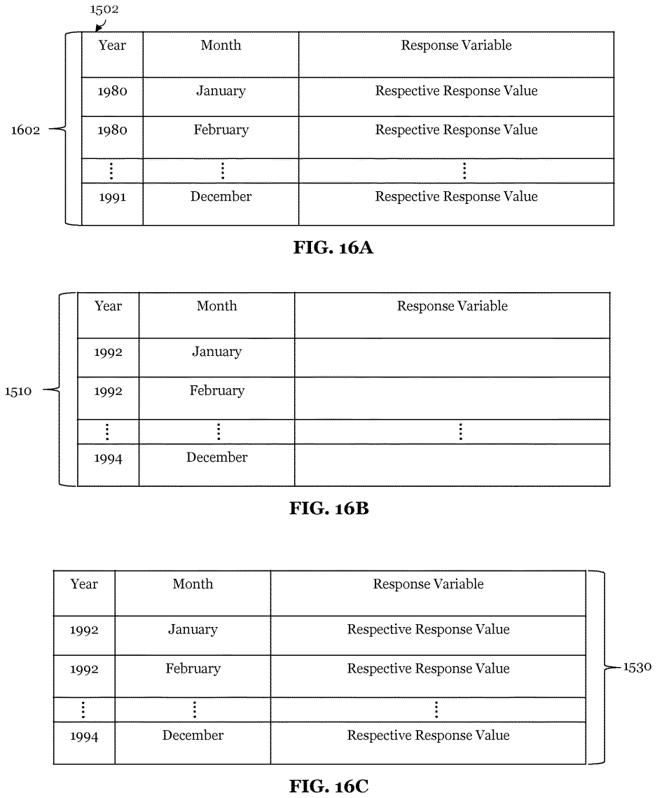

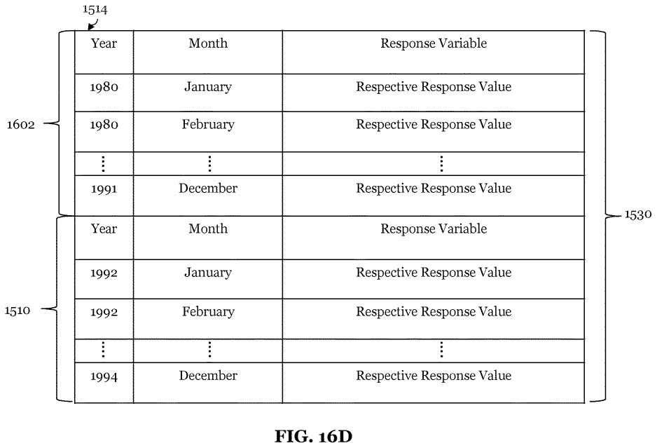

Turning now to FIGS. 16A-16D, which illustrate example data structures associated with generating synthetic longitudinal data, in accordance with some embodiments of the present disclosure. FIGS. 16A-16D may collectively depict transformations of data structures as the synthetic data generation process progresses from an initial data structure to an augmented data structure that includes synthetic response data values.

Referring first to FIG. 16A, an exemplary initial data structure 1602 is shown. In some embodiments, the exemplary initial data structure 1602 may correspond to the initial data structure 1502 described above with respect to FIG. 15. The exemplary initial data structure 1602 may include longitudinal data comprising a plurality of historical data records, where each data record may include a temporal attribute value, one or more predictor variable data values, and a response variable data value. The exemplary initial data structure 1602 may therefore represent observed data corresponding to a historical time span.

Turning to FIG. 16B, a plurality of partially completed data records 1510 is shown. In some embodiments, the plurality of partially completed data records 1510 may be generated based on one or more synthetic data generation parameters, as described above. Each partially completed data record may correspond to a respective time period within a target time span and may include one or more populated fields, such as temporal identifiers and predictor variable values, along with an unpopulated response data field. The plurality of partially completed data records 1510 may therefore represent a framework for synthetic data records to be completed in subsequent processing stages.

Referring now to FIG. 16C, a set of synthetic response data values 1530 is shown. In some embodiments, the set of synthetic response data values 1530 may be computed using synthetic component trajectories generated by a simulation smoother in conjunction with a champion state space model. Each synthetic response data value in the set of synthetic response data values 1530 may correspond to a respective partially completed data record of the plurality of partially completed data records 1510 and may represent a simulated value of a response variable for a corresponding time period within the target time span.

Turning to FIG. 16D, an augmented data structure 1514 is shown that includes the plurality of partially completed data records 1510 populated with the set of synthetic response data values 1530. In some embodiments, the augmented data structure 1514 may also include the longitudinal data from the initial data structure 1502 (or exemplary initial data structure 1602), thereby forming a unified data structure that spans both a historical time span and a target time span. The augmented data structure 1514 may therefore include completed synthetic data records corresponding to the target time span, where each completed record includes a temporal identifier, one or more predictor variable values, and a corresponding synthetic response data value.

In some embodiments, FIGS. 16A-16D may illustrate an example progression in which an initial data structure is supplemented with newly generated records and corresponding synthetic response data values to produce an augmented data structure that includes both observed and synthetic data. It is to be understood that the specific arrangement and content of the data structures shown in FIGS. 16A-16D are provided for illustrative purposes, and that variations in data schema, formatting, and content may be employed in different implementations.

### Exemplary Generation of Synthetic Component Trajectories Using a Champion State Space Model

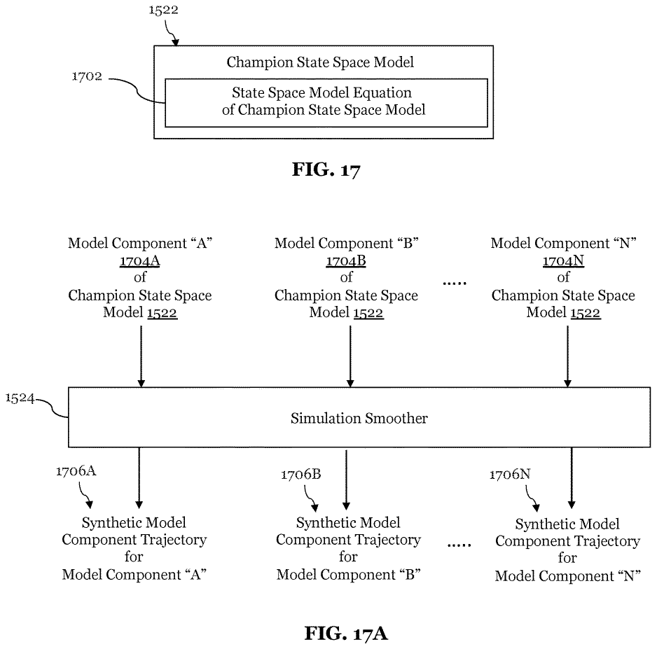

Turning now to FIGS. 17 and 17A, which illustrate aspects of generating synthetic component trajectories using a champion state space model, in accordance with some embodiments of the present disclosure. FIG. 17 may depict a structural representation of the champion state space model and its associated components, while FIG. 17A may depict example synthetic component trajectories generated for those components.

Referring first to FIG. 17, a champion state space model 1522 is shown. In some embodiments, the champion state space model 1522 may include a state space model equation 1702 that models a response variable as a function of a plurality of model components. The plurality of model components may include one or more components, such as model component “A” 1704A, model component “B” 1704B, and model component “N” 1704N, where “N” may represent any number of additional components included in the model. Each model component may correspond to a distinct contribution to the modeled behavior of the response variable, such as a regression component, one or more latent components representing temporal effects, or other modeled influences.

In some embodiments, the champion state space model 1522 may be provided as input to a simulation smoother 1524. The simulation smoother 1524 may be configured to generate a synthetic model component trajectory for each model component included in the champion state space model 1522. For example, the simulation smoother 1524 may generate a synthetic model component trajectory 1706A corresponding to model component “A” 1704A, a synthetic model component trajectory 1706B corresponding to model component “B” 1704B, and a synthetic model component trajectory 1706N corresponding to model component “N” 1704N. Each synthetic model component trajectory may represent a sequence of simulated values associated with a respective model component across a sequence of time periods.

Referring now to FIG. 17A, the synthetic model component trajectories 1706A, 1706B, and 1706N are illustrated in greater detail. In some embodiments, each synthetic model component trajectory may include a series of values indexed by time, where each value corresponds to a simulated state of a respective model component at a particular time period. The synthetic model component trajectories may collectively represent simulated temporal behaviors of the respective model components over a target time span, which may correspond to the time periods associated with the plurality of partially completed data records described above.

In some embodiments, the synthetic model component trajectories shown in FIG. 17A may be generated by the simulation smoother 1524 based on the champion state space model 1522 and an augmented data structure that includes longitudinal data and partially completed data records. The simulation smoother may utilize stochastic sampling procedures to generate the synthetic model component trajectories, such that the trajectories reflect variability while remaining consistent with statistical properties of the champion state space model and observed data.

In some embodiments, the synthetic model component trajectories 1706A, 1706B, and 1706N may be provided as inputs to a synthetic data generation circuit for computing synthetic response data values corresponding to respective time periods. The trajectories may therefore serve as intermediate data representations that capture simulated temporal dynamics of the model components and enable generation of synthetic longitudinal data. It is to be understood that the number and type of model components illustrated in FIGS. 17 and 17A are provided for illustrative purposes, and that a champion state space model may include any number of model components, including additional latent or observed components, depending on the application and modeling requirements.

### Exemplary Process for Computing a Synthetic Response Data Value Using Synthetic Component Trajectories and a State Space Model Equation

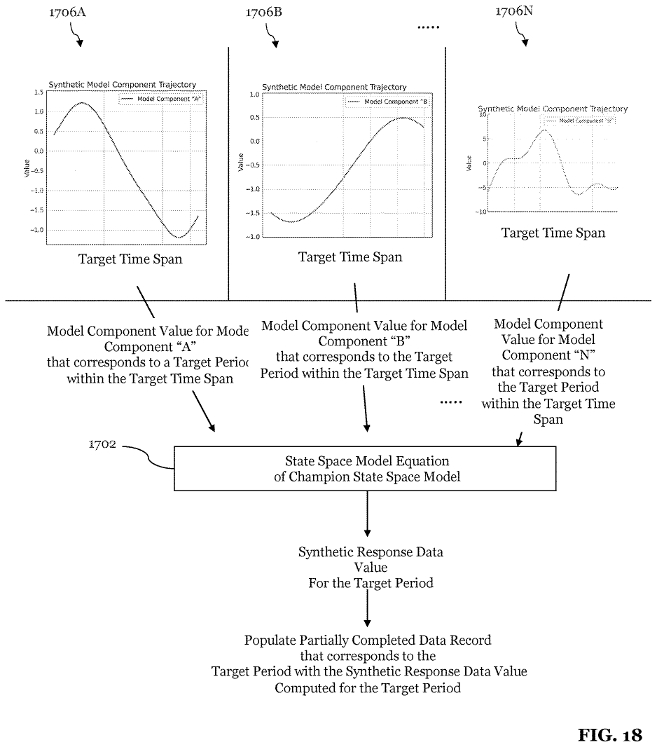

Turning now to FIG. 18, which illustrates an example process for computing a synthetic response data value for a given time period using synthetic component trajectories and a state space model equation, in accordance with some embodiments of the present disclosure. In some embodiments, FIG. 18 may depict how values derived from synthetic model component trajectories are utilized in conjunction with a state space model equation to generate a synthetic response data value corresponding to a target period within a target time span.

In some embodiments, a simulation smoother 1524 may generate a plurality of synthetic model component trajectories, such as a synthetic model component trajectory 1706A corresponding to model component “A,” a synthetic model component trajectory 1706B corresponding to model component “B,” and a synthetic model component trajectory 1706N corresponding to model component “N.” Each of the synthetic model component trajectories may include a sequence of simulated values indexed by time, where each value corresponds to a simulated state of the respective model component at a given time period.

In some embodiments, for a particular target period within a target time span, a model component value may be obtained from each of the synthetic model component trajectories. For example, a value corresponding to the target period may be selected from the synthetic model component trajectory 1706A, another value corresponding to the target period may be selected from the synthetic model component trajectory 1706B, and additional values may be selected from other synthetic model component trajectories, such as the synthetic model component trajectory 1706N. These selected values may represent simulated contributions of the respective model components for the target period.

In some embodiments, the obtained model component values may be provided as inputs to a state space model equation 1702 associated with a champion state space model. The state space model equation of the champion state space model 1702 may define a relationship for computing a response variable value as a function of the model component values and, in some embodiments, additional components such as a regression component and an error component. The processing circuitry may combine the model component values in accordance with the state space model equation of the champion state space model 1702 to compute a synthetic response data value corresponding to the target period.

In some embodiments, the synthetic response data value computed for the target period may be used to populate a corresponding field within a partially completed data record associated with the target period. This process may be repeated for multiple target periods within the target time span, thereby enabling the generation of a plurality of synthetic response data values based on the synthetic model component trajectories and the state space model equation.

It is to be understood that FIG. 18 illustrates one example of how synthetic component trajectories may be utilized to compute synthetic response data values, and that variations in the form of the state space model equation, the number of model components, and the manner in which component values are combined may be employed in different embodiments.

### Exemplary Process for Computing a Synthetic Response Data Value Using Synthetic Component Trajectories, a State Space Model Equation, and an Inverse Transformation Operation

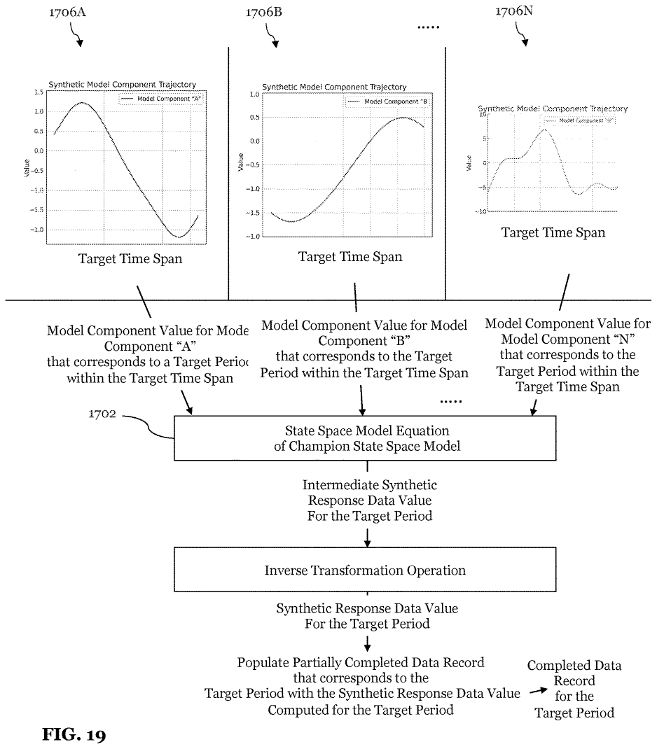

Turning now to FIG. 19, which illustrates an example process for computing a synthetic response data value using synthetic model component trajectories and a state space model equation, in accordance with some embodiments of the present disclosure. In some embodiments, FIG. 19 may depict an extension of the process described with respect to FIG. 18, wherein an intermediate synthetic response data value may be generated and subsequently transformed to produce a final synthetic response data value.

In some embodiments, a simulation smoother 1524 may generate a plurality of synthetic model component trajectories, including a synthetic model component trajectory 1706A corresponding to model component “A,” a synthetic model component trajectory 1706B corresponding to model component “B,” and a synthetic model component trajectory 1706N corresponding to model component “N.” Each synthetic model component trajectory may include a sequence of simulated values across a target time span, and, for a given target period, a respective model component value may be obtained from each trajectory.

In some embodiments, the obtained model component values corresponding to the target period may be provided as inputs to a state space model equation 1702 associated with the champion state space model. The processing circuitry may combine the model component values, and, in some embodiments, one or more additional components such as a regression component and an error component, in accordance with the state space model equation 1702 to compute an intermediate synthetic response data value for the target period.

In some embodiments, the intermediate synthetic response data value may be subjected to an additional processing step, such as an inverse transformation operation, to generate a final synthetic response data value. The inverse transformation operation may correspond to reversing a transformation applied during model fitting or may otherwise map the intermediate value to a desired scale or domain associated with the response variable. As a result, the final synthetic response data value may represent a simulated value of the response variable that is consistent with the statistical properties of the champion state space model.

In some embodiments, the computation of a synthetic response data value may include a multi-stage process in which an intermediate synthetic response data value is first computed based on the state space model equation, and a subsequent inverse transformation operation is then applied to the intermediate synthetic response data value to obtain a final synthetic response data value. In this manner, the intermediate synthetic response data value may represent a value in a transformed domain, and the inverse transformation operation may convert the intermediate synthetic response data value into a corresponding value in an original or target domain associated with the response variable.

In some embodiments, the inverse transformation operation may correspond to reversing a transformation applied during model fitting or preprocessing of the longitudinal data. For example, where a transformation such as a logarithmic transformation, normalization, standardization, or scaling operation has been applied to the response variable during model fitting, the inverse transformation operation may include applying a corresponding inverse function, such as an exponential function, denormalization operation, or rescaling operation, to the intermediate synthetic response data value. In some embodiments, the inverse transformation operation may be applied directly to the intermediate synthetic response data value generated by aggregating model component values according to the state space model equation. The resulting transformed value may correspond to the synthetic response data value that is stored in a respective partially completed data record.

In some embodiments, the final synthetic response data value may be used to populate a corresponding field within a partially completed data record associated with the target period, thereby generating a completed data record. This process may be repeated for multiple target periods within the target time span, enabling generation of a plurality of completed synthetic data records based on the synthetic model component trajectories and the state space model equation.

It is to be understood that FIG. 19 illustrates one example of incorporating an intermediate computation and transformation step into the generation of synthetic response data values, and that variations in the type of transformation, the form of the state space model equation, and the number of model components may be employed in different embodiments.

### Exemplary Process for Computing a Synthetic Response Data Value Using Synthetic Component Trajectories and a Modified Version of State Space Model Equation

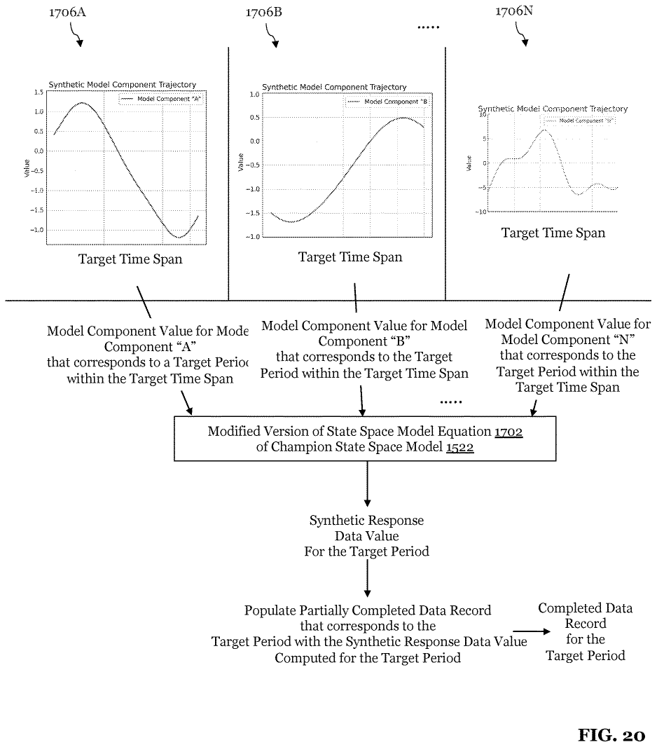

Turning now to FIG. 20, which illustrates an example process for computing a synthetic response data value using a modified version of a state space model equation, in accordance with some embodiments of the present disclosure. In some embodiments, FIG. 20 may depict a variation of the processes described with respect to FIGS. 18 and 19, wherein synthetic response data values may be computed using an alternative or modified formulation of the state space model equation.

In some embodiments, the obtained model component values corresponding to the target period may be provided as inputs to a modified version of the state space model equation 1702 associated with the champion state space model 1522. The modified version of the state space model equation may differ from the original state space model equation, for example, by including one or more additional scaling factors, weighting parameters, or alternative functional relationships among the model components. The processing circuitry may aggregate the model component values, and, in some embodiments, additional components such as a regression component and an error component, according to the modified version of the state space model equation to compute a synthetic response data value for the target period.

In some embodiments, the modified version of the state space model equation may include one or more scaling factors applied to respective model component values. For example, a first model component value obtained from a first synthetic component trajectory may be multiplied by a first scaling factor, and a second model component value obtained from a second synthetic component trajectory may be multiplied by a second scaling factor prior to aggregation. The scaled model component values may then be combined with the regression component value and the error component value to compute the synthetic response data value.

In some embodiments, the modified version of the state space model equation may correspond to an alternative formulation of the state space model equation in which one or more terms, coefficients, or functional relationships are adjusted relative to a baseline formulation of the state space model equation. The modified version of the state space model equation may therefore represent a distinct computational form used to combine model component values when generating synthetic response data values.

In some embodiments, the modified version of the state space model equation may enable adjustment of the relative contributions of different model components when computing the synthetic response data value. For example, one or more model component values obtained from the synthetic model component trajectories may be scaled or transformed prior to aggregation, thereby allowing for controlled variation in the generated synthetic data. In some embodiments, such modifications may be specified by one or more synthetic data generation parameters or may be determined based on characteristics of the longitudinal data.

In some embodiments, the synthetic response data value computed using the modified version of the state space model equation may be used to populate a corresponding field within a partially completed data record associated with the target period, thereby generating a completed data record. This process may be repeated for multiple target periods within the target time span to generate a plurality of synthetic data records.

It is to be understood that FIG. 20 illustrates one example of computing synthetic response data values using a modified state space model equation, and that various alternative modifications, parameterizations, or computational approaches may be employed depending on the desired characteristics of the synthetic data and the modeling requirements.

### Exemplary Generation of Synthetic Response Data Values Based on Longitudinal Data Using a Simulation Smoother

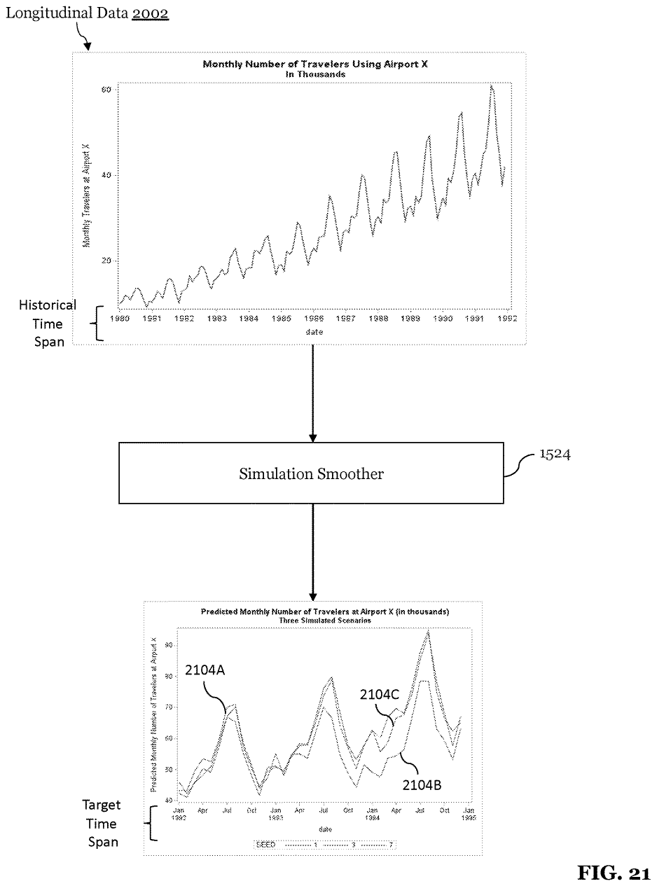

Turning now to FIG. 21, which illustrates an example of generating multiple sets of synthetic response data values based on longitudinal data using a simulation smoother, in accordance with some embodiments of the present disclosure. In some embodiments, FIG. 21 may depict how different simulated outcomes may be generated from the same underlying longitudinal data through repeated execution of a simulation procedure.

In some embodiments, longitudinal data 2002 may be provided as input to a simulation smoother 1524. The longitudinal data 2002 may include a plurality of historical data records spanning a historical time span and may be used, in conjunction with a fitted state space model, to condition the operation of the simulation smoother 1524. The simulation smoother 1524 may utilize the longitudinal data 2002 to generate simulated trajectories of model components, as described above, and may further use those trajectories to compute synthetic response data values.

In some embodiments, the simulation smoother 1524 may be configured to execute multiple simulations, where each simulation may produce a distinct set of synthetic response data values. For example, a first execution of the simulation smoother 1524 may generate a first exemplary set of synthetic response data values 2104A, a second execution may generate a second exemplary set of synthetic response data values 2104B, and a third execution may generate a third exemplary set of synthetic response data values 2104C. Each set of synthetic response data values may correspond to a simulated realization of the response variable across a target time span.

In some embodiments, the differences among the first, second, and third exemplary sets of synthetic response data values 2104A, 2104B, and 2104C may arise from stochastic elements within the simulation smoother 1524, such as pseudo-random sampling of latent component trajectories or error terms. As a result, each set of synthetic response data values may represent a plausible variation of the response variable that is consistent with the statistical properties of the longitudinal data 2002 and the underlying state space model.

In some embodiments, the plurality of sets of synthetic response data values generated by the simulation smoother 1524 may be used for a variety of purposes, such as generating multiple synthetic datasets, performing uncertainty analysis, or supporting downstream modeling and testing procedures. The ability to generate multiple distinct synthetic outcomes from the same longitudinal data may enable improved exploration of variability and robustness in simulated data.

It is to be understood that FIG. 21 illustrates one example in which multiple sets of synthetic response data values are generated, and that any number of simulations may be performed to generate corresponding sets of synthetic response data values, depending on one or more synthetic data generation parameters or application-specific requirements.

### Exemplary Generation of a Set of Synthetic Response Data Values Based on Longitudinal Data Using a Simulation Smoother

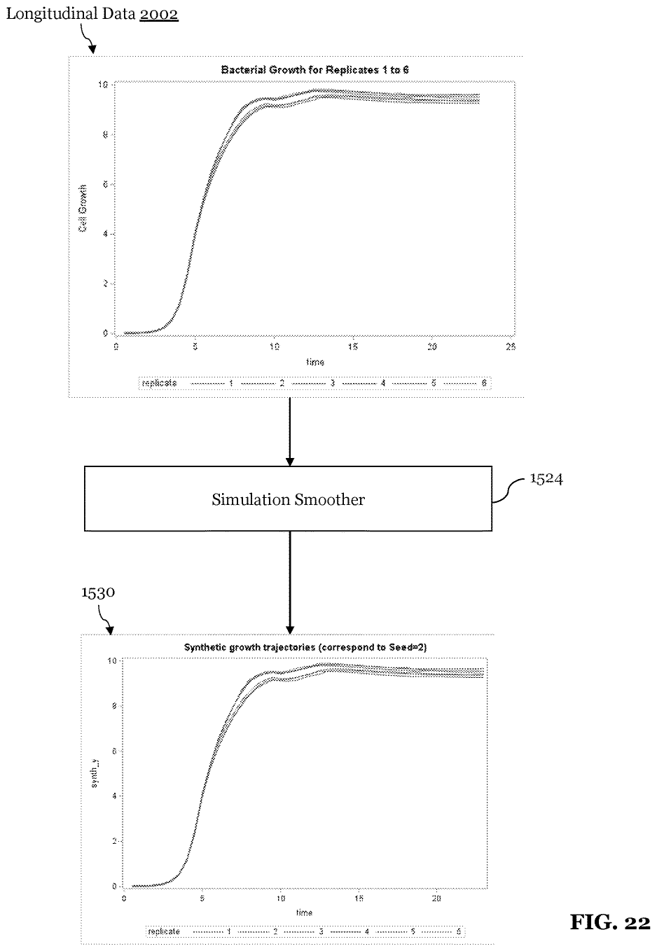

Turning now to FIG. 22, which illustrates an example generation of a set of synthetic response data values based on longitudinal data using a simulation smoother, in accordance with some embodiments of the present disclosure. In some embodiments, FIG. 22 may depict a streamlined representation of the synthetic data generation process in which a single set of synthetic response data values is produced from input longitudinal data.

In some embodiments, longitudinal data 2002 may be provided as input to a simulation smoother 1524. The longitudinal data 2002 may include a plurality of historical data records spanning a historical time span and may be used to condition the operation of the simulation smoother 1524. For example, the simulation smoother 1524 may utilize the longitudinal data 2002 in conjunction with a previously selected champion state space model to generate simulated trajectories of model components and corresponding response values.

In some embodiments, the simulation smoother 1524 may generate a set of synthetic response data values 1530 based on the longitudinal data 2002. The set of synthetic response data values 1530 may include a plurality of values corresponding to a sequence of time periods, such as a target time span that may differ from the historical time span represented by the longitudinal data 2002. Each synthetic response data value in the set 1530 may represent a simulated value of a response variable for a respective time period.

In some embodiments, the set of synthetic response data values 1530 may be generated based on stochastic sampling procedures performed by the simulation smoother 1524, such that the generated values reflect variability while maintaining consistency with statistical characteristics of the longitudinal data 2002 and the underlying model. The generated set of synthetic response data values 1530 may therefore represent a plausible realization of the response variable over the target time span.

In some embodiments, the set of synthetic response data values 1530 may be used to populate corresponding fields within a plurality of partially completed data records, thereby forming completed synthetic data records. The resulting synthetic data may be stored, returned to a requesting system, or used in downstream analytical or modeling processes.

It is to be understood that FIG. 22 illustrates one example of generating a set of synthetic response data values from longitudinal data using a simulation smoother, and that variations in input data, model configuration, and simulation parameters may result in different synthetic outputs.

Exemplary Performance Characteristics Associated with Generating Synthetic Response Data Values for Different Input Configurations

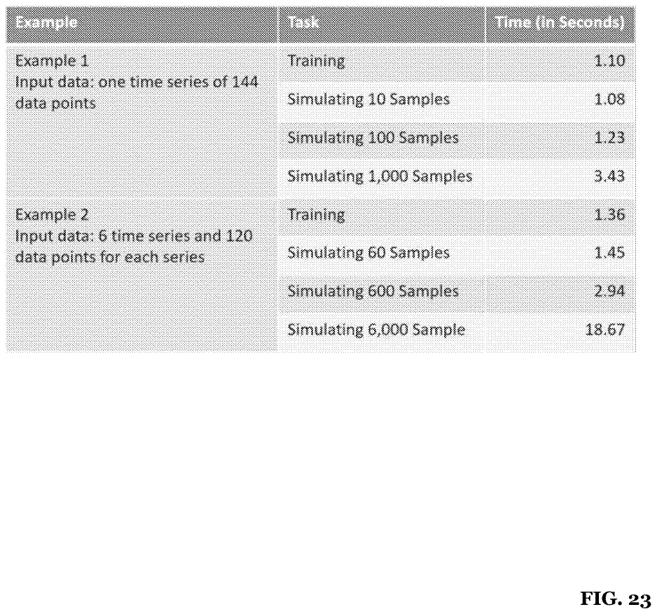

Turning now to FIG. 23, which illustrates example performance characteristics associated with generating synthetic response data values for different input configurations, in accordance with some embodiments of the present disclosure. In some embodiments, FIG. 23 may present comparative examples that demonstrate execution of the synthetic data generation process under different input data scenarios and corresponding computational tasks.

In some embodiments, FIG. 23 may include a first example in which input data includes a single time series comprising 144 data points. The time series may correspond to longitudinal data spanning a particular historical time span, and may be provided as input to a synthetic data generation application, such as the synthetic data generation application described above. For the first example, a sequence of tasks associated with generating synthetic response data values may be performed, such as generating partially completed data records, forming an augmented data structure, fitting one or more candidate state space models, selecting a champion state space model, executing a simulation smoother, and computing synthetic response data values. FIG. 23 may further indicate a corresponding amount of time taken to perform each of these tasks for the single time series input, thereby providing an indication of computational performance for that configuration.

In some embodiments, FIG. 23 may further include a second example in which input data includes a plurality of time series, such as six time series, each comprising 120 data points. Each time series may correspond to a distinct panel or replicate of longitudinal data, and the plurality of time series may collectively be processed by the synthetic data generation application. Similar to the first example, a sequence of tasks may be performed for the second example, including data preparation, model fitting, model selection, simulation smoothing, and synthetic response data value computation. FIG. 23 may further illustrate a corresponding amount of time taken for each of these tasks when processing the plurality of time series.

In some embodiments, the comparison between the first example and the second example may illustrate how computational performance, such as execution time for individual tasks or overall processing time, may vary based on characteristics of the input data, such as the number of time series and the number of data points within each series. For example, increasing the number of time series or the dimensionality of the input data may increase computational complexity associated with model fitting and simulation procedures, which may be reflected in increased execution times for certain tasks. It is to be understood that the specific task breakdowns and execution times shown in FIG. 23 are provided for illustrative purposes, and that actual performance may vary depending on system configuration, model complexity, parameter settings, and implementation details of the synthetic data generation application.

Exemplary Equations Utilized within Various Processes of State Space Model-Based Synthetic Data Generation for Longitudinal and Time Series Data

In some embodiments, a state space modeling framework may be used to represent temporal behavior of a response variable in the synthetic data generation process. For example, the response variable at a given time period t may be modeled as a combination of multiple components, including contributions from predictor variables, latent temporal effects, and stochastic noise, as represented by the following form.

yₜ=Xₜβ+μₜ+ψₜ+ωₜ+ . . . +∈ₜ

In this formulation, the term yₜ may represent a response variable value at time period t which may correspond to an observed value in longitudinal data or a synthetic response data value generated for a partially completed data record. The term Xₜ may represent a vector of predictor variable data values observed at time period t, and β may represent a corresponding vector of regression coefficients. The product Xₜβ may therefore define a regression component that captures contributions of predictor variables to the response variable.

In some embodiments, the terms μₜ, ψₜ, and ωₜ may represent distinct latent components of the state space model. Each latent component may correspond to a different temporal effect. For example, μₜ may represent a trend component that captures long-term progression in the data, ψₜ may represent a seasonal component that captures periodic patterns, and ωₜ may represent a transient or irregular component that captures short-term fluctuations. Additional latent components may also be included, as indicated by the ellipsis, depending on the model specification. The term ∈ₜ may represent an error component, which may capture stochastic variation or noise not explained by the other components.

In some embodiments, individual latent components of the state space model may be associated with distinct types of temporal behavior. For example, a first latent model component may represent a seasonal behavior characterized by periodic variation over time, a second latent model component may represent a trend behavior corresponding to a long-term progression of the response variable, and a third latent model component may represent a transient behavior corresponding to short-term or irregular fluctuations. Additional latent model components may be included to represent other temporal effects.

In some embodiments, the above equation may be used as part of a broader process for generating synthetic longitudinal data. For example, in a first step, a data structure may be defined that specifies a desired form of synthetic data. This may include generating an augmented data structure that extends historical data with additional rows corresponding to a target time span and, in some embodiments, new predictor variable configurations. The response variable values for these additional rows may initially be unpopulated, thereby forming partially completed data records.

In a second step, a suitable state space model of the form described above may be fitted to the augmented data structure using longitudinal data. This fitting process may involve estimating the regression coefficients β and parameters associated with each latent component, as well as determining appropriate model structure through iterative model specification and diagnostic evaluation.

In a third step, the fitted state space model may be used in conjunction with a simulation smoother to generate synthetic trajectories for each model component, including the latent components μₜ, ψₜ, ωₜ, and the error component ∈ₜ. The simulation smoother may draw samples from a posterior distribution of these components conditioned on the observed data, thereby generating plausible realizations of their temporal behavior. In some embodiments, multiple simulations may be performed, each associated with a respective random seed, to generate multiple sets of component trajectories.

In a fourth step, synthetic response data values may be generated by combining the simulated component trajectories with the regression component defined by the product Xₜβ. For each time period corresponding to a partially completed data record, component values may be obtained from the simulated trajectories and aggregated according to the state space model equation. In some embodiments, additional transformations may be applied to intermediate values to produce final synthetic response data values. The resulting values may then be used to populate the response data fields of the partially completed data records, thereby generating one or more synthetic datasets.

It is to be understood that the equation and associated steps described herein provide one example framework for modeling and generating synthetic longitudinal data, and that variations in model structure, component definitions, and processing steps may be employed depending on application-specific requirements.

As a person skilled in the art will recognize from the previous detailed description and from the figures and claims, modifications and changes can be made to the embodiments of the disclosure without departing from the scope of the various described embodiments. For example, aspects/operations of method 1440 may be interchanged, substituted, and/or added between these methods.

It shall also be noted that the system and methods of the embodiments and variations described herein can be embodied and/or implemented at least in part as a machine comprising a computer-readable medium storing computer-readable instructions. The instructions may be executed by computer-executable components integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, memory sticks (e.g., SD cards, USB flash drives), cloud-based services (e.g., cloud storage), magnetic storage devices, Solid-State Drives (SSDs), or any suitable device. The computer-executable component is preferably a general or application-specific processor, but any suitable dedicated hardware or hardware/firmware combination device can alternatively or additionally execute the instructions.

It shall be noted that, in the method(s) described herein where one or more steps (e.g., processes) are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The systems and methods of the preferred embodiments may additionally, or alternatively, be implemented on an integrated data analytics software application and/or software architecture such as those offered by SAS Institute Inc. of Cary, N.C., USA. Merely for illustration, the systems and methods of the preferred embodiments may be implemented using or integrated with one or more SAS software tools such as SAS® Viya™ which is developed and provided by SAS Institute Inc. of Cary, N.C., USA.

Although omitted for conciseness, the preferred embodiments include every combination and permutation of the implementations of the systems and methods described herein in real-time or near real-time, asynchronously (e.g., sequentially), concurrently (e.g., in parallel), or in any other suitable order by and/or using one or more instances of the systems, elements, and/or entities described herein. It shall be noted that “real-time” or “near real-time” as generally used herein may refer to generating an output or performing an action within strict time constraints. For example, in one or more embodiments, real-time may be understood to be instantaneous, on the order of milliseconds, or on the order of minutes. Of course, depending on the particular temporal nature of the system in which an embodiment is implemented, other appropriate timescales may be considered acceptable for real-time or near real-time processing.

Embodiments of the system and/or method can include every combination and permutation of the various system components and the various method processes, wherein one or more instances of the method and/or processes described herein can be performed in real-time or near real-time, asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments of the application without departing from the scope of the various described embodiments.

What is claimed is:

1. A computer-implemented system comprising:
one or more input devices;
a network interface coupled to the one or more input devices;
a host device coupled to the network interface, the host device comprising:
a processor; and
a synthetic data generation application comprising computer-readable instructions that, when executed by the processor, implement a plurality of circuits that control a generation of synthetic data, wherein the plurality of circuits include:
a request detection circuit that receives, via the network interface, a synthetic data generation request that includes longitudinal data and one or more synthetic data generation parameters,
a model fitting and selection circuit that (i) fits a plurality of candidate state space models to the longitudinal data received by the request detection circuit and (ii) elects one of the plurality of candidate state space models as a champion state space model,
a simulation smoother circuit that generates a plurality of synthetic component trajectories using at least the champion state space model elected by the model fitting and selection circuit, and
a synthetic data generation circuit that generates a plurality of synthetic data records using the plurality of synthetic component trajectories generated by the simulation smoother circuit; and
an output device coupled to the host device that returns, using the network interface, the plurality of synthetic data records to a user associated with the synthetic data generation request.

2. The computer-implemented system according to claim 1, wherein:
in response to the request detection circuit receiving the synthetic data generation request, the request detection circuit obtains, from computer memory, an initial data structure comprising the longitudinal data and the one or more synthetic data generation parameters stored in association with the initial data structure,
in response to obtaining the initial data structure and the one or more synthetic data generation parameters, the synthetic data generation application:
generates and stores in the computer memory a plurality of partially completed data records according to the one or more synthetic data generation parameters, and
generates an augmented data structure that includes the longitudinal data and the plurality of partially completed data records,
fitting the plurality of candidate state space models includes fitting, by the model fitting and selection circuit executing a model fitting computer program, the plurality of candidate state space models using the longitudinal data included in the augmented data structure,
electing the one of the plurality of candidate state space models as the champion state space model includes selecting, in response to fitting the plurality of candidate state space models, the one of the plurality of candidate state space models as the champion state space model based on the one of the plurality of candidate state space models satisfying a model efficacy criterion,
generating the plurality of synthetic component trajectories includes executing, by the simulation smoother circuit, a simulation smoother to generate a synthetic component trajectory for each model component of the champion state space model based on providing at least the augmented data structure and the champion state space model as input to the simulation smoother, and
generating the plurality of synthetic data records further includes using the synthetic component trajectory generated for each model component of the champion state space model to compute a set of synthetic response data values for the plurality of partially completed data records.

3. The computer-implemented system according to claim 2, wherein:
each partially completed data record of the plurality of partially completed data records includes an unpopulated response data field, and
the computer-readable instructions, when executed by the processor, perform operations further comprising:
in response to computing the set of synthetic response data values, populating the unpopulated response data field within each partially completed data record of the augmented data structure with a corresponding synthetic response data value included in the set of synthetic response data values.

4. The computer-implemented system according to claim 2, wherein:
the longitudinal data includes a plurality of historical data records collectively corresponding to a historical time span,
the one or more synthetic data generation parameters specifies a request to generate, at a predetermined time interval, synthetic longitudinal data for a target time span different from the historical time span,
the plurality of partially completed data records collectively span the target time span at the predetermined time interval, and
generating the augmented data structure includes:
creating a plurality of new rows based on a total number of the plurality of partially completed data records; and
augmenting the initial data structure with the plurality of new rows to form the augmented data structure.

5. The computer-implemented system according to claim 4, wherein:
each partially completed data record of the plurality of partially completed data records includes a respective temporal identifier,
each new row of the plurality of new rows corresponds to a distinct one of the plurality of partially completed data records,
each new row of the plurality of new rows includes the respective temporal identifier that corresponds to the distinct one of the plurality of partially completed data records, and
each new row of the plurality of new rows includes an unpopulated response data field.

6. The computer-implemented system according to claim 2, wherein:
the longitudinal data includes a plurality of historical data records spanning a historical time span,
a schema of the initial data structure specifies a plurality of predictor variables, a response variable associated with the plurality of predictor variables, and a temporal attribute,
each historical data record of the plurality of historical data records includes:
a temporal attribute value specifying a distinct period within the historical time span,
a plurality of predictor variable data values observed for the distinct period that correspond to the plurality of predictor variables, and
a response variable data value observed for the distinct period that corresponds to the response variable, and
the champion state space model models a temporal behavior of the response variable across the historical time span as a state space model equation.

7. The computer-implemented system according to claim 6, wherein:
the state space model equation predicts a subject response data value for the response variable at a given time as a sum of a regression component, a plurality of distinct latent components, and an error component,
the regression component represents a contribution of the plurality of predictor variable data values observed at the given time multiplied by a predetermined set of regression coefficients, and
each distinct latent component of the plurality of distinct latent components represents an effect of a distinct time-based factor at the given time.

8. The computer-implemented system according to claim 6, wherein:
the champion state space model includes at least a first model component and a second model component,
the set of synthetic response data values computed for the plurality of partially completed data records includes a respective synthetic response data value computed for each partially completed data record of the plurality of partially completed data records, and
computing the respective synthetic response data value for a respective partially completed data record of the plurality of partially completed data records using the synthetic component trajectory generated for each model component of the champion state space model includes:
obtaining, from the synthetic component trajectory generated for the first model component, a first model component value for the first model component based on a target time period specified by the respective partially completed data record;
obtaining, from the synthetic component trajectory generated for the second model component, a second model component value for the second model component based on the target time period specified by the respective partially completed data record;
computing a regression component value for the respective partially completed data record based on multiplying a plurality of predictor variable data values included in the respective partially completed data record by a predetermined set of regression coefficients; and
combining the regression component value, the first model component value, the second model component value, and an error component value according to the state space model equation to compute the respective synthetic response data value for the respective partially completed data record.

9. The computer-implemented system according to claim 6, wherein:
the champion state space model includes at least a first model component and a second model component,
the set of synthetic response data values computed for the plurality of partially completed data records includes a respective synthetic response data value computed for each partially completed data record of the plurality of partially completed data records, and
computing the respective synthetic response data value for a respective partially completed data record of the plurality of partially completed data records using the synthetic component trajectory generated for each model component of the champion state space model includes:
obtaining, from the synthetic component trajectory generated for the first model component, a first model component value for the first model component based on a target time period specified by the respective partially completed data record;
obtaining, from the synthetic component trajectory generated for the second model component, a second model component value for the second model component based on the target time period specified by the respective partially completed data record;
computing a regression component value for the respective partially completed data record based on multiplying a plurality of predictor variable data values included in the respective partially completed data record by a predetermined set of regression coefficients;
computing an intermediate synthetic response data value for the respective partially completed data record by aggregating the regression component value, the first model component value, the second model component value, and an error component value according to the state space model equation; and
executing an inverse transformation operation on the intermediate synthetic response data value to compute the respective synthetic response data value for the respective partially completed data record.

10. The computer-implemented system according to claim 6, wherein:
the champion state space model includes at least a first model component and a second model component,
the set of synthetic response data values computed for the plurality of partially completed data records includes a respective synthetic response data value computed for each partially completed data record of the plurality of partially completed data records, and
computing the respective synthetic response data value for a respective partially completed data record of the plurality of partially completed data records using the synthetic component trajectory generated for each model component of the champion state space model includes:
obtaining, from the synthetic component trajectory generated for the first model component, a first model component value for the first model component based on a target time period specified by the respective partially completed data record;
obtaining, from the synthetic component trajectory generated for the second model component, a second model component value for the second model component based on the target time period specified by the respective partially completed data record;
computing a regression component value for the respective partially completed data record based on multiplying a plurality of predictor variable data values included in the respective partially completed data record by a predetermined set of regression coefficients; and
aggregating, based on a modified version of the state space model equation, the regression component value, the first model component value, the second model component value, and an error component value to compute the respective synthetic response data value for the respective partially completed data record.

11. The computer-implemented system according to claim 10, wherein:
the modified version of the state space model equation includes one or more additional scaling factors when compared to the state space model equation of the champion state space model.

12. The computer-implemented system according to claim 10, wherein:
the state space model equation does not include a first scaling factor for the first model component nor a second scaling factor for the second model component,
the modified version of the state space model equation includes the first scaling factor for the first model component and the second scaling factor for the second model component, and
aggregating the regression component value, the first model component value, the second model component value, and the error component value based on the modified version of the state space model equation includes:
computing a first scaled model component value by multiplying the first model component value by the first scaling factor;
computing a second scaled model component value by multiplying the second model component value by the second scaling factor; and
computing the respective synthetic response data value for the respective partially completed data record by summing the first scaled model component value, the second scaled model component value, the regression component value, and the error component value.

13. The computer-implemented system according to claim 2, wherein the computer-readable instructions, when executed by the processor, perform operations further comprising:
in response to selecting the champion state space model:
generating, by the processor, an application programming interface request that includes the champion state space model and the augmented data structure;
transmitting, over a computer network, the application programming interface request to an API endpoint of an analytics compute service; and
invoking, in response to the API endpoint of the analytics compute service receiving the application programming interface request, a simulation smoother computer procedure that executes the simulation smoother.

14. The computer-implemented system according to claim 2, wherein:
the longitudinal data includes a plurality of historical data records collectively spanning a historical time span,
the plurality of partially completed data records collectively span a target time span that occurred after the historical time span, and
the synthetic component trajectory generated for a respective model component of the champion state space model represents a simulated behavior of the respective model component across the target time span.

15. The computer-implemented system according to claim 2, wherein:
the longitudinal data includes a plurality of historical data records collectively spanning a historical time span,
the plurality of partially completed data records collectively span a target time span that occurred before the historical time span, and
the synthetic component trajectory generated for a respective model component of the champion state space model represents a simulated behavior of the respective model component across the target time span.

16. The computer-implemented system according to claim 2, wherein:
the champion state space model includes a plurality of model components,
the plurality of model components includes a plurality of latent model components,
a first latent model component of the plurality of latent model components represents a seasonal behavior observed in the longitudinal data,
a second latent model component of the plurality of latent model components represents a trend behavior observed in the longitudinal data, and
a third latent model component of the plurality of latent model components represents a transient behavior observed in the longitudinal data.

17. The computer-implemented system according to claim 16, wherein:
the plurality of partially completed data records collectively span a target time span that is different from a historical time span spanned by the longitudinal data,
the synthetic component trajectory generated for the first latent model component represents a simulated behavior of the seasonal behavior across the target time span,
the synthetic component trajectory generated for the second latent model component represents a simulated behavior of the trend behavior across the target time span, and
the synthetic component trajectory generated for the third latent model component represents a simulated behavior of the transient behavior across the target time span.

18. The computer-implemented system according to claim 2, wherein:
the champion state space model includes a plurality of model components,
the plurality of model components includes a plurality of latent model components,
a first latent model component of the plurality of latent model components represents a shared longitudinal behavior across a plurality of distinct experiments, and
a second latent model component of the plurality of latent model components models a distinct experiment deviation curve for each distinct experiment of the plurality of distinct experiments.

19. The computer-implemented system according to claim 18, wherein:
the plurality of partially completed data records collectively span a target time span that is different from a historical time span spanned by the longitudinal data,
the synthetic component trajectory generated for the first latent model component represents a simulated behavior of the shared longitudinal behavior across the target time span, and
the synthetic component trajectory generated for the second latent model component includes a simulated behavior of the distinct experiment deviation curve for each distinct experiment of the plurality of distinct experiments across the target time span.

20. The computer-implemented system according to claim 2, wherein:
the plurality of partially completed data records collectively span a target time span that is different from a historical time span spanned by the longitudinal data, and
the computer-readable instructions, when executed by the processor, perform operations further comprising:
commencing an automated execution of the computer-readable instructions in response to receiving the synthetic data generation request that includes the initial data structure and the one or more synthetic data generation parameters, and
in response to executing the simulation smoother, generating an output data structure that includes the set of synthetic response data values for the plurality of partially completed data records as a response to the synthetic data generation request, wherein:
each row in the output data structure corresponds to a distinct partially completed data record of the plurality of partially completed data records, and
each row in the output data structure includes:
a temporal attribute value specifying a distinct period within the target time span that corresponds to the distinct partially completed data record,
a respective synthetic response data value of the set of synthetic response data values computed based on the distinct partially completed data record, and
a respective seed value corresponding to the distinct partially completed data record that represents a pseudo-random number generator state of the simulation smoother.

21. The computer-implemented system according to claim 2, wherein:
the one or more synthetic data generation parameters include a simulation count parameter that specifies a total number of simulations to perform using the simulation smoother, and
the simulation smoother executes a plurality of distinct simulations equal in number to the total number of simulations specified by the simulation count parameter, wherein each simulation of the plurality of distinct simulations includes:
initializing a pseudo-random number generator of the simulation smoother with a respective seed value;
generating, based on the respective seed value, a corresponding synthetic component trajectory for each model component of the champion state space model; and
computing, using the corresponding synthetic component trajectory generated for each model component of the champion state space model, a respective set of synthetic response data values for the plurality of partially completed data records.

22. The computer-implemented system according to claim 2, wherein:
the longitudinal data includes a plurality of distinct panels of longitudinal data,
each panel of longitudinal data of the plurality of distinct panels of longitudinal data includes a distinct historical series of longitudinal data for a respective replicate of a plurality of distinct replicates, and
the set of synthetic response data values computed for the plurality of partially completed data records includes a plurality of distinct subsets, wherein:
each distinct subset of the plurality of distinct subsets includes a series of synthetic response data values representing a scaled behavior of a distinct replicate of the plurality of distinct replicates.

23. The computer-implemented system according to claim 2, wherein:
the plurality of partially completed data records collectively span a target time span that is different from a historical time span spanned by the longitudinal data,
the longitudinal data is associated with a plurality of predictor variables and a response variable, and
each synthetic response data value of the set of synthetic response data values computed for the plurality of partially completed data records represents a simulated value of the response variable corresponding to a respective period within the target time span.

24. The computer-implemented system according to claim 2, wherein:
the longitudinal data includes a plurality of predictor variables and a response variable,
the longitudinal data includes a plurality of historical data records collectively corresponding to a historical time span,
the one or more synthetic data generation parameters specifies a request to generate, at a predetermined time interval, synthetic longitudinal data for a target time span different from the historical time span,
the plurality of partially completed data records collectively span the target time span at the predetermined time interval,
the one or more synthetic data generation parameters further includes a target value for one of the plurality of predictor variables, and
generating the augmented data structure includes:
creating a plurality of new rows based on a total number of the plurality of partially completed data records; and
augmenting the initial data structure with the plurality of new rows to form the augmented data structure.

25. The computer-implemented system according to claim 24, wherein:
each partially completed data record of the plurality of partially completed data records includes a respective temporal identifier,
each new row of the plurality of new rows corresponds to a distinct one of the plurality of partially completed data records, and
each new row of the plurality of new rows includes:
the respective temporal identifier that corresponds to the distinct one of the plurality of partially completed data records,
the target value for the one of the plurality of predictor variables, and
an unpopulated response data field.

26. The computer-implemented system according to claim 1, wherein:
the longitudinal data does not include instances of a target class of a response variable,
the plurality of synthetic data records generated by the synthetic data generation circuit includes synthetic instances of the target class, and
the computer-readable instructions, when executed by the processor, perform operations further comprising:
training at least one machine learning model using the plurality of synthetic data records generated by the synthetic data generation circuit to enable the at least one machine learning model to learn the target class of the response variable.

27. The computer-implemented system according to claim 1, wherein the computer-readable instructions, when executed by the processor, perform operations further comprising:
training an ensemble of machine learning models using the plurality of synthetic data records generated by the synthetic data generation circuit.

28. The computer-implemented system according to claim 1, wherein the computer-readable instructions, when executed by the processor, perform operations further comprising:
using the plurality of synthetic data records generated by the synthetic data generation circuit to automatically test or automatically assess one or more software algorithms developed by the user.

29. A computer-implemented method comprising:
receiving, at a request detection circuit, via a network interface coupled to one or more input devices, a synthetic data generation request comprising longitudinal data and one or more synthetic data generation parameters;
fitting, via a model fitting and selection circuit, a plurality of candidate state space models to the longitudinal data received by the request detection circuit;
electing, via the model fitting and selection circuit, one of the plurality of candidate state space models as a champion state space model;
generating, via a simulation smoother circuit, a plurality of synthetic component trajectories using at least the champion state space model elected by the model fitting and selection circuit;
generating, via a synthetic data generation circuit, a plurality of synthetic data records using the plurality of synthetic component trajectories generated by the simulation smoother circuit; and
returning, via the network interface, the plurality of synthetic data records for output via an output device to a user associated with the synthetic data generation request.

30. A computer-program product comprising a non-transitory machine-readable storage medium storing computer instructions that, when executed by processing circuitry, perform operations comprising:
receive, at a request detection circuit, via a network interface coupled to one or more input devices, a synthetic data generation request comprising longitudinal data and one or more synthetic data generation parameters;
fit, via a model fitting and selection circuit, a plurality of candidate state space models to the longitudinal data received by the request detection circuit;
elect, via the model fitting and selection circuit, one of the plurality of candidate state space models as a champion state space model;
generate, via a simulation smoother circuit, a plurality of synthetic component trajectories using at least the champion state space model elected by the model fitting and selection circuit;
generate, via a synthetic data generation circuit, a plurality of synthetic data records using the plurality of synthetic component trajectories generated by the simulation smoother circuit; and
return, via the network interface, the plurality of synthetic data records for output via an output device to a user associated with the synthetic data generation request.
